(19) United States
(12) Patent Application Publication
(10) Pub. No.: US 2014/0057887 A1
(43) Pub. Date: Feb. 27, 2014

(54) NOVEL PLATINUM-CARBENE COMPLEXES AND USE THEREOF AS MEDICAMENTS

(71) Applicants: Stéphane Bellemin-Laponnaz, Strasbourg (FR); Gilles Guichard, Gradignan (FR); Edith Chardon, Strasbourg (FR)

(72) Inventors: Stéphane Bellemin-Laponnaz, Strasbourg (FR); Gilles Guichard, Gradignan (FR); Edith Chardon, Strasbourg (FR)

(21) Appl. No.: 13/996,105

(22) PCT Filed: Dec. 22, 2011
(86) PCT No.: PCT/FR2011/053148

§ 371 Date: Nov. 12, 2013

(30) Foreign Application Priority Data
Dec. 23, 2010 (FR) 10/61227

(51) Int. Cl. C07F 15/00

(52) U.S. Cl. CPC C07F 15/0086
USPC 514/188; 546/2; 548/103; 544/64; 544/225; 514/184

(57) ABSTRACT

Disclosed are novel platinum-carbene complexes and use thereof as medicinal products.

The present invention relates to novel platinum-carbene complexes and use thereof as medicinal products.

Certain derivatives of platinum are known anticancer agents. The best known among them, cisplatin, is one of the anticancer agents most frequently used throughout the world. However, the application of cisplatin in chemotherapy remains very restricted owing to limitations on its activity with respect to cancer cells. In fact, cisplatin is only active against a limited spectrum of cancer cells. Certain cancer cell lines display a natural resistance to cisplatin, while certain other cancer cells can develop an acquired resistance.

Moreover, as a medicinal product cisplatin has several drawbacks, for example significant side-effects such as nephrotoxicity, neurotoxicity, or emetogenesis.

Moreover, the main method of administration of cisplatin is still intravenous administration, as cisplatin has low solubility in water (1 mg/ml).

Recently, a new family of metal complexes, the N-heterocyclic carbene complexes, has attracted the attention of scientists for their anticancer activity.

The carbene complexes of gold were investigated by Barnard et al. (Barnard, P. J. et al., J. Inorg. Biochem. 2004, 10, 1642). These complexes display antitumour activity.

Ray et al. described, in 2007 (J. Am. Chem. Soc. 2007, 129, 15042-15053), four carbene complexes of palladium, which have anticancer, antiproliferative or antibacterial properties.

In 2009, Teyssot et al. (Chem. Eur. J. 2009, 15, 314-318) showed that carbene complexes of copper display toxicity against human tumour cells, and are capable of inducing cessation of the cell cycle, apoptosis, or cleavage of DNA.

Skander et al. (J. Med. Chem. 2010, 53, 2146-2154) describe a new family of platinum-carbene complexes bearing a nitrogen-containing ligand in trans configuration as regards the carbene, obtained by a three-step method, via (NHC)Pt(dvtms) complexes. However, since the ligands that can be introduced into this family of platinum derivatives are limited to cycloalkyl or heteroalkyl groups, and that consequently most of the platinum-carbene complexes described by Skander et al. are insoluble, these platinum derivatives do not have properties, such as water-solubility or selectivity, that are particularly required for a compound if it is to be considered as a possible drug candidate.

Consequently, there is a great need to develop novel platinum-carbene complexes possessing quite particular properties, and that can be used as medicinal products.

The subject of the present invention is to provide novel platinum-carbene complexes.

One aspect of the invention relates to providing novel cytosoluble platinum-carbene complexes.

Another aspect of the invention relates to the use of novel platinum-carbene complexes as medicinal products.

In general, the invention relates to a compound of group 1, with the following formula I:

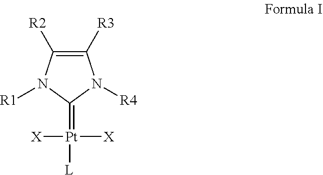

in which:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) an amine of formula

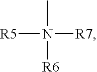

in which R5, R6 and R7 represent, independently of one another:
   (a) a hydrogen,
   (b) a linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular selected from alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
   an ad hoc protective group,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

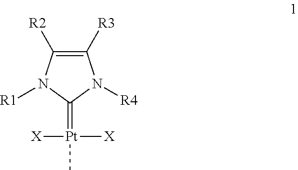

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine,

excluding the compounds of formula I, in which:

R1 and/or R4 represent, independently of one another, an aryl or aralkyl group, each optionally substituted, a linear or branched C1-C6 alkyl group, monocyclic C3-C7 cycloalkyl, linear or branched C2-C6 alkenyl,

R2 and/or R3 represent hydrogen, a phenyl group,

and X represents iodine, bromine or chlorine,

L represents:

an amine of formula

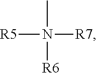

in which:
R5 and R6 represent a hydrogen and R7 represents a group selected from the cycloalkyl, mono- or bicyclic C3-C7 heterocycloalkyl or benzyl groups, optionally substituted,
R5, R6 or R7 represent simultaneously a hydrogen, or
R5 represents a hydrogen and R6 and R7 form, together with NH, a heterocycloalkyl,
   in particular a morpholine, or
   in which:

R1 and/or R4 represent, independently of one another, an unsubstituted linear or branched C1-C6 alkyl group,

R2 and/or R3 simultaneously represent hydrogen,

and X represents iodine, bromine or chlorine,

L represents a pyridine.

By “ester” of an amino acid is meant: the acid function of the α-amino acid is protected in the form of esters of linear or branched alkyl or of alkenyl (allyls) with 1 to 20 carbon atoms or in the form of benzyl esters, unsubstituted, or substituted with methoxy groups or with an NO₂ group.

By “amide” of an amino acid is meant: the acid function of the α-amino acid is protected in the form of amide, we have NH₂—CH(R)—CONH₂, R being a linear or branched alkyl with 1 to 20 carbon atoms.

By “short alkyl or aralkyl chain” is meant a C1-C8, in particular C1-C6 carbon chain, said chain in particular being linear or branched.

By “ad hoc protective group” is meant a group intended to protect a function, for example a carboxylic acid protective group, against undesirable reactions during the synthesis steps. The protective groups commonly used are described in Greene, “Protective Groups in Organic Synthesis” (John Wiley & Sons, New York (1981)).

The bond between Pt and the ligand L represented by a solid line in formula I does not correspond to a covalent bond, but to a coordination bond.

The coordination bond between Pt of the m−1 groups of formula 1 and m−1 amines of —NH— or —NH₂ type of the polymer of general formula NH₂—(CH₂(CH₂)ᵢNH)₍ₙ₋₁₎—H is represented by a dotted line.

In the context of the invention, the peptide or pseudopeptide as ligand L of the compound of formula II can be selected from the peptides known to a person skilled in the art.

As an example of ligand L, there can be mentioned the cyclized cyclic peptide H-Arg(HCl)-Gly-Asp(CH₂CCl₃)-D-Phe-Lys(N₃)—OH (J. Org. Chem. 2003, 68, 4464-4471).

As another example of ligand L, there can be mentioned the pseudopeptide N—[N—[(S)-1,3-dicarboxypropyl]carbamoyl]-(S)-lysine (DCL), a ligand known from the prostate specific membrane antigen (PSMA) (J. Med. Chem. 2009, 52, 347-357) or a derivative thereof such as MeO-L-Lys-CO-L-Glu(OMe)-OMe, MeO-L-Lys(CO—(CH₂)₅—NH₂)—CO-L-Glu(OMe)-OMe or CCl₃—CH₂—O-L-Lys-CO-L-Glu(O—CH₂—CCl₃)—OCH₂CCl₃.

The invention also relates to a compound of group 2 with the following formula I:

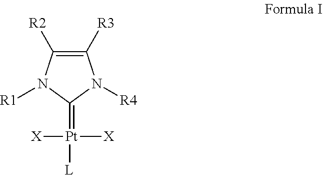

in which

### (I) if:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
   then L represents:
(i) an amine of formula

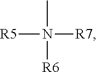

in which R5, R6 and R7 represent, independently of one another:
   (a) a hydrogen,
   (b) a non-cyclized linear or branched C1-C18 alkyl, optionally substituted with an estradiol,
   (c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, in particular with a trimethylsilyl,
   (d) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a hydrazine monosubstituted with an aryl having 1, 2 or 3 aromatic rings, in particular a phenyl, or a linear or branched alkyl with 1 to 12 carbon atoms,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xvi) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xvii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

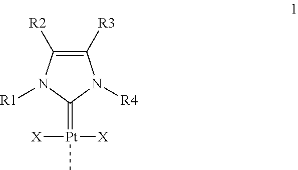

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine;

### (IIa) if:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C1-C6 alkyl group, substituted with a trimethylsilyl group, or a non-cyclized linear or branched C7-C12, in particular C7-C8, alkyl group, optionally substituted with an alkoxy group with 1 to 12 carbon atoms, in particular with 1 to 8 carbon atoms, with a CF₃ group or in particular with a trimethylsilyl group,
   a linear or branched C2-C12, in particular C2-C8 alkenyl group, substituted with a trimethylsilyl group,
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

### II (b) or, if:

R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, with the condition that R2 or R3 represents:
an aralkyl group with a C1-C12, in particular C1-C8 carbon chain, the aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilylbenzyl group, or
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
   then:

L represents:
(i) an amine of formula

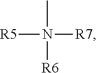

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

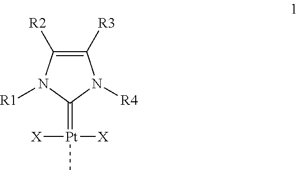

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

In an advantageous embodiment, the invention also relates to a compound of group 3, with the following formula I:

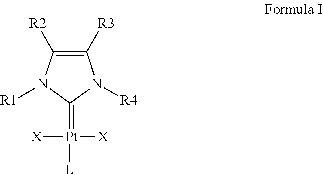

in which

### (I) if:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
   then L represents:
(i) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(ii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(iii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(iv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

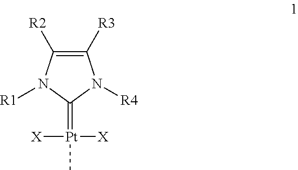

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine;

### (IIa) if:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C1-C6 alkyl group, substituted with a trimethylsilyl group,
   an aryl group having 2 or 3 aromatic rings, in particular naphthalenyl or anthracenyl, the aryl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

### II (b) or, if:

R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
   then:

L represents:
(i) an amine of formula

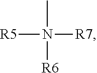

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

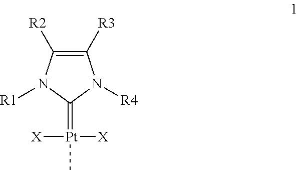

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 3 covers the compounds comprising: a C2-C12 alkynyl group in position 1, 2, 3 or 4; or a linear or branched C1-C6 alkyl group, substituted with a trimethylsilyl group, a polymer represented by the formula —(CH₂CH₂O)ₙ—R′ or the formula —(CH₂CH₂CH₂O)ₙ—R′ or an aryl group having 2 or 3 aromatic rings, in position 1 or 4; or a peptide, a pseudopeptide or a polymer represented by the general formula NH₂—(CH₂(CH₂)ᵢNH)₍ₙ₋₁₎—H as ligand L.

In an advantageous embodiment, the invention also relates to a compound of group 4, of the following formula I:

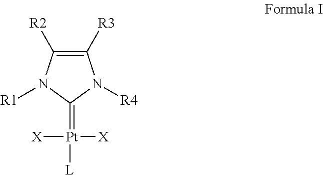

in which

### (Ia) if:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

### (Ib) or, if:

R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
   then:

L represents:
(i) an amine of formula

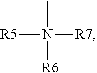

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide, (vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

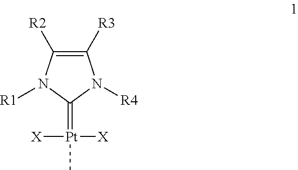

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 4 covers the compounds comprising a C2-C12 alkynyl group in position 1, 2, 3 or 4.

In a particular embodiment, the invention relates to a compound of group 5, of the following formula I:

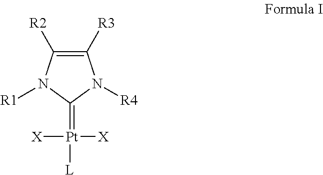

in which:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, in particular with a trimethylsilyl group,
   and L represents:
(i) an amine of formula

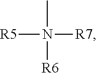

in which R5, R6 and R7 represent, independently of one another:
   (a) a hydrogen,
   (b) a non-cyclized linear or branched C1-C18 alkyl, optionally substituted with an estradiol,
   (c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, or in particular with a trimethylsilyl,
   (d) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xi) a piperazine N-substituted with a dansyl or dabsyl group,
(xii) a hydrazine monosubstituted with an aryl having 1, 2 or 3 aromatic rings, in particular a phenyl, or a linear or branched alkyl with 1 to 12 carbon atoms,
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

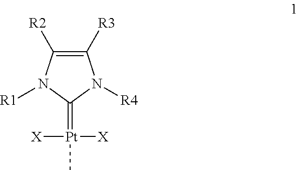

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

In another advantageous embodiment, the invention relates to a compound of group 6, of the following formula I:

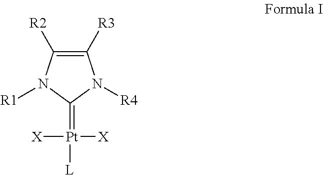

in which:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
   and L represents:
(i) an amine of formula

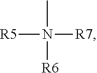

in which R5, R6 and R7 represent, independently of one another:
   (a) a hydrogen, or
   (b) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xi) a piperazine N-substituted with a dansyl or dabsyl group
(xii) a hydrazine monosubstituted with an aryl having 1, 2 or 3 aromatic rings, in particular a phenyl, or a linear or branched alkyl with 1 to 12 carbon atoms,
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

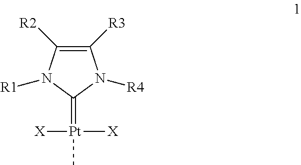

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

In an advantageous embodiment, the invention also relates to a compound of group 7, of the following formula I:

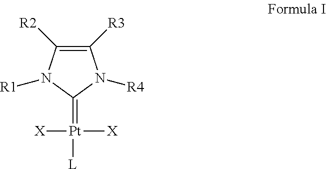

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(ii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(iii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(iv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

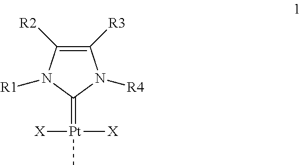

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 7 covers the compounds having, as ligand L, a peptide, a pseudopeptide or a polymer represented by the general formula NH₂—(CH₂(CH₂)ᵢNH)₍ₙ₋₁₎—H.

In another particular embodiment, the invention relates to a compound of group 8, of the following formula I:

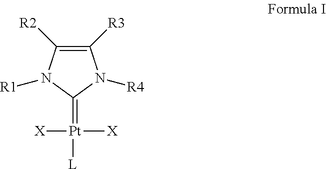

in which:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C1-C6 alkyl group, substituted with a trimethylsilyl group, or a non-cyclized linear or branched C7-C12, in particular C7-C8, alkyl group, optionally substituted with an alkoxy group with 1 to 12 carbon atoms, in particular with 1 to 8 carbon atoms, with a CF₃ group or in particular with a trimethylsilyl group,
   a linear or branched C2-C12, in particular C2-C8 alkenyl group, substituted with a trimethylsilyl group,
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, and
   L represents:
(i) an amine of formula

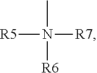

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or amides,
(viii) a beta or gamma amino acid and its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine,
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

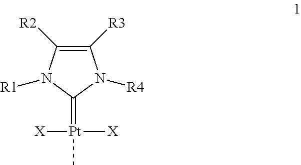

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

In an advantageous embodiment, the invention also relates to a compound of group 9, of the following formula I:

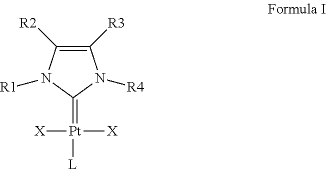

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C1-C6 alkyl group, substituted with a trimethylsilyl group,
   an aryl group having 2 or 3 aromatic rings, in particular naphthalenyl or anthracenyl, the aryl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) an amine of formula

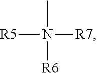

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

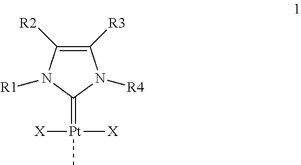

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 9 covers the compounds comprising: a C2-C12 alkynyl group, a linear or branched C1-C6 alkyl group, substituted with a trimethylsilyl group, a polymer represented by the formula —(CH₂CH₂O)ₙ—R′ or the formula —(CH₂CH₂CH₂O)ₙ—R′ or an aryl group having 2 or 3 aromatic rings, in position 1 or 4.

In an advantageous embodiment, the invention also relates to a compound of group 10, of the following formula I:

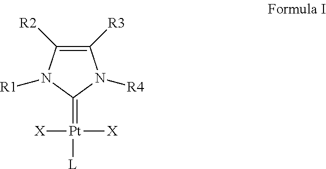

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C1-C6 alkyl group, substituted with a trimethylsilyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) an amine of formula

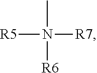

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

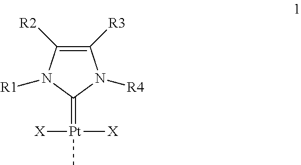

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 10 covers the compounds comprising a linear or branched C1-C6 alkyl group, substituted with a trimethylsilyl group, in position 1 or 4.

The compounds of formula I belonging to group 10 possess particularly advantageous lipophilicity properties.

In an advantageous embodiment, the invention also relates to a compound of group 11, of the following formula I:

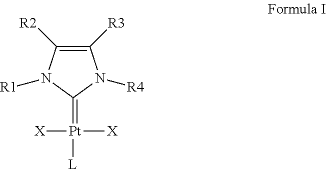

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   an aryl group having 2 or 3 aromatic rings, in particular naphthalenyl or anthracenyl, the aryl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) an amine of formula

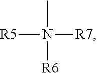

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

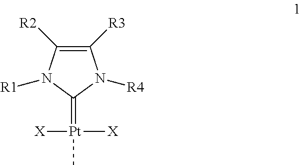

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 11 covers the compounds comprising an aryl group having 2 or 3 aromatic rings, in position 1 or 4.

The compounds of formula I belonging to group 11 possess particularly advantageous fluorescence properties.

In an advantageous embodiment, the invention also relates to a compound of group 12, of the following formula I:

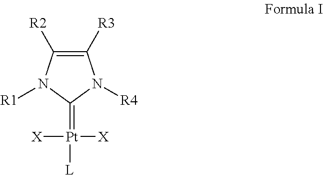

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) an amine of formula

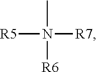

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

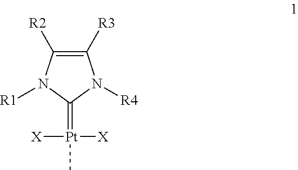

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 12 covers the compounds comprising a polymer represented by the formula —(CH₂CH₂O)ₙ—R′ or the formula —(CH₂CH₂CH₂O)ₙ—R′, in position 1 or 4.

The compounds of formula I belonging to group 12 possess particularly advantageous water-solubility properties.

In an advantageous embodiment, the invention also relates to a compound of group 13, of the following formula I:

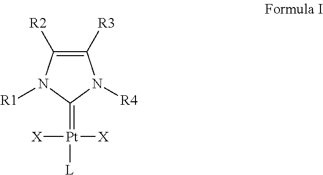

in which

R1 and R4 represent, independently of one another:
a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,

R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) an amine of formula

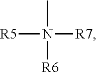

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

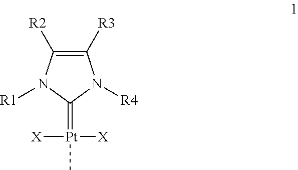

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 13 covers the compounds comprising a polymer represented by the formula —(CH₂CH₂O)ₙ—R′ or the formula —(CH₂CH₂CH₂O)ₙ—R′, in position 1 and 4.

The compounds of formula I belonging to group 13 possess particularly advantageous water-solubility properties.

In another particular embodiment, the invention relates to a compound of group 14, with the following formula I:

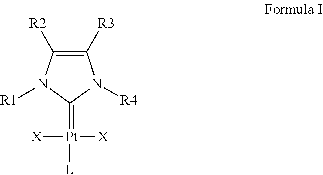

in which:

R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

with the condition that R2 or R3 represents:
an aralkyl group with a C1-C12, in particular C1-C8 carbon chain, the aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilylbenzyl group, or
   a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group, and

L represents:
(i) an amine of formula

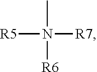

in which R5, R6 and R7 represent, independently of one another:
(a) a hydrogen,
(b) a non-cyclized linear or branched C1-C18 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine,
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

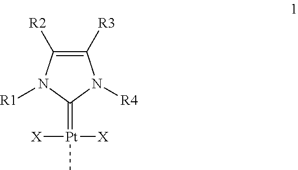

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

In an advantageous embodiment, the invention also relates to a compound of group 15, of the following formula I:

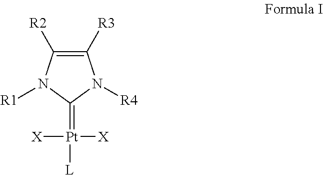

in which

R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

L represents:
(i) an amine of formula

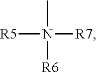

in which R5, R6 and R7 represent, independently of one another:
   (a) a hydrogen,
   (b) a non-cyclized linear or branched C1-C18 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

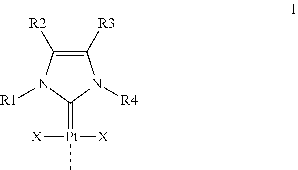

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 15 covers the compounds comprising a C2-C12 alkynyl group, in position 2 or 3.

The compounds of formula I belonging to group 15 possess particularly advantageous post-functionalization properties by forming a substituted triazole starting from the alkynyl group.

In another embodiment, the invention relates to a compound of group 16, of the following formula I:

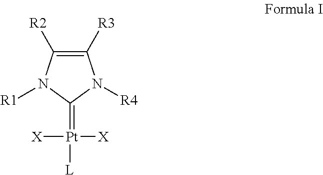

in which:

L represents a pyridine or a pyridine substituted with iodine, bromine or chlorine, in particular 3-bromopyridine, or 3-chloropyridine, or disubstituted with iodine, bromine or chlorine, in particular 3,5-dibromopyridine,

X represents iodine, bromine or chlorine,

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
   excluding the compounds of formula I, in which:
R1 and/or R4 represent, independently of one another, an unsubstituted linear or branched C1-C6 alkyl group,
R2 and/or R3 represent hydrogen,
and X represents iodine, bromine or chlorine.

In an advantageous embodiment, the invention relates to the compounds of formula I, in which:

L represents pyridine or 3-bromopyridine;

(i) R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl), provided that R1 or R4 represents 2,5,8,11-tetraoxatridecane, a 1-methyl-3-(5-(trimethylsilyl)pent-4-yn-1-yl), a 1-methyl-3-(anthracen-9-ylmethyl), 1-methyl-3-(3-(trimethylsilyl)propyl) or a heptyl;
and R2 and R3 represent, independently of one another, a hydrogen or an alkyne substituted with a trimethylsilyl; or
   (ii) R1 and R4 represent, independently of one another: 2,5,8,11-tetraoxatridecane, a heptyl, a methyl, a benzyl, a trimethylsilyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl),
R2 and R3 represent, independently of one another, a hydrogen or an alkyne substituted with a trimethylsilyl, provided that R2 or R3 represents an alkyne substituted with a trimethylsilyl.

In an advantageous embodiment, the invention relates to a compound of group 17, of the following formula I:

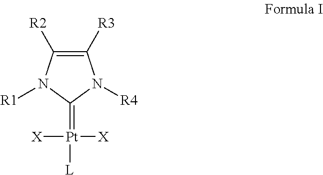

in which:

L represents a pyridine or a pyridine substituted with iodine, bromine or chlorine, in particular 3-bromopyridine, or 3-chloropyridine, or disubstituted with iodine, bromine or chlorine, in particular 3,5-dibromopyridine,

X represents iodine, bromine or chlorine,

R1 and R4 represent, independently of one another:
(i) a linear or branched C7-C12, in particular C7-C8 alkyl group, optionally substituted with an alkoxy group with 1 to 12 carbon atoms, in particular with 1 to 8 carbon atoms, with a CF₃ group or in particular with a trimethylsilyl group, or a C1-C6 alkyl group substituted an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(iv) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group.

In a particularly advantageous embodiment, the compounds according to the invention are the following compounds:

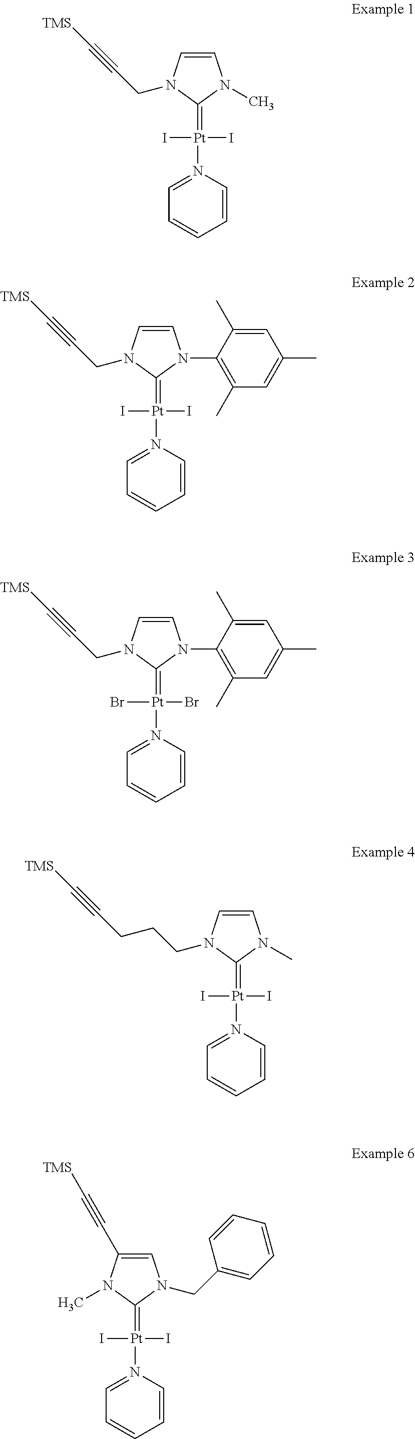

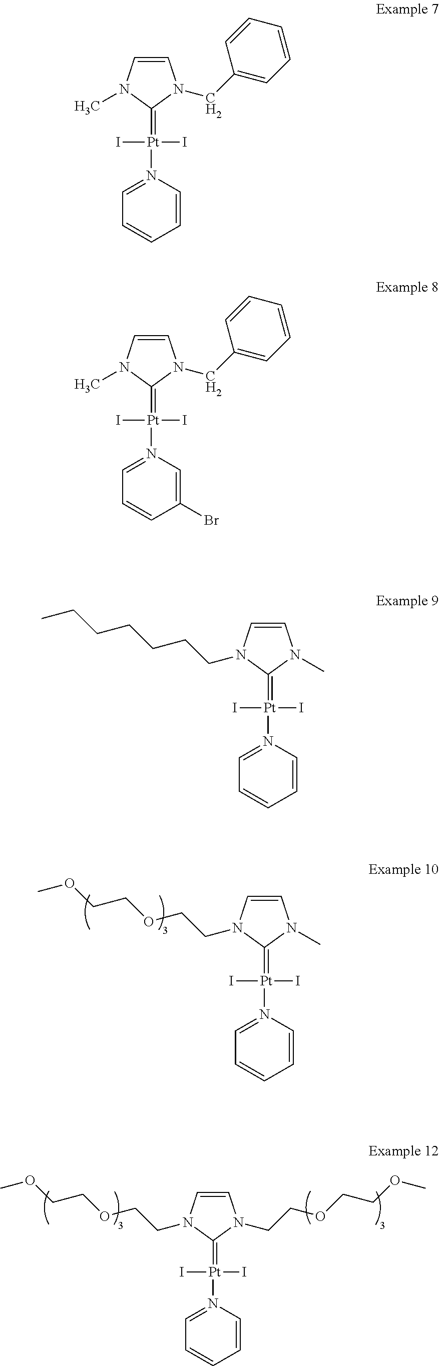

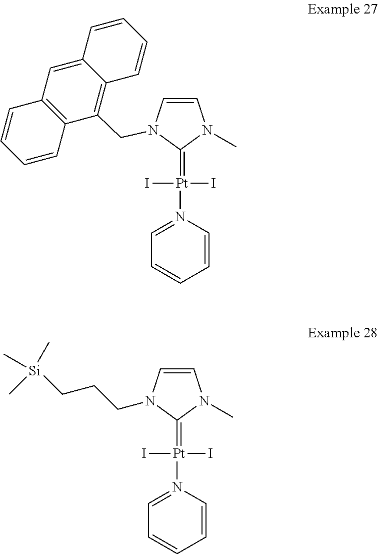

In another particular embodiment, the invention relates to the compounds of group 18, of the following formula I:

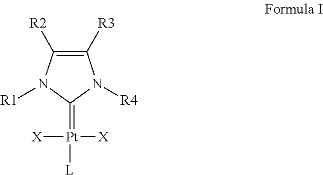

in which:
R2 and R3 are hydrogens,
X represents iodine, bromine or chlorine, and
R1 is a methyl and R4 is a benzyl, or
R4 is a methyl and R1 is a benzyl, and
L represents:
   (i) an amine of formula

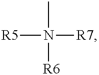

in which R5, R6 and R7 represent, independently of one another:
   (a) a hydrogen,
   (b) a non-cyclized linear or branched C1-C18 alkyl, optionally substituted with an estradiol,
   (c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, or in particular with a trimethylsilyl,
   (d) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a hydrazine monosubstituted with an aryl having 1, 2 or 3 aromatic rings, in particular a phenyl, or a linear or branched alkyl with 1 to 12 carbon atoms,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group,
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xvi) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group.
(xvii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

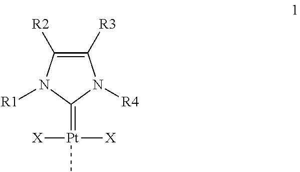

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2.

In a particularly advantageous embodiment, the invention relates to the compounds of group 19, of the following formula I:

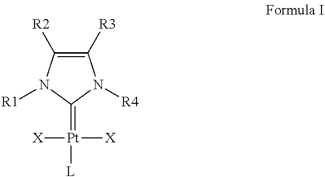

in which:

R2 and R3 are hydrogens,
X represents iodine, bromine or chlorine, and
R1 is a methyl and R4 is a benzyl, or
R4 is a methyl and R1 is a benzyl, and
L represents:

valine or its esters, phenylalanine or its esters, Leu-Gly or Leu-Gly-OMe, Val-Phe-Gly or Val-Phe-Gly-OMe, Ile-Lys-Gly or Ile-Lys-Gly-OMe, (methoxy)polyethylene glycol amine, methyl 6-aminohexanoate, prolinol, prolinamide, ethanolamine, (6S,11S,16S,21S,26S)-6,21-diisobutyl-16-isopropyl-11-methyl-3,8,13,18,23-pentaoxo-2,4,7,9,12,14,17,19,22,24-decaazaheptacosan-26-aminium, N,N-dimethyl-5-(piperazin-1-ylsulphonyl)naphthalen-1-amine, phenylhydrazine, diethylenetriamine, ethylenediamine, linear poly(ethylenamine), (13S,16R,17R)-16-(7-aminoheptyl)-16-(hydroxymethyl)-13-methyl-7,8,9,11,12,13,14,15,16,17-decahydro-6H-cyclopenta[a]phenanthrene-3,17-diol, 16(beta)hydroxymethyl-16-(amino[polyethyleneglycol])-1,3,5(10)-estratriene-3,17-diol, N-[N—[(S)-1,3-dicarboxypropyl]carbamoyl]-(S)-lysine, MeO-L-Lys-CO-L-Glu(OMe)-OMe, MeO-L-Lys(CO—(CH₂)₅—NH₂)—CO-L-Glu(OMe)-OMe, CCl₃—CH₂—O-L-Lys-CO-L-Glu(O—CH₂—CCl₃)—OCH₂CCl₃ or H-Arg(HCl)-Gly-Asp(CH₂CCl₃)-D-Phe-Lys(N₃)—OH.

In another advantageous embodiment, the invention relates to the compounds of group 20, of the following formula I:

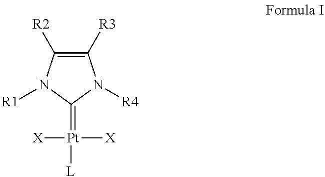

in which:

R2 and R3 are hydrogens,
X represents iodine, bromine or chlorine, and
R1 is a methyl and R4 is a benzyl, or
R4 is a methyl and R1 is a benzyl, and
L represents:
   (i) an amine of formula

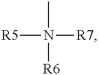

in which R5, R6 and R7 represent, independently of one another:
   (a) a hydrogen,
   (b) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or
(viii) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(ix) a hydrazine monosubstituted with an aryl having 1, 2 or 3 aromatic rings, in particular a phenyl, or a linear or branched alkyl with 1 to 12 carbon atoms,
(x) a piperazine N-substituted with a dansyl or dabsyl group,
(xi) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group.
(xiii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

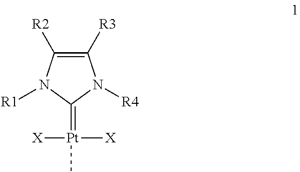

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2.

In a particularly advantageous embodiment, the compounds according to the invention are as follows:

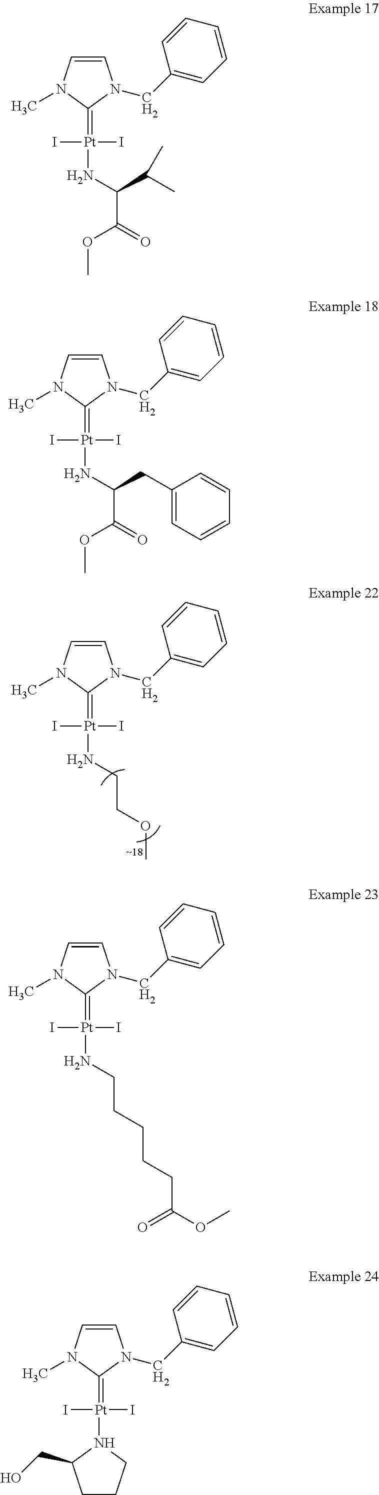

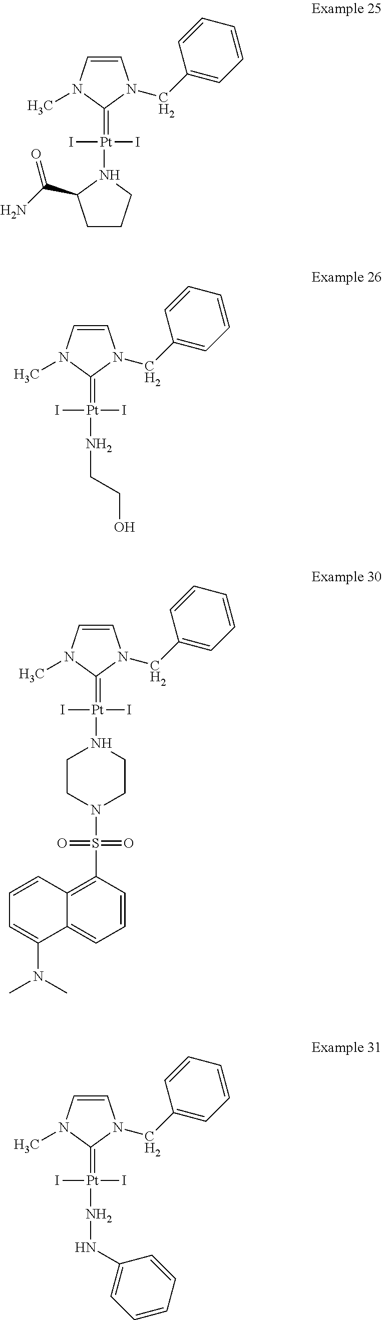

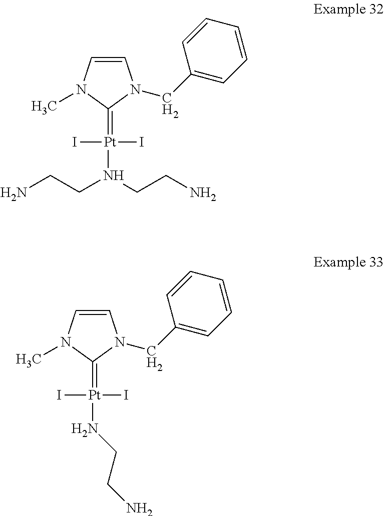

In another particular embodiment, the invention relates to a compound of group 21, of the following formula I:

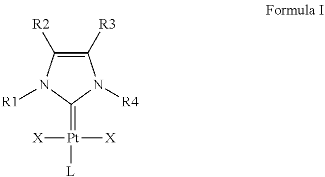

in which:

L represents morpholine

(i)—R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

with the condition that R2 or R3 represents:
an aralkyl group with a C1-C12, in particular C1-C8 carbon chain, the aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilylbenzyl group, or
   a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
   or (ii) R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C1-C6 alkyl group, substituted with a trimethylsilyl group, or a non-cyclized linear or branched C7-C12, in particular C7-C8, alkyl group, optionally substituted with an alkoxy group with 1 to 12 carbon atoms, in particular with 1 to 8 carbon atoms, with a CF₃ group or in particular with a trimethylsilyl group,
   a linear or branched C2-C12, in particular C2-C8 alkenyl group, substituted with a trimethylsilyl group,
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group.

In an advantageous embodiment, the invention relates to a compound of group 22, of the following formula I:

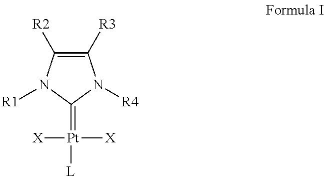

in which:

L represents morpholine;

X represents iodine, bromine or chlorine;

then (i)—R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl), provided that R1 or R4 represents 2,5,8,11-tetraoxatridecane, a trimethylsilyl, a 1-methyl-3-(5-(trimethylsilyl)pent-4-yn-1-yl), a 1-methyl-3-(anthracen-9-ylmethyl), 1-methyl-3-(3-(trimethylsilyl)propyl) or a heptyl,
R2 and R3 represent, independently of one another, a hydrogen or an alkyne substituted with a trimethylsilyl;
   or (ii)—R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl),
R2 and R3 represent, independently of one another, a hydrogen or an alkyne substituted with a trimethylsilyl, provided that R2 or R3 represents an alkyne substituted with a trimethylsilyl.

In another advantageous embodiment, the invention relates to a compound of group 23, of the following formula I:

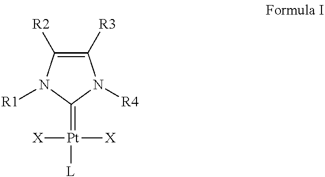

in which:

L represents morpholine

(i) R1 and R4 represent, independently of one another:
a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
   a linear or branched C1-C6 alkyl group, substituted with a trimethylsilyl group, or a non-cyclized linear or branched C7-C12, in particular C7-C8, alkyl group, optionally substituted with an alkoxy group with 1 to 12 carbon atoms, in particular with 1 to 8 carbon atoms, with a CF₃ group or in particular with a trimethylsilyl group, or
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,

R2 and R3 represent, independently of one another:
a hydrogen, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
   (ii) R1 and R4 represent, independently of one another:
a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,

R2 and R3 represent, independently of one another:
a hydrogen, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, provided that R2 or R3 represents a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group.

In a particularly advantageous embodiment, the compounds according to the invention are as follows:

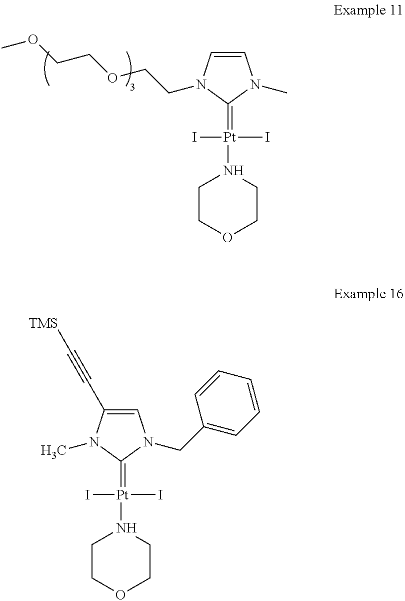

In another particular embodiment, the invention relates to a compound of group 24, of the following formula I:

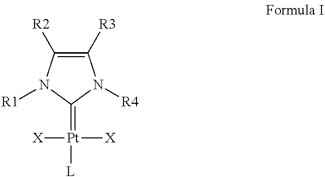

in which:

L represents cyclohexylamine,

(i)—R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, with the condition that R2 or R3 represents:
an aralkyl group with a C1-C12, in particular C1-C8 carbon chain, the aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilylbenzyl group, or
   a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
   or (ii) R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represents:
   a linear or branched C1-C6 alkyl group, substituted with a trimethylsilyl group, or a non-cyclized linear or branched C7-C12, in particular C7-C8, alkyl group, optionally substituted with an alkoxy group with 1 to 12 carbon atoms, in particular with 1 to 8 carbon atoms, with a CF₃ group or in particular with a trimethylsilyl group,
   a linear or branched C2-C12, in particular C2-C8 alkenyl group, substituted with a trimethylsilyl group,
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group.

In an advantageous embodiment, the invention relates to a compound of group 25, of the following formula I:

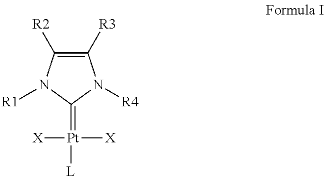

in which:
L represents cyclohexylamine;
X represents iodine, bromine or chlorine;
Then (i)—R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl), provided that R1 or R4 represents 2,5,8,11-tetraoxatridecane, a trimethylsilyl, a 1-methyl-3-(5-(trimethylsilyl)pent-4-yn-1-yl), a 1-methyl-3-(anthracen-9-ylmethyl), 1-methyl-3-(3-(trimethylsilyl)propyl) or a heptyl

R2 and R3 represent, independently of one another, a hydrogen or an alkyne substituted with a trimethylsilyl;

or (ii)—R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl),

R2 and R3 represent, independently of one another, a hydrogen or an alkyne substituted with a trimethylsilyl, provided that R2 or R3 represents an alkyne substituted with a trimethylsilyl.

In another advantageous embodiment, the invention relates to a compound of group 26, of the following formula I

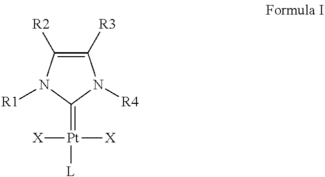

in which:

L represents cyclohexylamine,

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group, with the condition that R1 or R4 represent:
   a linear or branched C1-C6 alkyl group, substituted with a trimethylsilyl group, or a non-cyclized linear or branched C7-C12, in particular C7-C8, alkyl group, optionally substituted with an alkoxy group with 1 to 12 carbon atoms, in particular with 1 to 8 carbon atoms, with a CF₃ group or in particular with a trimethylsilyl group,
   a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
   a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,

R2 and R3 represent, independently of one another:
a hydrogen,
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group.

In a particularly advantageous embodiment, the compounds according to the invention are as follows:

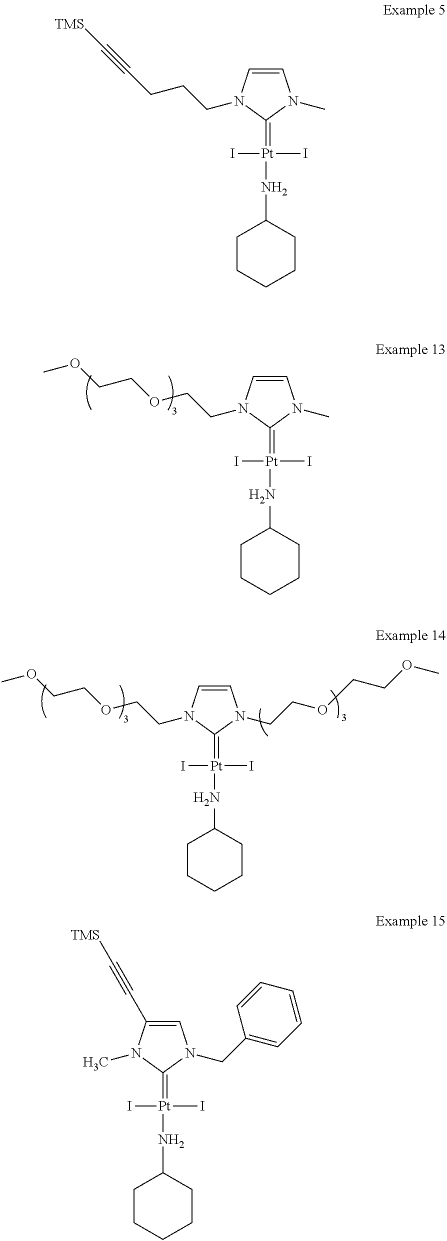

In an advantageous embodiment, the invention also relates to a compound of group 27, of the following formula I:

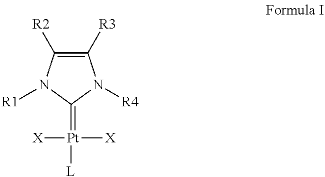

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,

and X represents iodine, bromine or chlorine.

Formula I of group 27 covers the compounds having a peptide as ligand L.

The compounds of formula I belonging to group 27 possess particularly advantageous water-solubility and/or selectivity properties with respect to certain cells.

In a particularly advantageous embodiment, the compounds according to the invention are as follows:

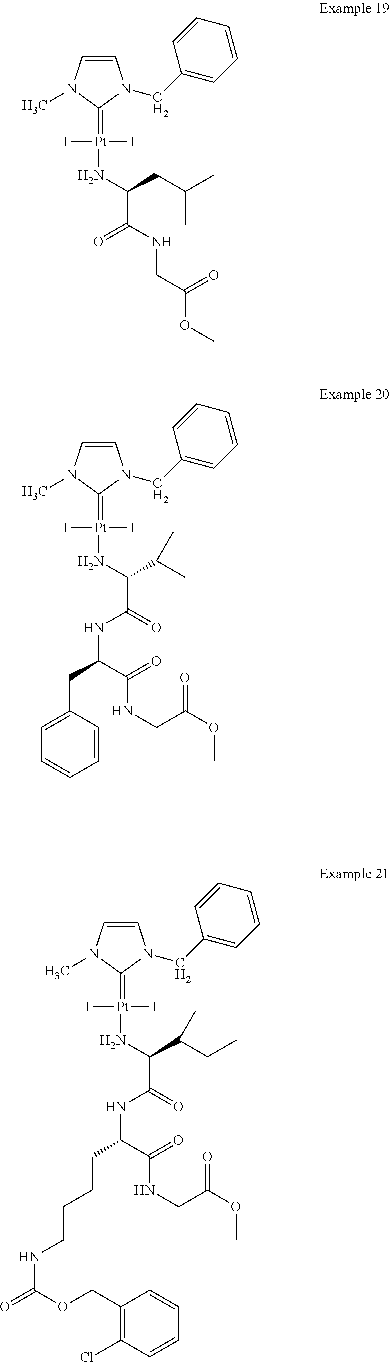

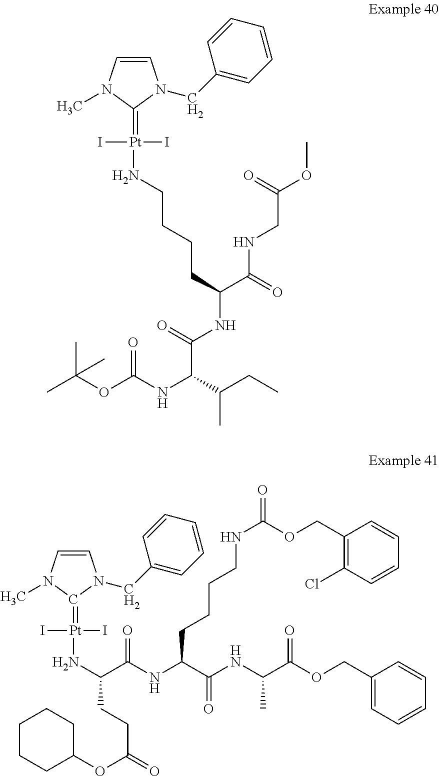

In an advantageous embodiment, the invention also relates to a compound of group 28, of the following formula I:

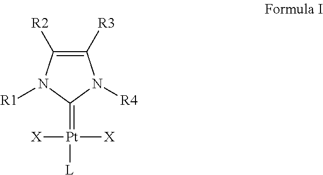

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents:
(i) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain, or
(ii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,

and X represents iodine, bromine or chlorine.

Formula I of group 28 covers the compounds having a pseudopeptide as ligand L.

The compounds of formula I belonging to group 13 possess particularly advantageous water-solubility and/or selectivity properties with respect to certain cells.

In a particularly advantageous embodiment, the compounds according to the invention are as follows:

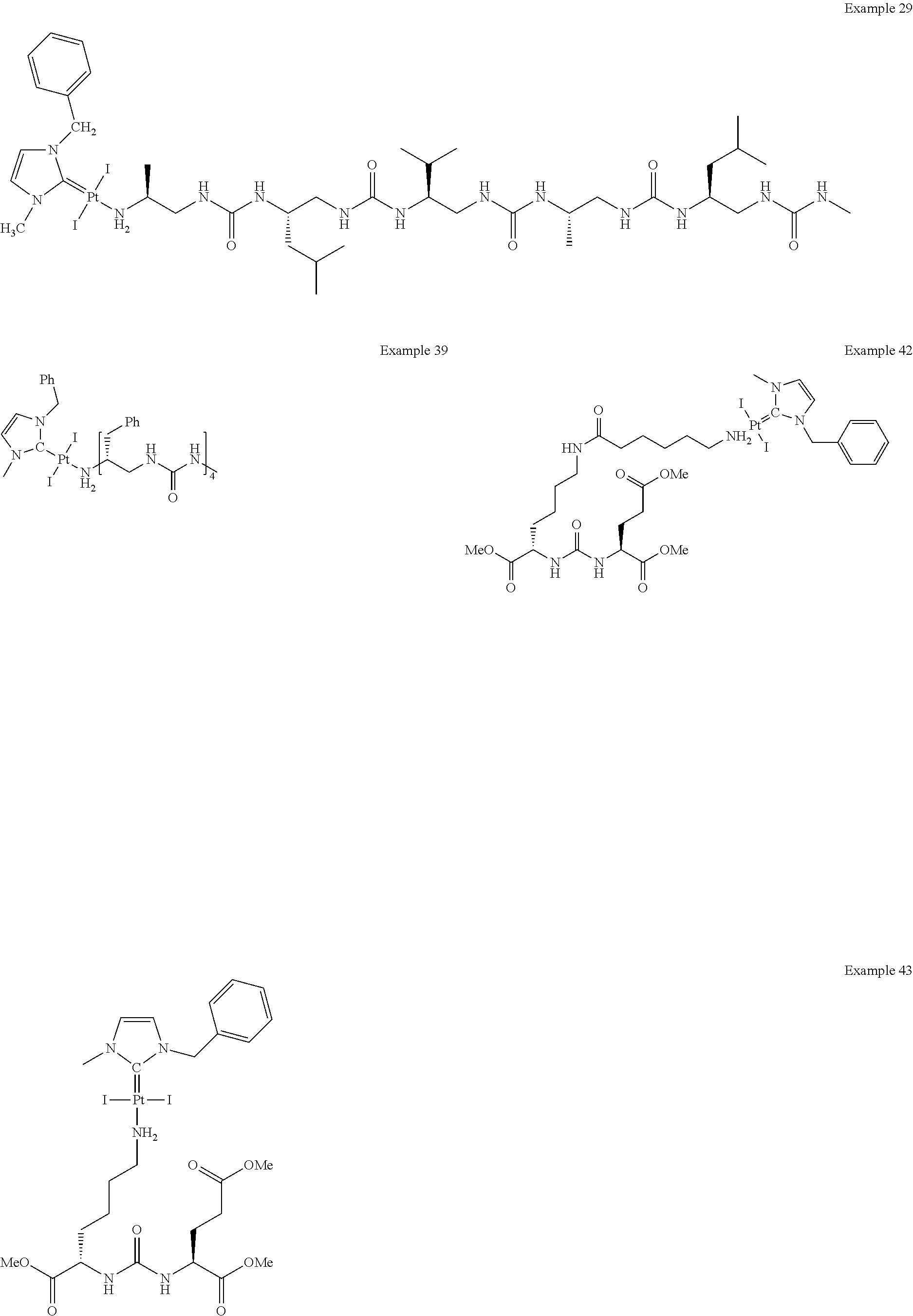

In an advantageous embodiment, the invention also relates to a compound of group 29, of the following formula I:

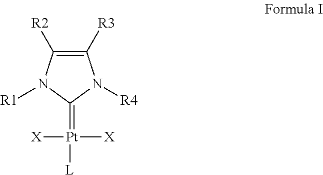

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

L represents a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

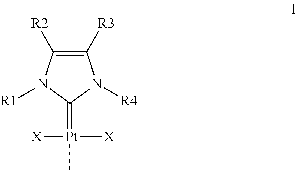

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,

and X represents iodine, bromine or chlorine.

Formula I of group 29 covers the compounds having, as ligand L, a polymer represented by the general formula NH₂—(CH₂(CH₂)ᵢNH)₍ₙ₋₁₎—H.

The compounds of formula I belonging to group 29 possess particularly advantageous water-solubility properties.

In a particularly advantageous embodiment, a compound according to the invention is of the following formula:

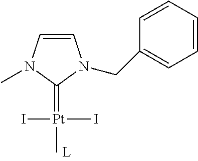

in which L is a polymer represented by the formula NH₂—(CH₂—CH₂—NH)₍ₙ₋₁₎—H, in which n=400 to 600, in particular n=450 to 550, more particularly from 490 to 510, even more particularly 500, said polymer moreover forming m−1 coordination bonds with m−1 groups of formula:

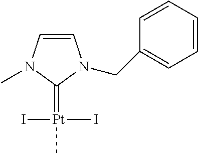

the number m being comprised between 40 and 60, in particular between 45 and 55, more particularly from 49 to 51, m being even more particularly equal to 50.

In a particularly advantageous embodiment, the invention also relates to a compound of group 30, of the following formula Ia:

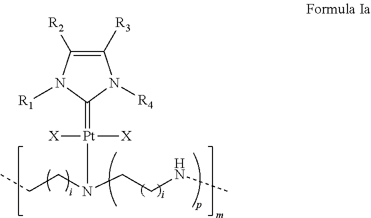

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

X represents iodine, bromine or chlorine,

m=1 to 1000, in particular m=1 to 100, more particularly from 1 to 50,

p=0 to 50, in particular p=1 to 20, more particularly from 1 to 10, p representing the ratio of the number of platinum atoms to the number of amines of —NH— or —NH₂ type,

i=1, 2 or 3.

Formula I of group 30 covers the compounds having, as ligand L, a polymer represented by the formula Ia, comprising one carbene per unit repeated m times.

The compounds of formula I belonging to group 30 possess particularly advantageous water-solubility properties.

In a particularly advantageous embodiment, a compound according to the invention is as follows:

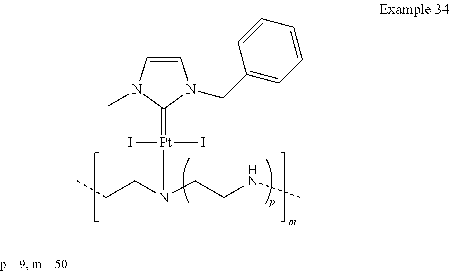

In a particularly advantageous embodiment of the invention, the compounds of group 31, of the following formula I, are soluble:

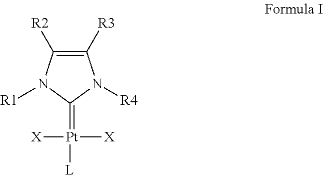

in which:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
   and L represents:
(i) an amine of formula

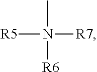

in which:
   at least one of the R5, R6 and R7 radicals represents a polymer represented by the formula —(CH₂CH₂O)ₙ—R′ or the formula —(CH₂CH₂CH₂O)ₙ—R′, in which n=6 to 40, in particular n=6 to 20, and R′ is a C1-C12, in particular C1-C8 alkyl group, said polymer being optionally substituted with an estradiol,
   R5, R6 and R7 represent, independently of one another:
      (a) a hydrogen,
      (b) a non-cyclized linear or branched C1-C18 alkyl,
      (c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, or in particular with a trimethylsilyl,
      (d) a polymer represented by the formula —(CH₂CH₂O)ₙ—R′ or the formula —(CH₂CH₂CH₂O)ₙ—R′, in which n=6 to 40, in particular n=6 to 20, and R′ is a C1-C12, in particular C1-C8 alkyl group,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

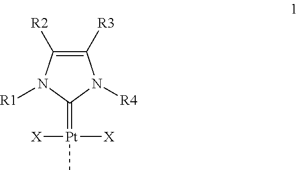

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2.

The solubility of such a compound is conferred by one of the particular ligands presented above.

In another particular embodiment, the invention relates to a compound of group 32, of the following formula I:

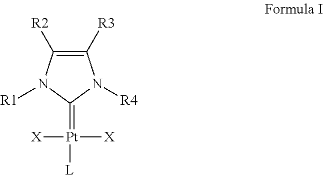

in which:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, in particular with a trimethylsilyl group,
   and L represents:
(i) an amine of formula

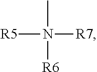

in which:
   at least one of the R5, R6 and R7 radicals represents a polymer represented by the formula —(CH₂CH₂O)ₙ—R′ or the formula —(CH₂CH₂CH₂O)ₙ—R′, in which n=1 to 5, and R′ is a C1-C12, in particular C1-C8 alkyl group,
   R5, R6 and R7 represent, independently of one another:
      (a) a hydrogen,
      (b) a non-cyclized linear or branched C1-C18 alkyl,
      (c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, in particular with a trimethylsilyl,
      (d) a polymer represented by the formula —(CH₂CH₂O)ₙ—R′ or the formula —(CH₂CH₂CH₂O)ₙ—R′, in which n=1 to 5, and R′ is a C1-C12, in particular C1-C8 alkyl group,
(ii) a linear or branched amino alcohol with 2 to 20 carbon atoms, in particular prolinol,
(iii) a linear or branched amino ester with 2 to 20 carbon atoms, in particular with 2 to 10 carbon atoms,
(iv) a linear or branched amino amide with 2 to 20 carbon atoms, in particular prolinamide,
(v) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(vi) a beta or gamma amino acid or its esters or amides,
(vii) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(viii) a hydrazine monosubstituted with an aryl having 1, 2 or 3 aromatic rings, in particular a phenyl, or a linear or branched alkyl with 1 to 12 carbon atoms,
(ix) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(x) a piperazine N-substituted with a dansyl or dabsyl group
(xi) a glucamine optionally N-substituted with an alkyl group with 1 to 20 carbon atoms, in particular N-methylglucamine, N-ethylglucamine or N-dodecylglucamine,
(xii) a glucosamine optionally N-substituted with an alkyl group with 1 to 20 carbon atoms,
(xiii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain, or
(xiv) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group.

An advantageous embodiment of the invention relates to a compound of group 33, of the following formula I:

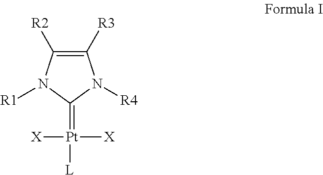

in which:

### (I) if:

R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl);

R2 and R3 represent, independently of one another:
a hydrogen,
an alkyne substituted with a trimethylsilyl,

X represents iodine, bromine or chlorine; and

then L represents:
valine or its esters, phenylalanine or its esters, Leu-Gly or Leu-Gly-OMe, Val-Phe-Gly or Val-Phe-Gly-OMe, Ile-Lys-Gly or Ile-Lys-Gly-OMe, (methoxy)polyethylene glycol amine, methyl 6-aminohexanoate, prolinol, prolinamide, ethanolamine, (6S,11S,16S,21S,26S)-6,21-diisobutyl-16-isopropyl-11-methyl-3,8,13,18,23-pentaoxo-2,4,7,9,12,14,17,19,22,24-decaazaheptacosan-26-aminium, N,N-dimethyl-5-(piperazin-1-ylsulphonyl)naphthalen-1-amine, phenylhydrazine, diethylenetriamine, ethylenediamine, linear poly(ethylenamine), (13S,16R,17R)-16-(7-aminoheptyl)-16-(hydroxymethyl)-13-methyl-7,8,9,11,12,13,14,15,16,17-decahydro-6H-cyclopenta[a]phenanthrene-3,17-diol, or 16(beta)hydroxymethyl-16-(amino[polyethyleneglycol])-1,3,5(10)-estratriene-3,17-diol, N—[N—[(S)-1,3-dicarboxypropyl]carbamoyl]-(S)-lysine, MeO-L-Lys-CO-L-Glu(OMe)-OMe, MeO-L-Lys(CO—(CH₂)₅—NH₂)—CO-L-Glu(OMe)-OMe, CCl₃-CH₂—O-L-Lys-CO-L-Glu(O—CH₂—CCl₃)—OCH₂CCl₃ or cyclic H-Arg(HCl)-Gly-Asp(CH₂CCl₃)-D-Phe-Lys(N₃)—OH.

### (IIa) if:

(i) R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl), provided that R1 or R4 represents 2,5,8,11-tetraoxatridecane, a 1-methyl-3-(5-(trimethylsilyl)pent-4-yn-1-yl), a 1-methyl-3-(anthracen-9-ylmethyl), 1-methyl-3-(3-(trimethylsilyl)propyl) or a heptyl, and
(ii) R2 and R3 represent, independently of one another:
a hydrogen,
an alkyne substituted with a trimethylsilyl,

### (IIb) or if:

(i) R2 and R3 represent, independently of one another, a hydrogen or an alkyne substituted with a trimethylsilyl, provided that R2 or R3 represents an alkyne substituted with a trimethylsilyl,
(ii) R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl);
then:

L represents:

cyclohexylamine, morpholine, valine or its esters, phenylalanine or its esters, Leu-Gly or Leu-Gly-OMe, Val-Phe-Gly or Val-Phe-Gly-OMe, Ile-Lys-Gly or Ile-Lys-Gly-OMe, (methoxy)polyethylene glycol amine, methyl 6-aminohexanoate, prolinol, prolinamide, ethanolamine, (6S,11S,16S,21S,26S)-6,21-diisobutyl-16-isopropyl-11-methyl-3,8,13,18,23-pentaoxo-2,4,7,9,12,14,17,19,22,24-decaazaheptacosan-26-aminium, N,N-dimethyl-5-(piperazin-1-ylsulphonyl)naphthalen-1-amine, phenylhydrazine, diethylenetriamine, ethylenediamine, linear poly(ethylenamine), pyridine or 3-bromopyridine, (13S,16R,17R)-16-(7-aminoheptyl)-16-(hydroxymethyl)-13-methyl-7,8,9,11,12,13,14,15,16,17-decahydro-6H-cyclopenta[a]phenanthrene-3,17-diol, or 16(beta)hydroxymethyl-16-(amino[polyethyleneglycol])-1,3,5(10)-estratriene-3,17-diol, N—[N—[(S)-1,3-dicarboxypropyl]carbamoyl]-(S)-lysine, MeO-L-Lys-CO-L-Glu(OMe)-OMe, MeO-L-Lys(CO—(CH₂)₅—NH₂)—CO-L-Glu(OMe)-OMe, CCl₃-CH₂—O-L-Lys-CO-L-Glu(O—CH₂—CCl₃)—OCH₂CCl₃ or cyclic H-Arg(HCl)-Gly-Asp(CH₂CCl₃)-D-Phe-Lys(N₃)—OH.

X represents iodine, bromine or chlorine.

A particularly advantageous embodiment of the invention relates to a compound of group 34, of the following formula I:

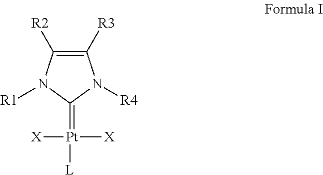

in which:
(i) R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl);
(ii) R2 and R3 represent, independently of one another:
a hydrogen,
an alkyne substituted with a trimethylsilyl,
   (iii) X represents iodine, bromine or chlorine; and
   (iv) L represents:

valine or its esters, phenylalanine or its esters, Leu-Gly or Leu-Gly-OMe, Val-Phe-Gly or Val-Phe-Gly-OMe, Ile-Lys-Gly or Ile-Lys-Gly-OMe, (methoxy)polyethylene glycol amine, methyl 6-aminohexanoate, prolinol, prolinamide, ethanolamine, (6S,11S,16S,21S,26S)-6,21-diisobutyl-16-isopropyl-11-methyl-3,8,13,18,23-pentaoxo-2,4,7,9,12,14,17,19,22,24-decaazaheptacosan-26-aminium, N,N-dimethyl-5-(piperazin-1-ylsulphonyl)naphthalen-1-amine, phenylhydrazine, diethylenetriamine, ethylenediamine, linear poly(ethylenamine), (13S,16R,17R)-16-(7-aminoheptyl)-16-(hydroxymethyl)-13-methyl-7,8,9,11,12,13,14,15,16,17-decahydro-6H-cyclopenta[a]phenanthrene-3,17-diol, or 16(beta)hydroxymethyl-16-(amino[polyethyleneglycol])-1,3,5(10)-estratriene-3,17-diol, N—[N—[(S)-1,3-dicarboxypropyl]carbamoyl]-(S)-lysine, MeO-L-Lys-CO-L-Glu(OMe)-OMe, MeO-L-Lys(CO—(CH₂)₅—NH₂)—CO-L-Glu(OMe)-OMe, CCl₃-CH₂—O-L-Lys-CO-L-Glu(O—CH₂—CCl₃)—OCH₂CCl₃ or cyclic H-Arg(HCl)-Gly-Asp(CH₂CCl₃)-D-Phe-Lys(N₃)—OH.

Another particularly advantageous embodiment of the invention relates to a compound of group 35, of the following formula I:

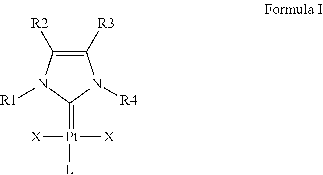

in which:
(i) R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl), provided that R1 or R4 represents 2,5,8,11-tetraoxatridecane, a 1-methyl-3-(5-(trimethylsilyl)pent-4-yn-1-yl), a 1-methyl-3-(anthracen-9-ylmethyl), 1-methyl-3-(3-(trimethylsilyl)propyl) or a heptyl, and
(ii) R2 and R3 represent, independently of one another:
a hydrogen,
an alkyne substituted with a trimethylsilyl,
   (iii) L represents:
   cyclohexylamine, morpholine, valine or its esters, phenylalanine or its esters, Leu-Gly or Leu-Gly-OMe, Val-Phe-Gly or Val-Phe-Gly-OMe, Ile-Lys-Gly or Ile-Lys-Gly-OMe, (methoxy)polyethylene glycol amine, methyl 6-aminohexanoate, prolinol, prolinamide, ethanolamine, (6S,11S,16S,21S,26S)-6,21-diisobutyl-16-isopropyl-11-methyl-3,8,13,18,23-pentaoxo-2,4,7,9,12,14,17,19,22,24-decaazaheptacosan-26-aminium, N,N-dimethyl-5-(piperazin-1-ylsulphonyl)naphthalen-1-amine, phenylhydrazine, diethylenetriamine, ethylenediamine, linear poly(ethylenamine), pyridine, 3-bromopyridine, (13S,16R,17R)-16-(7-aminoheptyl)-16-(hydroxymethyl)-13-methyl-7,8,9,11,12,13,14,15,16,17-decahydro-6H-cyclopenta[a]phenanthrene-3,17-diol, or 16(beta)hydroxymethyl-16-(amino[polyethyleneglycol])-1,3,5(10)-estratriene-3,17-diol, N—[N—[(S)-1,3-dicarboxypropyl]carbamoyl]-(S)-lysine, MeO-L-Lys-CO-L-Glu(OMe)-OMe, MeO-L-Lys(CO—(CH₂)₅—NH₂)—CO-L-Glu(OMe)-OMe, CCl₃—CH₂—O-L-Lys-CO-L-Glu(O—CH₂—CCl₃)—OCH₂CCl₃ or cyclic H-Arg(HCl)-Gly-Asp(CH₂CCl₃)-D-Phe-Lys(N₃)—OH.
   (iv) X represents iodine, bromine or chlorine.

Another particularly advantageous embodiment of the invention relates to a compound of group 36, of the following formula I:

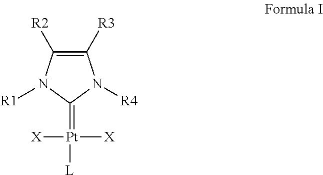

in which:
(i) R2 and R3 represent, independently of one another, a hydrogen or an alkyne substituted with a trimethylsilyl, provided that R2 or R3 represents an alkyne substituted with a trimethylsilyl,
(ii) R1 and R4 represent, independently of one another: 2,5,8,11-tetraoxatridecane, a heptyl, a methyl, a benzyl, a mesityl, a 1-methyl-3-(5-(trimethylsilyl)pent-4-yn-1-yl), a 1-methyl-3-(anthracen-9-ylmethyl), 1-methyl-3-(3-(trimethylsilyl)propyl);
(iii) L represents:
cyclohexylamine, morpholine, valine or its esters, phenylalanine or its esters, Leu-Gly or Leu-Gly-OMe, Val-Phe-Gly or Val-Phe-Gly-OMe, Ile-Lys-Gly or Ile-Lys-Gly-OMe, (methoxy)polyethylene glycol amine, methyl 6-aminohexanoate, prolinol, prolinamide, ethanolamine, (6S,11S,16S,21S,26S)-6,21-diisobutyl-16-isopropyl-11-methyl-3,8,13,18,23-pentaoxo-2,4,7,9,12,14,17,19,22,24-decaazaheptacosan-26-aminium, N,N-dimethyl-5-(piperazin-1-ylsulphonyl)naphthalen-1-amine, phenylhydrazine, diethylenetriamine, ethylenediamine, linear poly(ethylenamine), pyridine, 3-bromopyridine, (13S,16R,17R)-16-(7-aminoheptyl)-16-(hydroxymethyl)-13-methyl-7,8,9,11,12,13,14,15,16,17-decahydro-6H-cyclopenta[a]phenanthrene-3,17-diol, or 16(beta)hydroxymethyl-16-(amino[polyethyleneglycol])-1,3,5(10)-estratriene-3,17-diol, N—[N—[(S)-1,3-dicarboxypropyl]carbamoyl]-(S)-lysine, MeO-L-Lys-CO-L-Glu(OMe)-OMe, MeO-L-Lys(CO—(CH₂)₅—NH₂)—CO-L-Glu(OMe)-OMe, CCl₃—CH₂—O-L-Lys-CO-L-Glu(O—CH₂—CCl₃)—OCH₂CCl₃ or cyclic H-Arg(HCl)-Gly-Asp(CH₂CCl₃)-D-Phe-Lys(N₃)—OH,
(iv) X represents iodine, bromine or chlorine.

The present invention also relates to a compound of formula I as described above, in particular belonging to one of the groups 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or 36, for use as a medicinal product.

More particularly, the present invention relates to a compound of formula I as described above, in particular belonging to one of the groups 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or 36, for use as a medicinal product in the treatment of cancers.

Even more particularly, the present invention relates to a compound of formula I as described above, in particular belonging to one of the groups 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or 36, for use as a selective inhibitor of the growth of cancer cells.

As an example, the compound of example 14 is a selective inhibitor of the growth of cancer cells.

Advantageously, the present invention relates to a compound of formula I as described above, in particular belonging to one of the groups 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or 36, for use as an inhibitor of the growth of cancer cells and as anti-angiogenic agent.

As an example, the compound of example 34 is an inhibitor of the growth of cancer cells and an anti-angiogenic agent.

The present invention also relates to a pharmaceutical composition comprising a compound of formula I as described above, in particular belonging to one of the groups 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or 36, as the active ingredient, and a pharmaceutically acceptable vehicle.

A pharmaceutically acceptable vehicle is selected from those known to a person skilled in the art.

More particularly, the present invention relates to a pharmaceutical composition comprising a compound of formula I as described above, in particular belonging to one of the groups 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or 36, as the active ingredient, and a pharmaceutically acceptable vehicle, used in cancer treatment.

Said cancer which can be treated with the pharmaceutical composition according to the invention is selected from cervical cancer, glioma, colon cancer, breast cancer, pancreatic cancer, prostate cancer, liver cancer, lung cancer, stomach cancer, intestinal cancer, cancer, melanoma, multiple myeloma.

The present invention relates to a process for preparing a compound, as described above, represented by the following formula I:

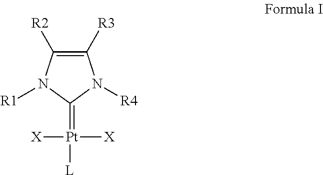

in which:

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

X represents iodine, bromine or chlorine,

L representing:
(i) an amine of formula

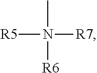

in which R5, R6 and R7 represent, independently of one another:
   (a) a hydrogen,
   (b) a linear or branched C1-C20 alkyl, optionally substituted with an estradiol,
   (c) an aryl group having 1, 2 or 3 aromatic rings, in particular phenyl, or aralkyl with a C1-C12, in particular C1-C8 carbon chain, the aryl, or aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(vi) a linear or branched amino ester with 2 to 20 carbon atoms, in particular with 2 to 10 carbon atoms,
(vii) a linear or branched amino amide with 2 to 20 carbon atoms, in particular prolinamide
(viii) an amino acid in particular selected from the 20 proteinogenic α-amino acids or their esters or amides, and in particular selected from alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(ix) a beta or gamma amino acid or its esters or amides,
(x) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(xi) a morpholine,
(xii) a pyridine, a pyridine substituted with iodine, bromine or chlorine, in particular 3-bromopyridine, or 3-chloropyridine, or disubstituted with iodine, bromine or chlorine, in particular 3,5-dibromopyridine
(xiii) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xiv) a piperazine N-substituted with a dansyl or dabsyl group
(xv) a hydrazine monosubstituted with an aryl having 1, 2 or 3 aromatic rings, in particular a phenyl, or a linear or branched alkyl with 1 to 12 carbon atoms,
(xvi) a glucamine optionally N-substituted with an alkyl group with 1 to 20 carbon atoms, in particular N-methylglucamine, N-ethylglucamine or N-dodecylglucamine,
(xvii) a glucosamine optionally N-substituted with an alkyl group with 1 to 20 carbon atoms,
(xviii) a pseudopeptide of general formula H—(NH—CH(R)—CH₂—Y—CO)ₙ—NHR″, with R being a side chain of one of the 20 proteinogenic amino acids; Y being independently, throughout the sequence, CH₂, O or NH; n=1-15; R″=H, or short alkyl, or aralkyl chain,
(xix) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xx) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1:

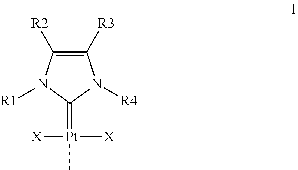

where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
   in particular for preparing a compound of the following formula Ia:

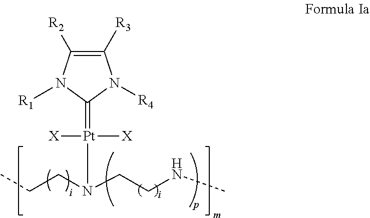

in which

R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,

and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,

X represents iodine, bromine or chlorine,

m=1 to 1000, in particular m=1 to 100, more particularly from 1 to 50,

p=0 to 50, in particular p=1 to 20, more particularly from 1 to 10, p representing the ratio of the number of platinum atoms to the number of amines of —NH— or —NH₂ type,

i=1, 2 or 3, said process comprising:

(I) reacting a compound of formula III:

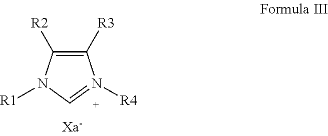

in which:

(a) R1, R2, R3, R4 have the meanings stated above,

(b) Xa represents iodine, bromine or chlorine, or a counter-anion such as mesylate, tosylate, tetrafluoroborate, hexafluorophosphate, with the following molecules:

(ii) Pt(Xb)₂, in which Xb represents iodine, bromine or chlorine, and
(iii) a ligand L₁, L₁ representing a pyridine, a pyridine substituted with iodine, bromine or chlorine, in particular 3-bromopyridine, or 3-chloropyridine, or disubstituted with iodine, bromine or chlorine, in particular 3,5-dibromopyridine, and
(iv) optionally NaXc in excess, Xc representing iodine, bromine or chlorine, said reaction being carried out optionally in the presence of a solvent, in particular toluene, to obtain a compound of the following formula II:

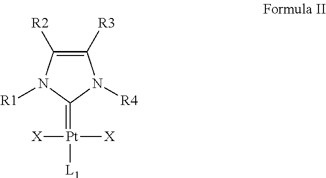

in which

R1, R2, R3, R4 and X have the meanings stated above,

L₁ representing a pyridine, or a pyridine substituted with iodine, bromine or chlorine, in particular 3-bromopyridine, or 3-chloropyridine, or disubstituted with iodine, bromine or chlorine, in particular 3,5-dibromopyridine, and optionally

(II) reaction of the compound of the above formula II with a ligand L₂, carried out optionally in the presence of a solvent, to obtain a platinum-carbene complex of the above formula I, L₂ representing:
(i) an amine of formula

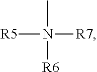

in which R5, R6 and R7 represent, independently of one another:
   (a) a hydrogen,
   (b) a non-cyclized linear or branched C1-C20 alkyl, optionally substituted with an estradiol,
   (c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
   (d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
   (e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
   a linear or branched C1-C6 alkyl,
   an aryl group having 1, 2 or 3 aromatic rings, in particular phenyl, or aralkyl with a C1-C12, in particular C1-C8 carbon chain,
   a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xvii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group.
(xviii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100.

The bond between Pt and ligand L₁ represented by a solid line in formula II does not correspond to a covalent bond, but to a coordination bond.

The compound of formula III is commercially available, or can be prepared by the processes described according to the reference Chardon et al., (Chem. Rev. 2011, 111, 2705-2733).

PtCl₂, PtBr₂ or PtI₂ are commercially available.

The following examples describe the preparation of certain compounds according to the invention. These examples are not limitative and are only intended to illustrate the present invention.

### Materials and Methods:

The ¹H NMR spectrum is measured on a Brucker Avance 300 spectrometer. The frequencies are 300 MHz for proton spectroscopy (¹H NMR).

The ¹³C NMR spectrum is measured on a Brucker Avance 300 spectrometer. The frequencies are 75 MHz for carbon spectroscopy (¹³C NMR). The chemical shifts (δ) are stated in parts per million (ppm), using the residual signals of the deuterated solvent as reference.

X-ray diffraction (ORTEP diagrams) was carried out on a Nonius Kappa-CCD or Bruker APEX II DUO Kappa-CCD diffractometer.

### Principle of the MTS Assay for Measuring Cellular Viability:

MTS [3-(4,5-dimethylthiazol-2-yl)-5-(3-carboxymethoxyphenyl)-2-(4-sulphophenyl)-2H-tetrazolium] is reduced to formazan (coloured compound, the optical density of which is measured at 492 nm) by the mitochondrial dehydrogenases. Only the live cells will reduce MTS to formazan, which will be released in the medium. The optical density measured at 492 nm is directly proportional to the number of live cells.

MTS [3-(4,5-dimethylthiazol-2-yl)-5-(3-carboxymethoxyphenyl)-2-(4-sulphophenyl)-2H-tetrazolium], soluble in the culture medium, can be reduced to formazan (coloured product) by the mitochondrial dehydrogenases of the live cells. The measured optical density (492 nm) is therefore directly proportional to the quantity of live cells. The cells are deposited in a 96-well plate at 1.10⁴ cells per well in 100 μL of RPMI 5% FCS. The cells are then treated with the various molecules at the desired concentrations and then incubated for 48 h at 37° C. (5% CO₂). After treatment, 20 μL of MTS is added to each well. After incubation for two hours at 37° C. the optical density is measured at an absorbance of 492 nm using the plate reader Wallac Victor 2 Multi-label Counter (Technical University of Denmark, Kongens Lyngby, Denmark). All the treatments are carried out in triplicate. The blank, determined by incubating RPMI with MTS, is deducted from the values of the wells containing cells. The percentage of live cells is calculated from the following formula: (OD experiment*100)/OD control. MTS [3-(4,5-dimethylthiazol-2-yl)-5-(3-carboxymethoxyphenyl)-2-(4-sulphophenyl)-2H-tetrazolium] is marketed by the company Promega (Madison, Wis.).

### Measurement of Water-Solubility

1 to 5 mg of compound is solubilized in a minimum of water (by adding microdrops using a microsyringe), under ambient conditions of temperature and pressure; the solubility in water, expressed in g/L, corresponds to the ratio of said mass of compound to the total volume of water added for complete dissolution, observed using a magnifying optical system, for example a magnifying glass.

### Measurement of the Value of the Inhibitory Concentration IC₅₀

The cytotoxicity of the compounds according to the invention is measured in vitro on the Hela and U87 cell lines.

U87: stage IV glioblastoma, expresses αVβ5 and can be used as a xenograft

HeLa: metastatic ovarian cancer (used classically for testing platinum-based molecules)

The cytotoxicity of a compound with respect to a cancer cell line is evaluated from the value of the inhibitory concentration IC₅₀ of said compound with respect to said cell line.

The MTS assay gives an optical density signal that is proportional to the quantity of live cells (in a linear range). These values, as well as the untreated controls, are used for calculating the percentage of live cells at each concentration. IC50 is only calculated when the concentrations used make it possible to cover the values from 0 to 100%. The IC₅₀ values are calculated on the basis of 4-parameter fitting using the Sigma Plot software.

The results obtained are illustrated below. The compounds of examples 4, 5, 7, 10, 15 and 18 tested in this experiment show higher cytotoxic activity than cisplatin on the HeLa and U87 cell lines. The compound of example 20 also has higher cytotoxic activity than cisplatin on the U87 cell line. The compound of example 34 has cytotoxic activity almost identical to that of cisplatin and has better water-solubility.

| Structure | DMSO | Cisplatin 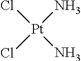 | Example 4 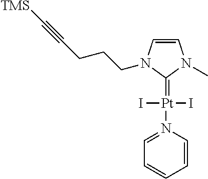 | Example 5 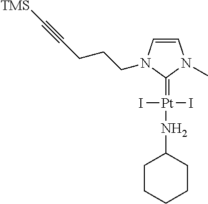 |
|---|---|---|---|---|
| IC₅₀ {Hela} (in μM) | not | 26.2 | 2.0 | 3.2 |
| | cytotoxic | | | |
| IC₅₀ {U87} (in μM) | not | 8.0 | 2.0 | 2.0 |
| | cytotoxic | | | |
| Water-solubility | — | 2.5 | — | — |
| (in g/L) | | | | |

| Structure | Example 7 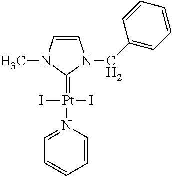 | Example 10 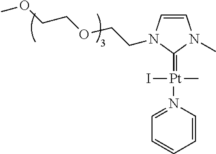 | Example 15 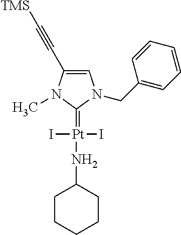 |
|---|---|---|---|
| IC₅₀ {Hela} (in μM) | 5.9 | 15 | 3.0 |
| IC₅₀ {U87} (in μM) | 1.1 | 2.5 | 2.0 |
| Water-solubility | — | — | — |
| (in g/L) | | | |
| Structure | Example 17 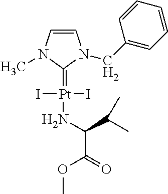 | Example 20 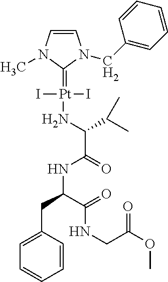 | Example 34 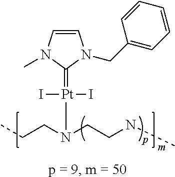 |
| IC₅₀ {Hela} (in μM) | 7.2 | 39.6 | 28.4 |
| IC₅₀ {U87} (in μM) | 5.0 | 3.0 | 8.3 |
| Water-solubility | — | — | 6.7 |
| (in g/L) | | | |

The cytotoxicity of the compounds according to the invention is also measured in vitro on the cell lines MCF7, HCT116, PC3, SK-OV3, OVCAR-8, EPC.

MCF7: breast carcinoma

HCT 116: colon carcinoma

PC3: prostatic adenocarcinoma

SK-OV-3 and OVCAR8: ovarian adenocarcinomas

EPC: endothelial progenitor cells

The endothelial progenitor cells (EPC) play an important role in angiogenesis and vasculogenesis; these last-mentioned contribute to tumour growth, are mobilized by cytokines secreted at cancer sites and contribute to postnatal vasculogenesis and to pathological neovascularization. The cytotoxicity of a compound against an EPC line thus shows the anti-angiogenic and anti-vasculogenic effects of said compound.

The cytotoxicity of a compound against a cancer cell line is evaluated. The following table shows the results obtained with examples described above, which possess cytotoxic activities that are better or almost the same as those of cisplatin for all the ICₛₒ values, measured in μM.

| Structure | | Cisplatin 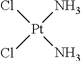 | Example 9 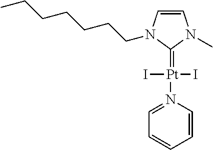 | Example 14 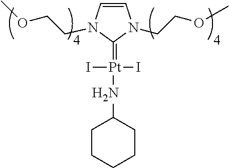 |
|---|---|---|---|---|
| IC₅₀ | {MCF7} | >10 | 0.2 | — |
| (in μM) | {HCT116} | 5.5* | 0.1 | — |
| | {PC3} | 5.1* | 0.7 | — |
| | {SK-OV3} | >10 | 0.2 | 6.2 |
| | {OVCAR8} | >10 | — | 3.9 |
| | {EPC} | >10 | 1.0 | — |

| | | | |
|---|---|---|---|
| Water-solubility | 2.5 | — | — |
| (in g/L) | | | |

| Structure | | Example 18 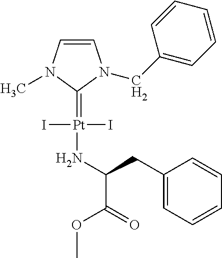 | Example 21 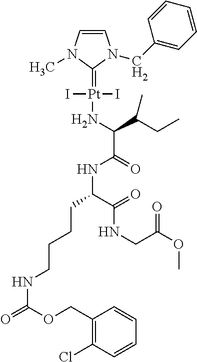 | Example 25 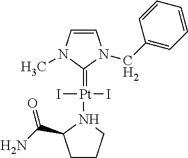 |
|---|---|---|---|---|
| IC₅₀ | {MCF7} | 0.2 | 4.1 | 0.2 |
| (in μM) | {HCT116} | 0.1 | 1.9 | 0.1 |
| | {PC3} | 0.3 | 4.6 | 0.3 |
| | {SK-OV3} | 0.1 | 3.7 | 0.2 |
| | {OVCAR8} | — | — | — |
| | {EPC} | — | — | — |

| | | | |
|---|---|---|---|
| Water-solubility | — | — | — |
| (in g/L) | | | |

*These IC50 values were measured by first dissolving cisplatin in water.
The IC50 values when cisplatin is dissolved beforehand in DMSO are >10 μM.

| Structure | | Example 26 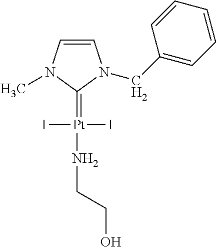 | Example 28 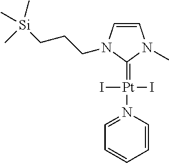 | Example 30 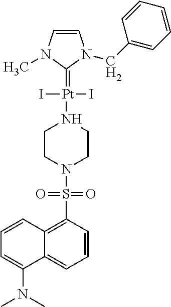 |
|---|---|---|---|---|
| IC₅₀ | {MCF7} | 0.3 | 0.2 | 0.1 |
| (in μM) | {HCT116} | 0.1 | 0.1 | 0.1 |
| | {PC3} | 0.6 | 0.5 | 0.6 |
| | {SK-OV3} | 0.2 | 0.2 | 0.1 |
| | {OVCAR8} | — | — | — |
| | {EPC} | — | 0.6 | — |

| | | | |
|---|---|---|---|
| Water-solubility | — | — | — |
| (in g/L) | | | |

| Structure | | Example 34 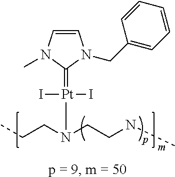 | Example 39 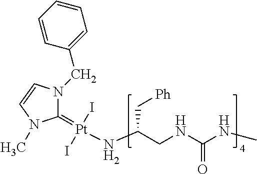 |
|---|---|---|---|
| IC₅₀ | {MCF7} | 1.7 | 0.6 |
| (in μM) | {HCT116} | 1.0 | 0.4 |
| | {PC3} | 2.8 | 1.4 |
| | {SK-OV3} | 1.2 | 0.6 |
| | {OVCAR8} | — | — |
| | {EPC} | — | 1.9 |

| | | |
|---|---|---|
| Water-solubility | 6.7 | — |
| (in g/L) | | |

The following table shows the percentages of cellular inhibition of the compounds according to the invention with respect to the cell lines KB, SK-OV3, OVCAR-8, HL60, MCF7, HCT116, PC3, MRCS, Vero and EPC.

KB: buccal carcinoma

SK-OV-3 and OVCAR8: ovarian adenocarcinomas

HL60: leukaemia

MCF7: breast carcinoma

HCT 116: colon carcinoma

PC3: prostatic adenocarcinoma

MRCS: human fetal lung cells

Vero: monkey kidney epithelial cells

EPC: endothelial progenitor cells

The results obtained are presented below. The compounds tested in this experiment at the final concentrations of 10 μM in the biological medium show very much higher cytotoxic activity than that of cisplatin. A structure-activity relation is demonstrated: replacement of a 2,5,8,11-tetraoxatridecane group (example 14) with a methyl group on the carbene skeleton (example 13) improves the activity of inhibition of cell growth.

The compound of example 14 displays activity of inhibition of cell growth that is selective with respect to the ovarian cancer cells SKOV-3 and OVCAR8 with low cytotoxicity on the non-cancerous cells MRCS, Vero and EPC. The compound of example 34 displays cytotoxic activity on all of the cancer cells tested and has low cytotoxicity with respect to the non-cancerous cells MRCS and Vero. Compounds 4, 5, 9, 13, 18, 19, 21, 22, 23, 24, 25, 26, 27, 28, 30, 34 and 39 show anti-angiogenic activity by inhibition of growth of EPC cells.

| Structure | | Cisplatin 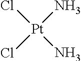 | Example 4 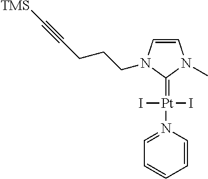 | Example 5 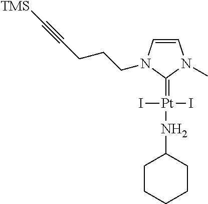 |
|---|---|---|---|---|
| Inhi- | {KB} | 3.6 | 99.6 | 99.2 |
| bition | {SK-OV3} | 4.4 | 99.4 | 94.3 |
| (in %) | {OVCAR8} | −1.8 | 97.8 | 94.2 |
| | {HL60} | −10.6 | 98.0 | 93.6 |
| | {MCF7} | −4.1 | 97.8 | 96.3 |
| | {HCT116} | 2.7 | 98.0 | 97.0 |
| | {PC3} | −6.2 | 92.7 | 89.4 |
| | {MRC5} | −20.4 | — | — |
| | {Vero} | −4.0 | — | — |
| | {EPC} | −1.2 | 98.0 | 96.9 |

| | | | |
|---|---|---|---|
| Water-solubility | 2.5 | — | — |
| (in g/L) | | | |

| Structure | | Example 9 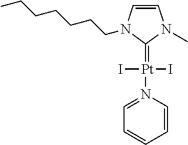 | Example 13 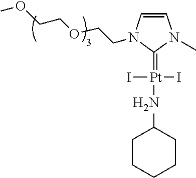 | Example 14 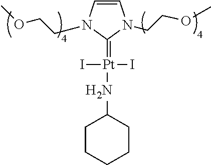 |
|---|---|---|---|---|
| Inhi- | {KB} | 100.8 | 100.4 | 26.6 |
| bition | {SK-OV3} | 98.5 | 90.9 | 62.8 |
| (in %) | {OVCAR8} | 96.8 | 92.4 | 78.4 |
| | {HL60} | 97.2 | 87.3 | 31.2 |
| | {MCF7} | 98.6 | 94.2 | 18.6 |
| | {HCT116} | 98.2 | 94.0 | 31.9 |
| | {PC3} | 91.3 | 83.8 | 5.7 |
| | {MRC5} | — | — | 24.5 |
| | {Vero} | — | — | 17.0 |
| | {EPC} | 100.0 | 96.1 | 27.2 |

| | | | |
|---|---|---|---|
| Water-solubility | — | — | — |
| (in g/L) | | | |

| Structure | | Example 18 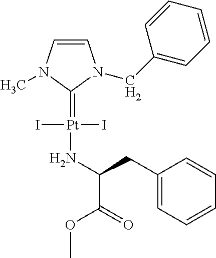 | Example 19 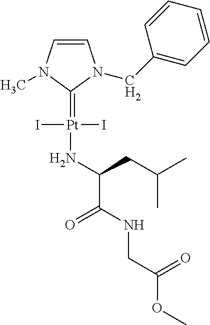 | Example 21 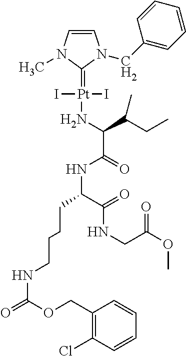 |
|---|---|---|---|---|
| Inhi- | {KB} | 100.7 | 63.2 | 100.1 |
| bition | {SK-OV3} | 97.2 | 85.7 | 95.9 |
| (in %) | {OVCAR8} | 94.0 | 86.0 | 93.3 |
| | {HL60} | 93.2 | 77.2 | 90.5 |
| | {MCF7} | 97.2 | 62.0 | 96.2 |
| | {HCT116} | 97.3 | 91.7 | 97.2 |
| | {PC3} | 93.8 | 32.5 | 87.0 |
| | {MRC5} | — | — | — |
| | {Vero} | — | — | — |
| | {EPC} | 100.7 | 85.5 | 101.3 |

| | | | |
|---|---|---|---|
| Water-solubility | — | — | — |
| (in g/L) | | | |

| Structure | | Example 22 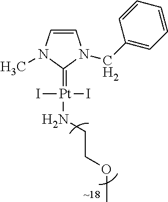 | Example 23 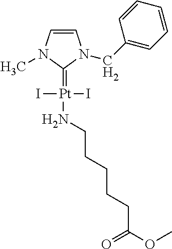 | Example 24 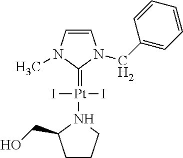 |
|---|---|---|---|---|
| Inhi- | {KB} | 77.8 | 101.2 | 99.8 |
| bition | {SK-OV3} | 90.3 | 95.0 | 97.6 |
| (in %) | {OVCAR8} | 90.0 | 92.8 | 94.8 |
| | {HL60} | 87.4 | 91.6 | 92.9 |
| | {MCF7} | 91.7 | 96.2 | 96.5 |
| | {HCT116} | 94.3 | 95.6 | 97.2 |
| | {PC3} | 78.5 | 86.1 | 94.2 |
| | {MRC5} | — | — | — |
| | {Vero} | — | — | — |
| | {EPC} | 93.7 | 98.1 | 99.0 |

| | | | |
|---|---|---|---|
| Water-solubility | 11.1 | — | — |
| (in g/L) | | | |

| Structure | | Example 25 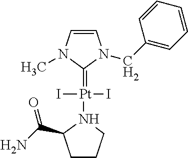 | Example 26 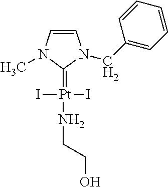 | Example 27 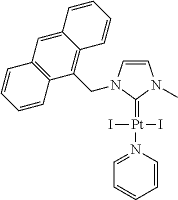 |
|---|---|---|---|---|
| Inhi- | {KB} | 98.6 | 98.2 | 98.3 |
| bition | {SK-OV3} | 97.2 | 97.7 | 96.9 |
| (in %) | {OVCAR8} | 93.5 | 94.0 | 93.9 |
| | {HL60} | 91.0 | 92.5 | 91.3 |
| | {MCF7} | 96.2 | 96.3 | 95.4 |
| | {HCT116} | 96.6 | 96.6 | 95.9 |
| | {PC3} | 94.6 | 94.0 | 88.3 |
| | {MRC5} | — | — | — |
| | {Vero} | — | — | — |
| | {EPC} | 96.1 | 99.1 | 99.1 |

| | | | |
|---|---|---|---|
| Water-solubility | — | — | — |
| (in g/L) | | | |

| Structure | | Example 28 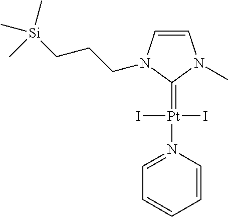 | Example 30 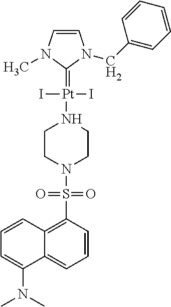 | Example 34 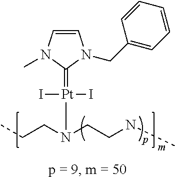 |
|---|---|---|---|---|
| Inhi- | {KB} | 99.8 | 100.8 | 64.0 |
| bition | {SK-OV3} | 100.4 | 97.7 | 99.1 |
| (in %) | {OVCAR8} | 98.0 | 96.3 | 79.1 |
| | {HL60} | 99.6 | 95.3 | 97.0 |
| | {MCF7} | 99.2 | 99.3 | 98.2 |
| | {HCT116} | 99.4 | 99.8 | 90.1 |
| | {PC3} | 91.5 | 99.3 | 64.2 |
| | {MRC5} | — | — | 26.4 |
| | {Vero} | — | — | 19.5 |
| | {EPC} | 100.3 | 99.9 | 95.8 |

| | | | |
|---|---|---|---|
| Water-solubility | — | — | 6.7 |
| (in g/L) | | | |

| Structure | | Example 39 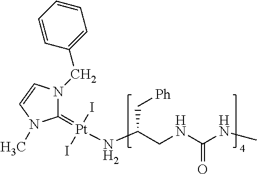 |
|---|---|---|
| Inhi- | {KB} | 101.2 |
| bition | {SK-OV3} | 95.2 |
| (in %) | {OVCAR8} | 92.1 |
| | {HL60} | 91.0 |
| | {MCF7} | 95.9 |
| | {HCT116} | 96.1 |
| | {PC3} | 90.9 |
| | {MRC5} | — |
| | {Vero} | — |
| | {EPC} | 99.3 |

| | |
|---|---|
| Water-solubility | — |
| (in g/L) | |

### Stability Testing

Solutions of the test compounds and of cisplatin are prepared according to the procedure described above (Sundquist et al., Inorg. Chem. 1987, 26, 1524). Cytotoxicity tests on the two cell lines Hela and U87 were carried out one hour after preparation of the solutions and about 14 days later: the cytotoxicity of the solutions tested about 14 days after being prepared is of the same order of magnitude as that of the solutions tested one hour after they were prepared.

The tests were carried out on the Hela cell line for the following compounds: cisplatin, the compound described in example 4 (trans-diiodo(N-pyridine)[1-methyl-3-(5-(trimethylsilyl)pent-4-yn-1-yl)imidazol-2-ylidene]platinum(II)), the compound described in example 10 (trans-diiodo(N-pyridine)[1-methyl-3-(2,5,8,11-tetraoxatridecan-13-yl)imidazol-2-ylidene]platinum(II)), and the compound described in example 17 (trans-diiodo(N-(L)valine methyl ester)[1-methyl-3-benzyl-imidazol-2-ylidene]platinum(II)).

The tests were carried out on the U87 cell line for the following compounds: cisplatin, the compound described in example 4, the compound described in example 5 (trans-diiodo(N-cyclohexylamine)[1-methyl-3-(5-(trimethylsilyl)pent-4-yn-1-yl)imidazol-2-ylidene]platinum(II)), the compound described in example 7 (trans-diiodo(N-pyridine)[1-methyl-3-benzyl-imidazol-2-ylidene]platinum(II)), the compound described in example 10, the compound described in example 15 (trans-diiodo(N-cyclohexylamine)[1-methyl-3-benzyl-5-((trimethylsilyl)ethynyl)imidazol-2-ylidene]platinum(II)), and the compound described in example 17.

Investigations In Vivo:

1) Manipulations on Human Cells:

Human tumour cells (HCT116 for example) are injected into immunodeficient nude mice.

The mice are treated by injecting a solution of a compound of the invention at different times after injection of the tumour cells (from D+2 to the moment when the presence of palpable tumours is detected).

The size of the tumours is monitored over time and is measured with a calliper gauge.

The tumours are removed; the type of cell death is investigated by treatment with collagenase, recovery of the tumour cells and measurement of apoptosis and/or of necrosis by annexin/IP labelling in flow cytometry. It is also possible to prepare protein extracts and then study the cleavage of the various caspases.

The type of cell death can also be investigated by embedding the tumour, then taking sections and verifying cell death by immunohistochemistry (for example by the TUNEL technique).

Tumour vascularization is investigated by embedding the tumours and verifying the presence and quality of the vessels by histochemistry or immunofluorescence.

2) Manipulations on Murine Models:

2) a) Implanted Tumour Models

Murine tumour cells are injected into immunocompetent mice (RenCa (renal carcinoma), B16F10 (melanoma), or TC1 (lung cancer)) subcutaneously (solid tumours) or intravenously (disseminated tumours of the metastasis type).

The mice are treated by injecting a solution of a compound of the invention at different times after injection of the tumour cells (from D+2 to the moment when the presence of palpable tumours is detected).

The size of the subcutaneous tumours is monitored over time and is measured with a calliper gauge. For the disseminated tumours, the mouse is killed and the number of tumour nodules in the lungs is evaluated.

Tumour vascularization is investigated as stated above.

The anti-tumour immune response is investigated in the blood and in the spleen or the lymph nodes.

In the blood, investigation for tumour-specific CD8+ T cells is conducted by means of tetramers in flow cytometry. A tetramer is a fluorescent construct composed of 4 molecules of CMH of class I bearing a peptide derived from a TAA (tumour associated antigen) selected as a function of the RenCa, B16F10, or TC1 model used. The TCR of the tumour-specific CD8+ T cells binds to the tetramer and the cells then become fluorescent.

Regarding the spleen or the lymph nodes, the mice are killed and the splenocytes (spleen) or the gangliocytes (lymph nodes) are taken. The cells thus obtained are cultured in the presence of the TAAs or the tumour cells, and the cellular proliferation and cytokine production (by ELISA and by ELISPOT) in response to the TAA and/or to the tumour cells are measured.

2) b) Models of Spontaneous Tumours

The studies are carried out with a procedure similar to that described above, using one of the following models: PyMt (spontaneous breast tumours) or Ret (spontaneous melanomas).

The following examples 1 to 43 illustrate the invention.

### EXAMPLE 1

### trans-diiodo(N-pyridine)[1-methyl-3-(3-(trimethylsilyl)prop-2-yn-1-yl)-imidazol-2-ylidene]platinum(II)

NaI (117 mg; 0.781 mmol), K₂CO₃ (108 mg; 0.781 mmol), PtCl₂ (21 mg; 0.078 mmol) and 1-methyl-3-(3-(trimethylsilyl)prop-2-yn-1-yl)-1H-imidazolium iodide (25 mg; 0.078 mmol) are suspended in pyridine (1 mL). The solution is sonicated for 10 minutes, and then heated for 3 h at 100° C. The solvent is evaporated off, the crude product is taken up in dichloromethane and filtered on Celite. The filtrate is purified by flash chromatography, eluting with a mixture of dichloromethane and cyclohexane (1/1 by volume). This gives 52 mg (92%) of trans-diiodo(N-pyridine)[1-methyl-3-(3-(trimethylsilyl)prop-2-yn-1-yl)imidazol-2-ylidene]platinum(II), illustrated below:

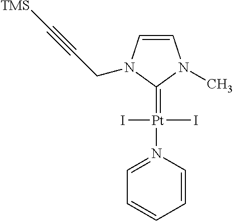

in the form of a yellow powder, which has the following characteristics:

¹H NMR spectrum (CDCl₃): δ 0.21 (s, 9H); 3.96 (s, 3H); 5.32 (s, 2H); 6.86 (d, 1H); 7.20 (d, 1H); 7.29-7.36 (m, 2H); 7.73 (t, 1H); 9.03 (d, 2H)

¹³C NMR spectrum (CDCl₃): δ−0.2; 38.4; 41.7; 93.0; 97.4; 119.9; 121.7; 125.0; 136.1; 136.1; 153.7

Mass spectrum (positive ESI mode): calculated for C₁₅H₂₁N₃IPtSi: 593.02. found: 593.04

### EXAMPLE 2

### trans-diiodo(N-pyridine)[1-mesityl-3-(3-(trimethylsilyl)prop-2-yn)-imidazol-2-ylidene]platinum(II)

NaI (88 mg; 0.589 mmol), K₂CO₃ (81 mg; 0.589 mmol), PtCl₂ (16 mg; 0.059 mmol) and 1-mesityl-3-(3-(trimethylsilyl)prop-2-yn-1-yl)-1H-imidazolium iodide (25 mg; 0.059 mmol) are suspended in pyridine (1 mL). The solution is sonicated for 10 minutes, and then heated for 3 h at 100° C. The solvent is evaporated off, the crude product is taken up in dichloromethane and filtered on Celite. The filtrate is purified by flash chromatography, eluting with a mixture of dichloromethane and cyclohexane (1/1 by volume). This gives 14 mg (28%) of trans-diiodo(N-pyridine)[1-mesityl-3-(3-(trimethylsilyl)prop-2-yn)imidazol-2-ylidene]platinum(II), illustrated below:

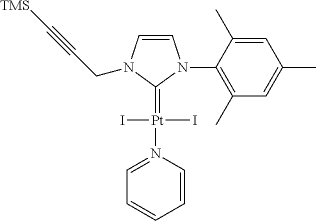

in the form of a yellow powder, which has the following characteristics:

¹H NMR spectrum (CDCl₃): δ 0.25 (s, 9H); 2.33 (s; 6H); 2.34 (s, 3H); 5.55 (s, 2H); 6.82 (d, 1H); 6.98 (s, 2H); 7.21 (m, 2H); 7.43 (d, 1H); 7.61 (t, 1H); 8.75 (d, 2H)

¹³C NMR spectrum (CDCl₃): δ−0.2; 21.2; 21.4; 43.0; 93.3; 97.6; 103.4; 119.9; 123.3; 124.7; 129.3; 135.3; 135.3; 137.3; 139.0; 153.6

Mass spectrum (positive ESI mode): calculated for C₂₃H₂₉N₃IPtSi: 697.08. found: 697.07

### EXAMPLE 3

### trans-dibromo(N-pyridine)[1-mesityl-3-(3-(trimethylsilyl)prop-2-yn)-imidazol-2-ylidene]platinum(II)

NaBr (61 mg; 0.589 mmol), K₂CO₃ (81 mg; 0.589 mmol), PtCl₂ (16 mg; 0.059 mmol) and 1-mesityl-3-(3-(trimethylsilyl)prop-2-yn-1-yl)-1H-imidazolium iodide (25 mg; 0.059 mmol) are suspended in pyridine (1 mL). The solution is sonicated for 10 minutes, and then heated for 20 h at 100° C. The solvent is evaporated off, the crude product is taken up in dichloromethane and filtered on Celite. The filtrate is purified by flash chromatography, eluting with a mixture of dichloromethane and cyclohexane (1/1 by volume). This gives 13 mg (36%) of trans-dibromo(N-pyridine)[1-mesityl-3-(3-(trimethylsilyl)prop-2-yn)imidazol-2-ylidene]platinum(II), illustrated below:

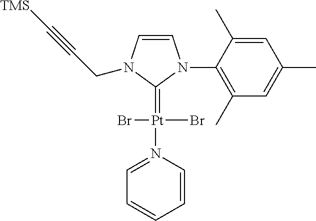

in the form of a yellow powder, which has the following characteristics:

¹H NMR spectrum (CDCl₃): δ 0.25 (s, 9H); 2.33 (s; 6H); 2.36 (s, 3H); 5.55 (s, 2H); 6.82 (d, 1H); 6.98 (s, 2H); 7.21 (m, 2H); 7.43 (d, 1H); 7.61 (t, 1H); 8.75 (d, 2H)

### EXAMPLE 4

### trans-diiodo(N-pyridine)[1-methyl-3-(5-(trimethylsilyl)pent-4-yn-1-yl)-imidazol-2-ylidene]platinum(II)

NaI (224 mg; 1.494 mmol), K₂CO₃ (194 mg; 1.406 mmol), PtCl₂ (41 mg; 0.154 mmol) and 1-methyl-3-(5-(trimethylsilyl)pent-4-yn-1-yl)-1H-imidazolium iodide (50 mg; 0.144 mmol) are suspended in pyridine (1 mL). The solution is sonicated for 10 minutes, and then heated for 20 h at 100° C. The solvent is evaporated off, the crude product is taken up in dichloromethane and filtered on Celite. The filtrate is purified by flash chromatography, eluting with dichloromethane. This gives 54 mg (52%) of trans-diiodo(N-pyridine)[1-methyl-3-(5-(trimethylsilyl)pent-4-yn-1-yl)imidazol-2-ylidene]platinum(II), illustrated below:

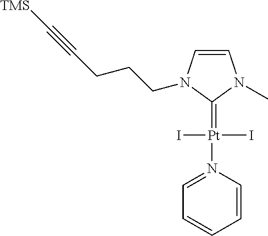

in the form of a yellow powder, which has the following characteristics:

¹H NMR spectrum (CDCl₃): δ 0.12 (s, 9H); 2.26-2.29 (m; 4H); 3.90 (s, 3H); 4.50 (t, 2H); 6.79 (d, 1H); 6.87 (d, 1H); 7.26 (m, 2H); 7.66 (t, 1H); 8.97 (d, 2H)

¹³C NMR spectrum (CDCl₃): δ 0.2; 17.0; 27.8; 38.4; 49.2; 86.4; 105.6; 121.3; 121.8; 124.9; 135.6; 137.4; 153.8

Mass spectrum (positive ESI mode): calculated for C₁₇H₂₅N₃IPtSi: 621.05. found: 621.05

ORTEP diagram illustrated below: obtained by X-ray diffraction. Crystals obtained from a solution in dichloromethane, by slow diffusion of pentane.

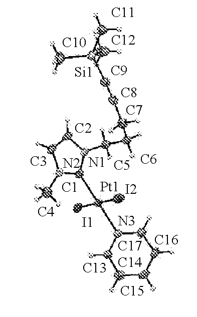

### EXAMPLE 5

### trans-diiodo(N-cyclohexylamine)[1-methyl-3-(5-(trimethylsilyl)pent-4-yn-1-yl)-imidazol-2-ylidene]platinum(II)

NaI (112 mg; 0.747 mmol), K₂CO₃ (99 mg; 0.717 mmol), PtCl₂ (21 mg; 0.079 mmol) and 1-methyl-3-(5-(trimethylsilyl)pent-4-yn-1-yl)-1H-imidazolium iodide (25 mg; 0.072 mmol) are suspended in cyclohexylamine (1 mL). The solution is sonicated for 10 minutes, and then heated for 3 h at 100° C. The solvent is evaporated off, the crude product is taken up in dichloromethane and filtered on Celite. The filtrate is purified by flash chromatography, eluting with a mixture of dichloromethane and cyclohexane (2/1 by volume). This gives 24 mg (43%) of trans-diiodo(N-cyclohexylamine)[1-methyl-3-(5-(trimethylsilyl)pent-4-yn-1-yl)imidazol-2-ylidene]platinum(II), illustrated below:

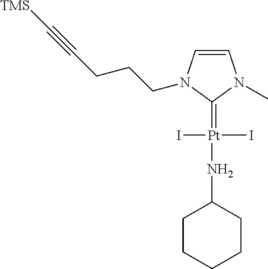

in the form of a yellow powder, which has the following characteristics:

¹H NMR spectrum (CDCl₃): δ 0.17 (s, 9H); 0.96-1.32 (m, 5H); 1.39-1.77 (s; 5H); 2.25-2.29 (m, 4H); 2.71-3.05 (m, 2H); 3.10-3.20 (m, 1H); 3.85 (s, 3H); 4.40 (t, 2H); 6.80 (d, 1H); 6.89 (d, 1H)

¹³C NMR spectrum (CDCl₃): δ 0.6; 17.1; 25.0; 25.5; 28.0; 36.1; 38.4; 49.2; 55.0; 86.5; 105.8; 121.5; 121.8; 139.2

Mass spectrum (positive ESI mode): calculated for C₁₈H₃₃N₃IPtSi: 641.11. found: 641.09

### EXAMPLE 6

### trans-diiodo(N-pyridine)[1-methyl-3-benzyl-5-((trimethylsilyl)ethynyl)-imidazol-2-ylidene]platinum(II)

NaI (228 mg; 1.521 mmol), K₂CO₃ (216 mg; 1.585 mmol), PtCl₂ (76 mg; 0.286 mmol) and 1-methyl-3-benzyl-5-((trimethylsilyl)ethynyl)-1H-imidazolium bromide (100 mg; 0.286 mmol) are suspended in pyridine (5 mL). The solution is sonicated for 10 minutes, and then heated for 3 h at 100° C. The solvent is evaporated off, the crude product is taken up in dichloromethane and filtered on Celite. The filtrate is purified by flash chromatography, eluting with a mixture of dichloromethane and cyclohexane (1/1 by volume). This gives 169 mg (74%) of trans-diiodo(N-pyridine)[1-methyl-3-benzyl-5-((trimethylsilyl)ethynyl)imidazol-2-ylidene]platinum(II), illustrated below:

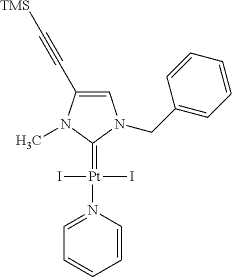

in the form of a yellow powder, which has the following characteristics:

¹H NMR spectrum (CDCl₃): δ 0.22 (s, 9H); 3.99 (s, 3H); 5.69 (s, 2H); 6.77 (s, 1H); 7.29-7.43 (m, 5H); 7.45-7.52 (m, 2H); 7.73 (t, 1H); 9.05 (d, 2H)

¹³C NMR spectrum (CDCl₃): δ−0.2; 36.4; 55.2; 90.5; 105.0; 118.6; 124.2; 125.4; 128.8; 129.2; 129.5; 135.0; 137.7; 128.7; 154.0

Mass spectrum (positive ESI mode): calculated for C₂₁H₂₅N₃IPtSi: 669.05. found: 669.05

### EXAMPLE 7

### trans-diiodo(N-pyridine)[1-methyl-3-benzyl-imidazol-2-ylidene]platinum(II)

NaI (296 mg; 1.975 mmol), PtCl₂ or PtI₂ (0.199 mmol), K₂CO₃ (273 mg; 1.975 mmol) and 1-methyl-3-benzyl-1H-imidazolium bromide (50 mg; 0.198 mmol) are suspended in pyridine (1 mL). The solution is sonicated for 10 minutes, and then heated for 20 h at 100° C. The solvent is evaporated off, the crude product is taken up in dichloromethane and filtered on Celite. The filtrate is purified by flash chromatography, eluting with a mixture of dichloromethane and cyclohexane (1/1 by volume). This gives 100 mg (72%) of trans-diiodo(N-pyridine)[1-methyl-3-benzyl-imidazol-2-ylidene]platinum(II), illustrated below:

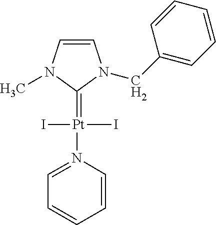

in the form of a yellow powder, which has the following characteristics:

¹H NMR spectrum (CDCl₃): δ 3.97 (s, 3H); 5.72 (s, 2H); 6.60 (s; 1H); 6.82 (s, 1H); 7.27-7.44 (m, 5H); 7.52 (m, 2H); 7.74 (t, 1H); 9.09 (d, 2H)

¹³C NMR spectrum (CDCl₃): δ 38.3; 54.4; 119.8; 122.2; 124.8; 128.3; 128.8; 129.1; 135.4; 136.3; 137.5; 153.7

Mass spectrum (positive ESI mode): calculated for C₁₆H₁₇N₃IPt: 573.01. found: 572.97

ORTEP diagram illustrated below: obtained by X-ray diffraction. Crystals obtained from a solution in dichloromethane, by slow diffusion of pentane.

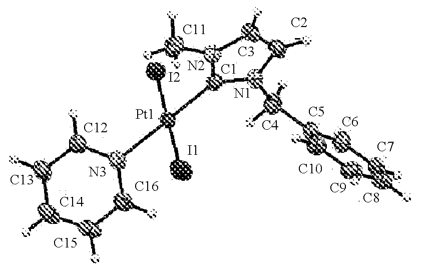

### EXAMPLE 8

### trans-diiodo(N-(3-bromo)-pyridine)[1-methyl-3-benzyl-imidazol-2-ylidene]platinum(II)

NaI (148 mg; 0.987 mmol), K₂CO₃ (136 mg; 0.987 mmol), PtCl₂ (26 mg; 0.099 mmol) and 1-methyl-3-benzyl-1H-imidazolium bromide (25 mg; 0.099 mmol) are suspended in 3-bromopyridine (2 mL). The solution is sonicated for 10 minutes, and then heated for 3 days at 100° C. The solvent is evaporated off, the crude product is taken up in dichloromethane and filtered on Celite. The filtrate is purified by flash chromatography, eluting with a mixture of dichloromethane and cyclohexane (1/1 by volume). This gives 42 mg (54%) of trans-diiodo(N-(3-bromo)-pyridine)[1-methyl-3-benzyl-imidazol-2-ylidene]platinum(II), illustrated below:

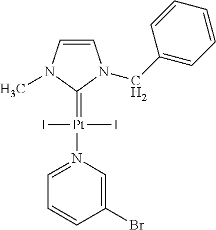

in the form of a yellow powder, which has the following characteristics:

¹H NMR spectrum (CDCl₃): δ 3.98 (s, 3H); 5.70 (s, 2H); 6.61 (s; 1H); 6.83 (s, 1H); 7.21 (m, 1H); 7.35-751 (m, 5H); 7.86 (d, 1H); 9.02 (d, 1H); 9.20 (m; 1H)

¹³C NMR spectrum (CDCl₃): δ 38.4; 54.6; 120.1; 120.8; 122.4; 125.6; 128.4; 128.8; 129.1; 135.0; 135.2; 140.3; 152.1; 154.7

Mass spectrum (positive ESI mode): calculated for C₁₆H₁₆N₃IBrPt: 651.92. found: 651.94

### EXAMPLE 9

### trans-diiodo(N-pyridine)[1-methyl-3-heptyl-imidazol-2-ylidene]platinum(II)

NaI (240 mg; 1.601 mmol), K₂CO₃ (221 mg; 1.601 mmol), PtCl₂ (43 mg; 0.162 mmol) and 1-methyl-3-heptyl-1H-imidazolium iodide (50 mg; 0.162 mmol) are suspended in pyridine (2 mL). The solution is sonicated for 10 minutes, and then heated for 48 h at 120° C. The solvent is evaporated off, the crude product is taken up in dichloromethane and filtered on Celite. The filtrate is purified by flash chromatography, eluting with dichloromethane. This gives 53 mg (47%) of trans-diiodo(N-pyridine)[1-methyl-3-heptyl-imidazol-2-ylidene]platinum(II), illustrated below:

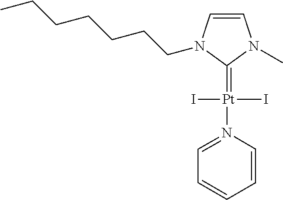

in the form of a yellow oil, which has the following characteristics:

¹H NMR spectrum (CDCl₃): δ 0.90 (t, 3H); 1.31-1.34 (m, 4H); 1.41-1.45 (m; 4H); 2.04 (t, 2H); 3.97 (s, 3H); 4.44 (t, 2H); 6.85 (s, 2H); 7.33 (m, 2H); 7.73 (t, 1H); 9.05 (d, 2H)

¹³C NMR spectrum (CDCl₃): δ 14.1; 22.6; 26.7; 28.9; 29.6; 31.7; 38.3; 50.9; 120.3; 121.9; 124.9; 135.2; 137.4; 153.8

### EXAMPLE 10

### trans-diiodo(N-pyridine)[1-methyl-3-(2,5,8,11-tetraoxatridecan-13-yl)-imidazol-2-ylidene]platinum(II)

NaI (130 mg; 0.867 mmol), K₂CO₃ (120 mg; 0.867 mmol), PtCl₂ (23 mg; 0.087 mmol) and 1-methyl-3-(2,5,8,11-tetraoxatridecan-13-yl)-1H-imidazolium iodide (35 mg; 0.087 mmol) are suspended in pyridine (2 mL). The solution is sonicated for 10 minutes, and then heated for 20 h at 100° C. The solvent is evaporated off, the crude product is taken up in dichloromethane and filtered on Celite. The filtrate is purified by flash chromatography, eluting with a mixture of dichloromethane and methanol (20/1 by volume). This gives 44 mg (63%) of trans-diiodo(N-pyridine)[1-methyl-3-(2,5,8,11-tetraoxatridecan-13-yl)-imidazol-2-ylidene]platinum(II), illustrated below:

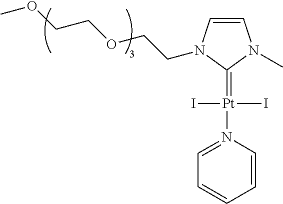

in the form of a yellow oil, which has the following characteristics:

¹H NMR spectrum (CDCl₃): δ 3.39 (s, 3H); 3.55 (t, 2H); 3.64-3.67 (m; 10H); 3.96 (s, 3H); 4.04 (t, 2H); 4.67 (t, 2H); 6.82 (d, 1H); 7.12 (d, 1H); 7.33 (m, 2H); 7.72 (t, 1H); 9.04 (d, 2H)

¹³C NMR spectrum (CDCl₃): δ 38.2; 50.5; 59.1; 69.5; 70.4; 70.5; 70.6; 72.0; 121.6; 122.4; 124.8; 135.1; 137.4; 153.6

Mass spectrum (positive ESI mode): calculated for C₁₈H₂₉N₃I₂O₄Pt.Na: 822.98. found: 822.97

### EXAMPLE 11

### trans-diiodo(N-morpholine)[1-methyl-3-(2,5,8,11-tetraoxatridecan-13-yl)-imidazol-2-ylidene]platinum(II)

NaI (123 mg; 0.821 mmol), K₂CO₃ (1113 mg; 0.818 mmol), PtCl₂ (47 mg; 0.177 mmol) and 1-methyl-3-(2,5,8,11-tetraoxatridecan-13-yl)-1H-imidazolium iodide (66 mg; 0.164 mmol) are suspended in morpholine (3 mL). The solution is sonicated for 10 minutes, and then heated for 2 days at 100° C. The solvent is evaporated off, the crude product is taken up in dichloromethane and filtered on Celite. The filtrate is purified by flash chromatography, eluting with a mixture of dichloromethane and methanol (20/1 by volume). This gives 78 mg (59%) of trans-diiodo(N-morpholine)[1-methyl-3-(2,5,8,11-tetraoxatridecan-13-yl)-imidazol-2-ylidene]platinum(II), illustrated below:

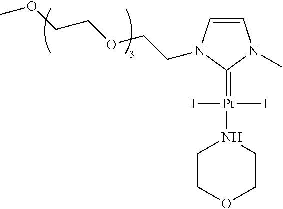

in the form of a yellow oil, which has the following characteristics:

¹H NMR spectrum (CD₃OD): δ 2.85 (d, 2H); 3.37 (s, 3H); 3.50-3.58 (m; 4H); 3.61-3.66 (m, 12H); 3.70 (d, 2H); 3.80 (s, 3H); 4.00 (t, 2H); 4.50 (t, 2H); 7.04 (d, 1H); 7.17 (d, 1H)

¹³C NMR spectrum (CDCl₃): δ 36.9; 49.9; 50.5; 57.8; 68.0; 68.9; 70.0; 70.2; 71.6; 121.5; 122.1; 135.1

### EXAMPLE 12

### trans-diiodo(N-pyridine)[1,3-di(2,5,8,11-tetraoxatridecan-13-yl)-imidazol-2-ylidene]platinum(II)

NaI (250 mg; 1.668 mmol), K₂CO₃ (230 mg; 1.667 mmol), PtCl₂ (28 mg; 0.105 mmol) and 1,3-di(2,5,8,11-tetraoxatridecan-13-yl)-1H-imidazol-3-ium iodide (47 mg; 0.082 mmol) are suspended in pyridine (2 mL). The solution is sonicated for 10 minutes, and then heated for 20 h at 90° C. The solvent is evaporated off, the crude product is taken up in dichloromethane and filtered on Celite. The filtrate is purified by flash chromatography, eluting with a mixture of dichloromethane and methanol (20/1 by volume). This gives 29 mg (36%) of trans-diiodo(N-pyridine)[1,3-di(2,5,8,11-tetraoxatridecan-13-yl-imidazol-2-ylidene]platinum(II), illustrated below:

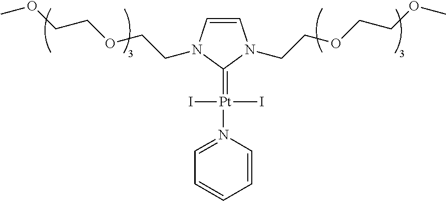

in the form of a yellow oil, which has the following characteristics:

¹H NMR spectrum (CDCl₃): δ 3.38 (s, 6H); 3.55 (m, 4H); 3.64-3.67 (m; 20H); 4.04 (t, 4H); 4.68 (t, 4H); 7.08 (s, 2H); 7.32 (m, 2H); 7.77 (t, 1H); 9.02 (d, 2H)

¹³C NMR spectrum (CDCl₃): δ 50.6; 59.0; 69.4; 70.4; 70.5; 70.6; 71.7; 121.9; 124.8; 134.5; 137.4; 135.7

Mass spectrum (positive ESI mode): calculated for C₂₆H₄₅N₃I₂O₈PtNa: 999.08. found: 999.09

### EXAMPLE 13

### trans-diiodo(N-cyclohexylamine)[1-methyl-3-(2,5,8,11-tetraoxatridecan-13-yl)-imidazol-2-ylidene]platinum(II)

The compound trans-diiodo(N-pyridine)[1-methyl-3-(2,5,8,11-tetraoxatridecan-13-yl-imidazol-2-ylidene]platinum(II) (15 mg; 0.019 mmol) is suspended in ethanol (1 mL). Cyclohexylamine (25 μL; 0.218 mmol) is added. The reaction medium is held at 55° C. for 20 h. The ethanol is evaporated off and the crude product is washed with pentane and then purified by flash chromatography, eluting with a mixture of dichloromethane and methanol (20/1 by volume). This gives 14 mg (93%) of trans-diiodo(N-cyclohexylamine)[1-methyl-3-(2,5,8,11-tetraoxatridecan-13-yl)imidazol-2-ylidene]platinum(II), illustrated below:

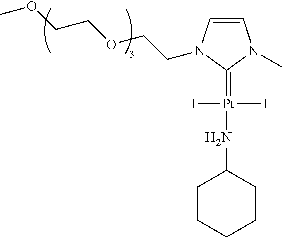

in the form of a yellow oil, which has the following characteristics:

¹H NMR spectrum (CDCl₃): δ 1.10-1.45 (m, 5H); 1.50-2.35 (m, 5H); 2.70-3.05 (m, 2H); 3.24 (m, 1H); 3.38 (s, 3H); 3.55 (m, 2H); 3.61-3.67 (m; 10H); 3.85 (s, 3H); 3.96 (t, 2H); 4.68 (t, 2H); 6.77 (d, 1H); 7.07 (d, 1H)

¹³C NMR spectrum (CDCl₃): δ 25.0; 25.5; 36.1; 38.2; 50.6; 55.0; 59.3; 69.7; 70.4; 70.5; 70.6; 72.2; 121.6; 122.6; 138.9

Mass spectrum (positive ESI mode): calculated for C₁₉H₃₇N₃I₂O₄PtNa: 843.04. found: 843.05

### EXAMPLE 14

### trans-diiodo(N-cyclohexylamine)[1,3-di(2,5,8,11-tetraoxatridecan-13-yl)-imidazol-2-ylidene]platinum(II)

The compound trans-diiodo(N-pyridine)[1,3-di(2,5,8,11-tetraoxatridecan-13-yl) imidazol-2-ylidene]platinum(II) (28 mg; 0.029 mmol) is suspended in ethanol (2 mL). Cyclohexylamine (33 μL; 0.282 mmol) is added. The reaction medium is held at 55° C. for 20 h. The ethanol is evaporated off and the crude product is washed with pentane and then purified by flash chromatography, eluting with a mixture of dichloromethane and methanol (20/1 by volume). This gives 18 mg (62%) of trans-diiodo(N-cyclohexylamine)[1,3-di(2,5,8,11-tetraoxatridecan-13-yl)imidazol-2-ylidene]platinum(II), illustrated below:

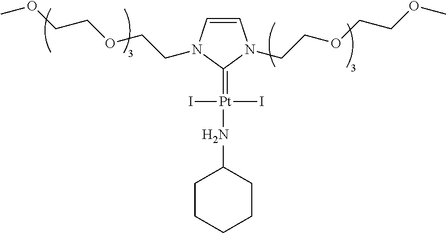

in the form of a yellow oil, which has the following characteristics:

¹H NMR spectrum (CDCl₃): δ 1.10-1.45 (m, 5H); 1.50-2.35 (m, 5H); 2.70-3.05 (m, 2H); 3.24 (m, 1H); 3.38 (s, 6H); 3.55 (m, 4H); 3.61-3.67 (m; 20H); 3.96 (t, 4H); 4.55 (t, 4H); 7.02 (s, 2H)

¹³C NMR spectrum (CDCl₃): δ 24.8; 25.3; 35.9; 50.5; 54.7; 59.0; 69.4; 70.4; 70.5; 70.6; 72.0; 121.9; 138.0

Mass spectrum (positive ESI mode): calculated for C₂₇H₅₃N₃I₂O₈PtNa: 1019.15. found: 1019.14

### EXAMPLE 15

### trans-diiodo(N-cyclohexylamine)[1-methyl-3-benzyl-5-((trimethylsilyl)ethynyl)-imidazol-2-ylidene]platinum(II)

The compound trans-diiodo(N-pyridine)[1-methyl-3-benzyl-5-(trimethylsilyl)ethynyl-imidazol-2-ylidene]platinum(II) (34 mg; 0.048 mmol) is dissolved in cyclohexylamine (1 mL). The reaction medium is stirred at ambient temperature for 10 min. The cyclohexylamine is evaporated off and the crude product is washed with pentane and with ether. This gives 15 mg (48%) of trans-diiodo(N-cyclohexylamine)[1-methyl-3-benzyl-5-((trimethylsilyl)ethynyl)imidazol-2-ylidene]platinum(II), illustrated below:

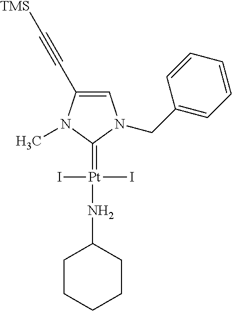

in the form of a yellow powder, which has the following characteristics:

¹H NMR spectrum (CDCl₃): δ 0.21 (s, 9H); 1.07-1.40 (m, 5H); 1.71-1.83 (m, 5H); 2.95 (d, 2H); 3.26 (m, 1H); 3.88 (s, 3H); 5.55 (s, 2H); 6.73 (s, 1H); 7.32-7.46 (m, 5H)

¹³C NMR spectrum (CDCl₃): δ−0.4; 24.8; 25.3; 35.9; 36.0; 54.7; 54.9; 90.3; 104.7; 123.8; 128.5; 128.9; 129.2; 134.9; 141.9

Mass spectrum (positive ESI mode): calculated for C₂₂H₃₃N₃IPtSi: 689.11. found: 689.13,

ORTEP diagram shown below: obtained by X-ray diffraction. Crystals obtained from a solution in dichloromethane, by slow diffusion of pentane.

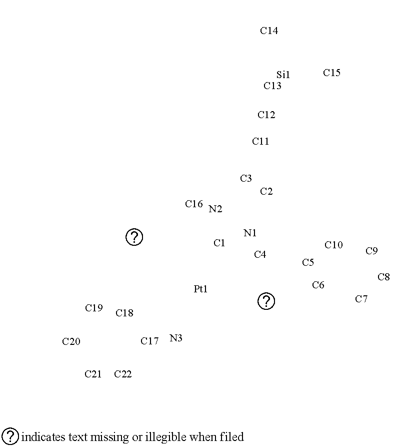

### EXAMPLE 16

### trans-diiodo(N-morpholine)[1-methyl-3-benzyl-5-((trimethylsilyl)ethynyl)-imidazol-2-ylidene]platinum(II)

The compound trans-diiodo(N-pyridine)[1-methyl-3-benzyl-5-(trimethylsilyl)ethynyl-imidazol-2-ylidene]platinum(II) (48 mg; 0.061 mmol) is dissolved in morpholine (2 mL). The reaction medium is stirred at ambient temperature for 10 min. The cyclohexylamine is evaporated off and the crude product is washed with pentane and with ether. This gives 47 mg (86%) of trans-diiodo(N-morpholine)[1-methyl-3-benzyl-5-((trimethylsilyl)ethynyl)imidazol-2-ylidene]platinum(II), illustrated below:

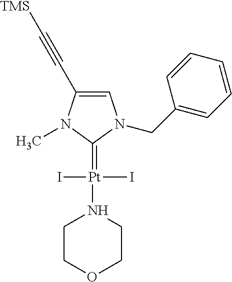

in the form of a yellow powder, which has the following characteristics:

¹H NMR spectrum (CDCl₃): δ 0.21 (s, 9H); 2.86 (m, 2H); 3.41 (m, 1H); 3.50-3.75 (m, 6H); 3.60-3.90 (m, 5H); 5.52 (s, 2H); 6.73 (s, 1H); 7.32-7.46 (m, 5H)

¹³C NMR spectrum (CDCl₃): δ 0.0; 36.2; 54.9; 68.8; 90.2; 104.8; 118.3; 123.9; 128.6; 128.9; 129.2; 129.3; 134.7; 138.2

Mass spectrum (positive ESI mode): calculated for C₂₀H₂₉N₃IPtSiO: 677.08. found: 677.08,

ORTEP diagram shown below: obtained by X-ray diffraction. Crystals obtained from a solution in dichloromethane, by slow diffusion of pentane.

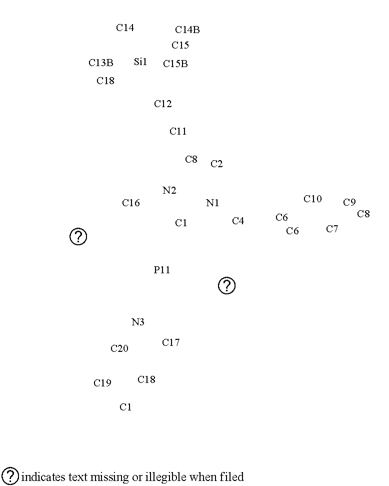

### EXAMPLE 17

### trans-diiodo(N-(L)-valine methyl ester)[1-methyl-3-benzyl-imidazol-2-ylidene]platinum(II)

The compound trans-diiodo(N-pyridine)[1-methyl-3-benzyl-imidazol-2-ylidene]platinum(II) (54 mg; 0.077 mmol), (L)-valine methyl ester hydrochloride (16 mg; 0.093 mmol) and triethylamine (21 μL; 0.150 mmol) are suspended in ethanol (6 mL). The reaction medium is held at 75° C. for 24 h. The solvent is evaporated off, the crude product is washed with pentane and purified by flash chromatography, eluting with a mixture of dichloromethane and cyclohexane (2/1 by volume). This gives 34 mg (59%) of trans-diiodo(N-(L)valine methyl ester)[1-methyl-3-benzyl-imidazol-2-ylidene]platinum(II), illustrated below:

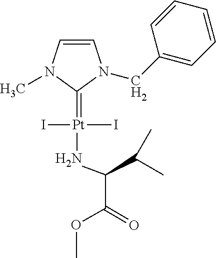

in the form of a yellow powder, which has the following characteristics:

¹H NMR spectrum (CDCl₃): δ 1.09 (d, 6H); 2.60 (m, 1H); 3.42 (m, 2H); 3.78 (s, 3H); 3.88 (s, 3H); 4.23 (m, 1H); 5.57 (s, 2H); 6.57 (d, 1H); 6.78 (d, 1H); 7.34-7.46 (m, 5H)

¹³C NMR spectrum (CDCl₃): δ 17.9; 18.8; 29.7; 38.2; 52.4; 54.4; 63.7; 120.0; 122.3; 128.2; 128.5; 128.9; 135.3; 137.5; 172.8

Mass spectrum (positive ESI mode): calculated for C₁₇H₂₅N₃I₂O₂PtNa: 774.96. found: 774.95

ORTEP diagram illustrated below: obtained by X-ray diffraction. Crystals obtained from a solution in dichloromethane, by slow diffusion of pentane.

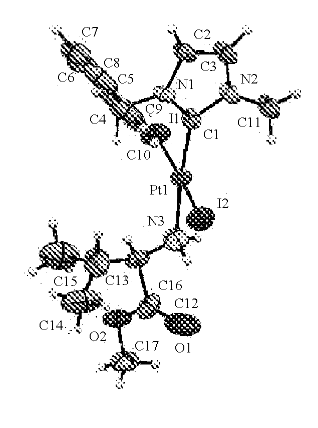

### EXAMPLE 18

### trans-diiodo(N-(L)-phenylalanine methyl ester)[1-methyl-3-benzyl-imidazol-2-ylidene]platinum(II)

The compound trans-diiodo(N-pyridine)[1-methyl-3-benzyl-imidazol-2-ylidene]platinum(II) (30 mg; 0.043 mmol), (L)-phenylalanine methyl ester hydrochloride (19 mg; 0.086 mmol) and triethylamine (23 μL; 0.171 mmol) are suspended in ethanol (2 mL). The reaction medium is held at 55° C. for 20 h. The solvent is evaporated off, the crude product is washed with pentane and purified by flash chromatography, eluting with a mixture of dichloromethane and cyclohexane (2/1 by volume). This gives 24 mg (71%) of trans-diiodo(N-(L)phenylalanine methyl ester)[1-methyl-3-benzyl-imidazol-2-ylidene]platinum(II), illustrated below:

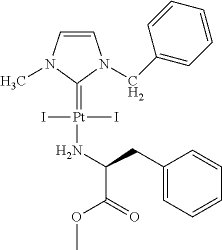

in the form of a yellow powder, which has the following characteristics:

¹H NMR spectrum (CDCl₃): δ 3.10-3.82 (m, 4H); 3.72 (s, 3H); 3.88 (s, 3H); 4.63 (m, 1H); 5.57 (s, 2H); 6.57 (d, 1H); 6.79 (d, 1H); 7.14-7.56 (m, 10H)

Mass spectrum (positive ESI mode): calculated for C₂₁H₂₅N₃I₂O₂PtNa: 822.96. found: 822.95

### EXAMPLE 19

### trans-diiodo(N—[(S)-methyl-2-(2-amino-4-methylpentanamido)acetate])[1-methyl-3-benzyl-imidazol-2-ylidene]platinum(II)

The compound trans-diiodo(N-pyridine)[1-methyl-3-benzyl-imidazol-2-ylidene]platinum(II) (30 mg; 0.043 mmol), (L)Leu-Gly.OMe hydrotrifluoroacetate (27 mg; 0.086 mmol) and triethylamine (116 μL; 0.860 mmol) are suspended in ethanol (2 mL). The reaction medium is held at 55° C. for 20 h. The solvent is evaporated off, the crude product is washed with pentane and purified by flash chromatography, eluting with dichloromethane. This gives 19 mg (54%) of trans-diiodo(N—(S)methyl-2-(2-amino-4-methylpentanamido)acetate)[1-methyl-3-benzyl-imidazol-2-ylidene]platinum(II), illustrated below:

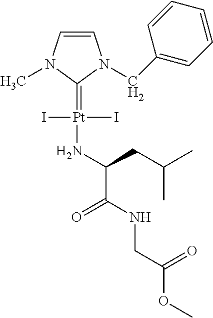

in the form of a yellow powder, which has the following characteristics:

¹H NMR spectrum (CD₃OD): δ 1.00 (m, 6H); 1.58-1.78 (m, 1H); 2.00-2.23 (m, 2H); 3.72 (s, 3H); 3.87 (s, 3H); 4.05-4.45 (m, 3H); 5.61 (s, 2H); 6.80 (d, 1H); 7.07 (d, 1H); 7.34 (m, 3H); 7.53 (m, 2H)

¹³C NMR spectrum (CD₃OD): δ 21.4; 22.2; 24.5; 36.9; 40.5; 43.7; 51.2; 53.7; 57.0; 119.8; 122.4; 127.7; 128.2; 128.7; 136.1; 139.4; 170.2; 175.1

Mass spectrum (positive ESI mode): calculated for C₂₀H₃₀N₄I₂O₃PtNa: 846.00. found: 846.00

### EXAMPLE 20

### trans-diiodo(N-[methyl 2-((R)-2-((R)-2-amino-3-methylbutanamido)-3-phenylpropanamido)acetate])[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol), (D)Val-(D)Phe-Gly.OMe hydrotrifluoroacetate (27 mg; 0.086 mmol) and triethylamine (15 μL; 0.114 mmol) are suspended in ethanol (1 mL). The reaction medium is held at 55° C. for 7 h. The solvent is evaporated off, the crude product is washed with pentane and purified by flash chromatography, eluting with dichloromethane and then with a mixture of dichloromethane and methanol (20/1 by volume). This gives 7 mg (26%) of trans-diiodo(N-methyl 2-((R)-2-((R)-2-amino-3-methylbutanamido)-3-phenylpropanamido)acetate)[1-methyl-3-benzyl-imidazol-2-ylidene]platinum(II), illustrated below:

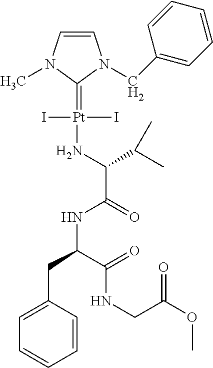

in the form of a yellow powder, which has the following characteristics:

¹H NMR spectrum (CDCl₃): δ 1.03 (m, 6H); 1.58-1.78 (m, 1H); 2.12-2.38 (m, 1H); 2.98-3.28 (m, 2H); 3.72 (s, 3H); 3.60-4.05 (m, 6H); 4.73 (m, 1H); 5.58 (d, 2H); 6.15 (t, 1H); 6.44 (d, 1H); 6.56 (d, 1H); 6.78 (d, 1H); 7.15-7.50 (m, 10H)

¹³C NMR spectrum (CDCl₃): δ 18.4; 18.5; 32.0; 38.2; 38.5; 41.2; 52.4; 54.4; 54.9; 64.8; 119.9; 122.3; 127.1; 128.3; 128.8; 129.0; 129.4; 135.3; 136.2; 137.7; 169.4; 170.4; 170.7

Mass spectrum (positive ESI mode): calculated for C₂₈H₃₇N₅I₂O₄PtNa: 979.05. found: 979.05

### EXAMPLE 21

### trans-diiodo(N-[methyl 2-((S)-2-((2S,3R)-2-amino-3-methylpentanamido)-6-((((2-chlorobenzyl)oxy)carbonyl)amino)hexanamido)acetate])[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol), (L)Ile-(L)Lys(Cl—Z)-Gly.OMe hydrotrifluoroacetate (32 mg; 0.052 mmol) and triethylamine (20 μL; 0.148 mmol) are suspended in methanol (1 mL). The reaction medium is held at 55° C. for 20 h. The solvent is evaporated off, the crude product is washed with pentane and purified by flash chromatography, eluting with a mixture of dichloromethane and cyclohexane (1/1 by volume) and then with a mixture of dichloromethane and ethyl acetate (75/25 by volume). This gives 7 mg (20%) of trans-diiodo(N-methyl 2-((S)-2-((2S,3R)-2-amino-3-methylpentanamido)-6-((((2-chlorobenzyl)oxy)carbonyl)amino)hexanamido)acetate)[1-methyl-3-benzyl-imidazol-2-ylidene]platinum(II), illustrated below:

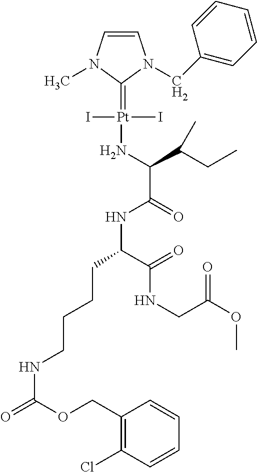

in the form of a yellow powder, which has the following characteristics:

¹H NMR spectrum (CDCl₃): δ 0.96-1.00 (m, 6H); 1.25-2.21 (m, 9H); 3.14-3.24 (m, 2H); 3.72 (s, 3H); 3.91 (s, 3H); 3.91-4.21 (m, 3H); 4.55 (m, 1H); 5.05 (t, 1H); 5.22 (s, 2H); 5.55 (d, 2H); 6.53 (d, 1H); 6.76 (d, 1H); 7.15-7.50 (m, 9H)

¹³C NMR spectrum (CDCl₃): δ 11.7; 14.9; 22.2; 25.8; 29.3; 31.7; 38.1; 39.0; 40.3; 41.2; 52.4; 53.1; 54.3; 63.6; 63.9; 119.9; 122.3; 126.9; 128.3; 128.8; 129.1; 129.3; 129.5; 129.7; 133.4; 135.3; 137.9; 156.4; 169.9; 171.0

Mass spectrum (positive ESI mode): calculated for C₃₄H₄₇N₆I₂ClO₆PtNa: 1142.09. found: 1142.21

### EXAMPLE 22

### trans-diiodo(N-[(methoxy)polyethylene glycol amine])[1-methyl-3-benzyl-imidazol-2-ylidene]platinum(II)

The compound trans-diiodo(N-pyridine)[1-methyl-3-benzyl-imidazol-2-ylidene]platinum(II) (32 mg; 0.046 mmol) and (methoxy)polyethylene glycol amine (840 Da and D=1.04; 61 mg; 0.069 mmol) are suspended in ethanol (2 mL). The reaction medium is held at 55° C. for 20 h. The solvent is evaporated off, the crude product is washed with pentane and purified by flash chromatography, eluting with a mixture of dichloromethane and methanol (10/1 by volume). This gives 30 mg (45%) of trans-diiodo(N-(methoxy)polyethylene glycol amine)[1-methyl-3-benzyl-imidazol-2-ylidene]platinum(II), illustrated below:

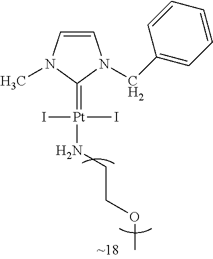

in the form of yellow oil, which has the following characteristics:

¹H NMR spectrum (CDCl₃): δ 2.05 (s, 2H); 3.18 (m, 4H); 3.37 (s, 3H); 3.40-3.79 (m, ˜72H); 3.87 (s, 3H); 5.60 (s, 2H); 6.60 (d, 1H); 6.80 (d, 1H); 7.25-7.60 (m, 5H)

¹³C NMR spectrum (CDCl₃): δ 38.1; 45.1; 54.4; 59.0; 70.2; 70.5; 71.9; 119.8; 122.2; 128.2; 128.8; 129.0; 135.4; 141.2

compound that is water-soluble at 11.1 g/L.

### EXAMPLE 23

### trans-diiodo(N-[methyl-6-aminohexanoate])[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol) and methyl 6-aminohexanoate (13 mg; 0.090 mmol) are suspended in ethanol (2 mL). The reaction medium is held at 55° C. for 20 h. The solvent is evaporated off, the crude product is washed with pentane and purified by flash chromatography, eluting with dichloromethane and then with a mixture of dichloromethane and methanol (20/1 by volume). This gives 10 mg (45%) of trans-diiodo(N-methyl-6-aminohexanoate)[1-methyl-3-benzyl-imidazol-2-ylidene]platinum(II), illustrated below:

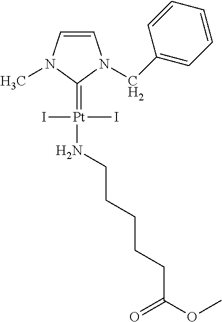

in the form of yellow oil, which has the following characteristics:

¹H NMR spectrum (CDCl₃): δ 1.26 (m, 2H); 1.66 (m, 4H); 2.33 (t, 2H); 3.04 (m, 4H); 3.66 (s, 3H); 3.89 (s, 3H); 5.59 (s, 2H); 6.57 (d, 1H); 6.78 (d, 1H); 7.32-7.46 (m, 5H)

¹³C NMR spectrum (CDCl₃): δ 24.4; 26.0; 31.7; 33.8; 38.2; 45.3; 51.5; 54.4; 119.9; 122.2; 128.3; 128.8; 129.2; 135.4; 139.4; 173.8

Mass spectrum (positive ESI mode): calculated for C₁₈H₂₇N₃I₂O₂PtNa: 788.97. found: 788.97

### EXAMPLE 24

### trans-diiodo(N-(L)-prolinol)[1-methyl-3-benzyl-imidazol-2-ylidene]platinum(II)

The compound trans-diiodo(N-pyridine)[1-methyl-3-benzyl-imidazol-2-ylidene]platinum(II) (31 mg; 0.044 mmol) and (L)-prolinol (13 μL; 0.131 mmol) are suspended in ethanol (2 mL). The reaction medium is held at 55° C. for 24 h. The solvent is evaporated off, the crude product is washed with pentane and purified by flash chromatography, eluting with dichloromethane and then with a mixture of dichloromethane and methanol (20/1 by volume). This gives 28 mg (90%) of trans-diiodo(N-(L)-prolinol)[1-methyl-3-benzyl-imidazol-2-ylidene]platinum(II), illustrated below:

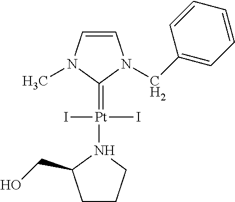

in the form of yellow oil, which has the following characteristics:

¹H NMR spectrum (CDCl₃): δ 1.73-1.86 (m, 4H); 2.36 (t, 1H); 3.12 (m, 1H); 3.24-3.68 (m, 4H); 3.89 (s, 3H); 4.45 (m, 1H); 5.58 (s, 2H); 6.57 (d, 1H); 6.79 (d, 1H); 7.32-7.46 (m, 5H)

¹³C NMR spectrum (CDCl₃): δ 25.1; 26.4; 38.3; 52.1; 54.6; 60.3; 65.8; 120.2; 122.5; 128.6; 129.0; 129.2; 135.5; 139.3

Mass spectrum (positive ESI mode): calculated for C₁₆H₂₃N₃I₂OPtNa: 744.95. found: 744.96

### EXAMPLE 25

### trans-diiodo(N-(L)-prolinamide)[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol), (L)-prolinamide hydrochloride (6 mg; 0.040 mmol) and triethylamine (20 μL; 0.148 mmol) are suspended in ethanol (1 mL). The reaction medium is held at 55° C. for 20 h. The solvent is evaporated off, the crude product is washed with pentane and purified by flash chromatography, eluting with dichloromethane and then with a mixture of dichloromethane and methanol (20/1 by volume). This gives 8 mg (38%) of trans-diiodo(N-(L)-prolinamide)[1-methyl-3-benzyl-imidazol-2-ylidene]platinum(II), illustrated below:

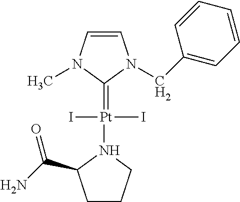

in the form of yellow oil, which has the following characteristics:

¹H NMR spectrum (CDCl₃): δ 1.73-2.20 (m, 4H); 3.26-3.40 (m, 2H); 3.87 (s, 3H); 4.41 (m, 1H); 4.52 (m, 1H); 5.58 (dd, 2H); 5.64 (m, 1H); 5.97 (m, 1H); 6.56 (s, 1H); 6.77 (s, 1H); 7.32-7.46 (m, 5H)

ORTEP diagram illustrated below: obtained by X-ray diffraction. Crystals obtained from a solution in dichloromethane, by slow diffusion of pentane.

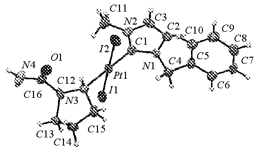

### EXAMPLE 26

### trans-diiodo(N-ethanolamine)[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol) and ethanolamine (9 μL; 0.143 mmol) are suspended in ethanol (1 mL). The reaction medium is held at 55° C. for 24 h. The solvent is evaporated off, the crude product is washed with pentane and purified by flash chromatography, eluting with dichloromethane and then with a mixture of dichloromethane and methanol (20/1 by volume). This gives 16 mg (81%) of trans-diiodo(N-ethanolamine)[1-methyl-3-benzyl-imidazol-2-ylidene]platinum(II), illustrated below:

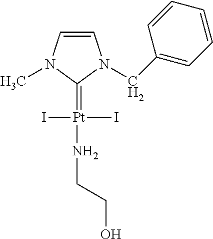

in the form of yellow oil, which has the following characteristics:

¹H NMR spectrum (CDCl₃): δ 2.50 (m, 1H); 3.16-3.25 (m, 4H); 3.89 (s, 3H); 3.99 (m, 2H); 5.59 (s, 2H); 6.59 (d, 1H); 6.80 (d, 1H); 7.32-7.46 (m, 5H)

¹³C NMR spectrum (CDCl₃): δ 38.2; 47.2; 54.4; 60.8; 120.0; 122.3; 128.3; 138.7; 129.0; 135.3

### EXAMPLE 27

### trans-diiodo(N-pyridine)[1-methyl-3-(anthracen-9-ylmethyl)-imidazol-2-ylidene]platinum(II)

K₂CO₃ (173 mg; 1.270 mmol), PtI₂ (62 mg; 0.137 mmol) and 3-(anthracen-9-ylmethyl)-1-methyl-1H-imidazol-3-ium iodide (50 mg; 0.125 mmol) are suspended in pyridine (2 mL). The solution is sonicated for 10 minutes, and then heated for 20 h at 100° C. The solvent is evaporated off, the crude product is taken up in dichloromethane, filtered on Celite and purified by flash chromatography, eluting with a mixture of dichloromethane and cyclohexane (4/1 by volume). This gives 9 mg (9%) of trans-diiodo(N-pyridine)[1-methyl-3-(anthracen-9-ylmethyl)-imidazol-2-ylidene]platinum(II), illustrated below:

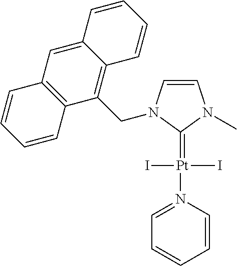

in the form of a yellow oil, which has the following characteristics:

¹H NMR spectrum (CDCl₃): δ 4.03 (s, 3H); 5.97 (d, 1H); 6.57 (s; 2H); 6.60 (d, 1H); 7.35 (m, 2H); 7.60 (m, 4H); 7.77 (m, 1H); 8.10 (d, 2H); 8.45 (d, 2H), 8.59 (s, 1H); 9.17 (m, 2H)

### EXAMPLE 28

### trans-diiodo(N-pyridine)[1-methyl-3-(3-(trimethylsilyl)propyl)-imidazol-2-ylidene]platinum(II)

K₂CO₃ (85 mg; 0.617 mmol), PtI₂ (30 mg; 0.068 mmol) and 1-methyl-3-(3-(trimethylsilyl)propyl)-1H-imidazol-3-ium iodide (20 mg; 0.062 mmol) are suspended in pyridine (1 mL). The solution is sonicated for 10 minutes, and then heated for 20 h at 100° C. The solvent is evaporated off, the crude product is taken up in dichloromethane and filtered on Celite. This gives 44 mg (98%) of trans-diiodo(N-pyridine)[1-methyl-3-(3-(trimethylsilyl)propyl)imidazol-2-ylidene]platinum(II), illustrated below:

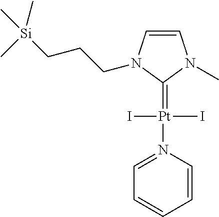

in the form of a yellow oil, which has the following characteristics:

¹H NMR spectrum (CDCl₃): δ 0.05 (s, 9H); 0.62 (m, 2H); 2.02 (m; 2H); 3.97 (s, 3H); 4.40 (t, 2H); 6.85 (s, 2H); 7.32 (m, 2H); 7.77 (t, 1H); 9.02 (d, 2H)

### EXAMPLE 29

### trans-diiodo(N-[1-((2S,7S,12S,17S,22S)-22-amino-2,17-diisobutyl-12-isopropyl-7-methyl-4,9,14,19-tetraoxo-3,5,8,10,13,15,18,20-octaazatricosyl)-3-methylurea])[1-methyl-3-benzyl-imidazol-2-ylidene]platinum(II)

The compound trans-diiodo(N-pyridine)[1-methyl-3-benzyl-imidazol-2-ylidene]platinum(II) (19 mg; 0.026 mmol), (6S,11S,16S,21S,26S)-6,21-diisobutyl-16-isopropyl-11-methyl-3,8,13,18,23-pentaoxo-2,4,7,9,12,14,17,19,22,24-decaazaheptacosan-26-aminium chloride (18 mg; 0.026 mmol) and triethylamine (50 μL; 0.370 mmol) are suspended in ethanol (1 mL). The reaction medium is held at 55° C. for 24 h. The solvent is evaporated off, the crude product is washed with pentane and purified by flash chromatography, eluting with dichloromethane and then with a mixture of dichloromethane and methanol (20/1 by volume). This gives 7 mg (21%) of trans-diiodo(N-[1-((2S,7S,12S,17S,22S)-22-amino-2,17-diisobutyl-12-isopropyl-7-methyl-4,9,14,19-tetraoxo-3,5,8,10,13,15,18,20-octaazatricosyl)-3-methylurea])[1-methyl-3-benzyl-imidazol-2-ylidene]platinum(II), illustrated below:

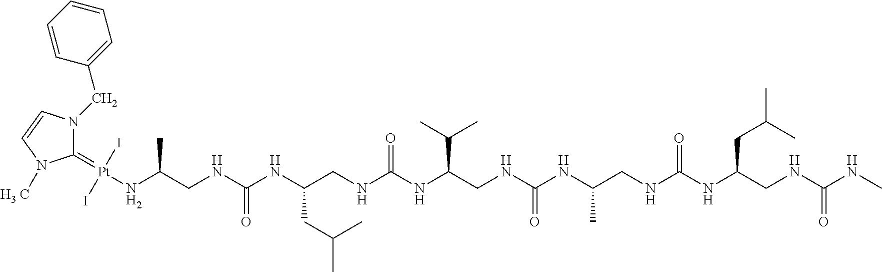

in the form of yellow oil, which has the following characteristics:

¹H NMR spectrum (CDCl₃): δ 0.84 (m, 18H); 1.01 (d, 3H); 1.21 (m, 4H); 1.35 (d, 3H); 1.50 (m, 1H); 1.68 (m, 2H); 2.10-2.50 (m, 3H); 2.66 (s, 3H), 2.83 (m, 10H); 3.00 (m, 2H); 3.52 (m, 4H); 3.83 (s, 3H); 3.84 (m, 3H); 5.40 (m, 1H); 5.52 (s, 2H); 5.62 (m, 1H); 5.70 (m, 2H); 6.05 (m, 1H); 6.32 (m, 1H); 6.53 (d, 1H); 6.77 (d, 1H); 7.27-7.41 (m, 5H)

¹³C NMR spectrum (CD₃OD+CDCl₃): δ 18.5, 19.4, 19.5, 22.0, 22.9, 24.7, 25.0, 26.2, 29.2, 29.6, 30.7, 37.8, 41.6, 42.8, 44.9, 45.0, 46.1, 46.8, 46.9, 54.1, 55.5, 120.0, 122.5, 128.3, 128.8, 128.8, 135.2, 137.3 (C—Pt), 159.5, 159.6, 159.7, 160.2, 160.4.

Mass spectrum (positive ESI mode): calculated for C₄₀H₇₃I₂N₁₃O₅PtH: 1265.37. found: 1265.37.

### EXAMPLE 30

### trans-diiodo(N—[N,N-dimethyl-5-(piperazin-1-ylsulphonyl)naphthalen-1-amine])[1-methyl-3-benzyl-imidazol-2-ylidene]platinum(II)

The compound trans-diiodo(N-pyridine)[1-methyl-3-benzyl-imidazol-2-ylidene]platinum(II) (30 mg; 0.043 mmol) and N,N-dimethyl-5-(piperazin-1-ylsulphonyl)naphthalen-1-amine (18 mg; 0.056 mmol) are suspended in ethanol (2 mL). The reaction medium is held at 55° C. for 24 h. The solvent is evaporated off, the crude product is washed with pentane and purified by flash chromatography, eluting with dichloromethane. This gives 28 mg (70%) of trans-diiodo(N—[N,N-dimethyl-5-(piperazin-1-ylsulphonyl)naphthalen-1-amine])[1-methyl-3-benzyl-imidazol-2-ylidene]platinum(II), illustrated below:

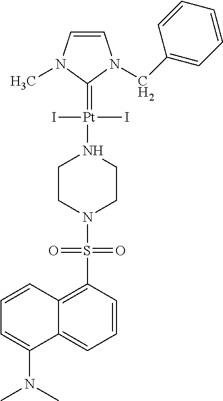

in the form of yellow oil, which has the following characteristics:

¹H NMR spectrum (CDCl₃): δ 2.61 (m, 2H); 2.90 (s, 6H); 3.04 (m, 2H); 3.45 (m, 2H); 3.73 (m, 2H); 3.82 (s, 3H); 5.51 (s, 2H); 6.54 (d, 1H); 6.76 (d, 1H); 7.21 (d, 1H); 7.35 (m, 5H); 7.56 (dd, 2H); 8.19 (d, 1H); 8.37 (d, 1H); 8.60 (d, 1H)

λₘₐₓ(absorption)=228 nm and λ(emission)=502 nm for λ(excitation)=341 nm in dichloromethane; c=6.6266.10⁻⁵ mol/L

### EXAMPLE 31

### trans-diiodo(N-phenylhydrazine)[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol) and phenylhydrazine (20 μL; 0.170 mmol) are suspended in ethanol (1 mL). The reaction medium is held at 55° C. for 24 h. The solvent is evaporated off, the crude product is washed with pentane and purified by flash chromatography, eluting with dichloromethane. This gives 17 mg (81%) of trans-diiodo(N-phenylhydrazine)[1-methyl-3-benzyl-imidazol-2-ylidene]platinum(II), illustrated below:

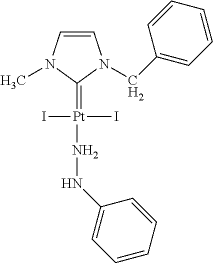

in the form of a yellow solid, which has the following characteristics:

¹H NMR spectrum (CDCl₃): δ 3.90 (s, 3H); 5.06 (m, 2H); 5.60 (s, 2H); 6.30 (m, 1H); 6.54 (d, 1H); 6.61 (d, 1H); 6.85 (d, 2H); 6.99 (t, 1H); 7.29-7.46 (m, 7H)

### EXAMPLE 32

### trans-diiodo(N-diethylenetriamine)[1-methyl-3-benzyl-imidazol-2-ylidene]platinum(II)

The compound trans-diiodo(N-pyridine)[1-methyl-3-benzyl-imidazol-2-ylidene]platinum(II) (10 mg; 0.014 mmol) and diethylenetriamine (8 μL; 0.072 mmol) are suspended in ethanol (2 mL). The reaction medium is held at 55° C. for 3 h. The crude reaction product is filtered on Celite and the filtrate is concentrated, washed with dichloromethane and with THF. This gives 6 mg (60%) of several isomers of iodo(N,N′-diethylenetriamine)[1-methyl-3-benzyl-imidazol-2-ylidene]platinum(II) iodide, illustrated below:

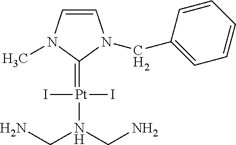

in the form of a white solid, which has the following characteristics:

¹H NMR spectrum (CD₃CN): δ 2.50-3.20 (m, 8H); 3.55-3.86 (m, 2H); 3.95 and 4.03 (s, 3H); 5.55 (s, 2H); 7.00-7.61 (m, 7H)

¹³C NMR spectrum (DMSO-d₆): δ 38.0; 38.1; 51.3; 51.5; 51.6; 51.8; 53.7; 54.0; 122.0; 124.0; 128.7; 129.1; 129.3; 129.4; 136.7; 137.1; 149.6; 149.9

Mass spectrum (positive ESI mode): calculated for C₁₅H₂₅N₅IPt: 597.08. found: 597.08

Compound water-soluble at 3.3 g/L

ORTEP diagram illustrated below: obtained by X-ray diffraction. Crystals obtained from a solution in acetonitrile, by diffusion of ether vapour.

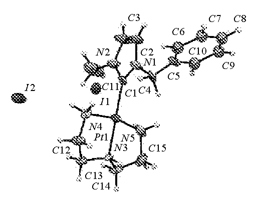

### EXAMPLE 33

### trans-diiodo(N-ethylenediamine)[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol) and ethylenediamine (10 μL; 0.143 mmol) are suspended in ethanol (1.5 mL). The reaction medium is held at 55° C. for 20 h. The crude reaction product is filtered on Celite and the filtrate is concentrated, washed with dichloromethane and with pentane. This gives 10 mg (50%) of iodo(N,N′-ethylenediamine)[1-methyl-3-benzyl-imidazol-2-ylidene]platinum(II) iodide, illustrated below:

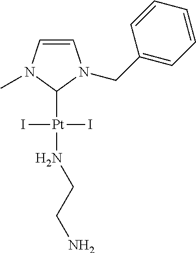

in the form of a white solid, which has the following characteristics:

¹H NMR spectrum (DMSO-d₆): δ 2.20-2.60 (m, 4H); 3.83 (s, 3H); 5.00 (s, 2H); 5.05-5.85 (dd, 2H); 7.10 (s, 1H); 7.30-7.45 (m, 6H)

Compound water-soluble at 3.3 g/L.

### EXAMPLE 34

### trans-diiodo(N-poly(ethylenamine))[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol) and linear poly(ethylenamine) (˜21532 Da; 13 mg; 0.557 μmol) are suspended in ethanol (2 mL). The reaction medium is held at 55° C. for 24 h. The crude reaction product is filtered on Celite and the filtrate is concentrated, and washed with dichloromethane. This gives 28 mg of iodo(N,N′-poly(ethylenimine))[1-methyl-3-benzyl-imidazol-2-ylidene]platinum(II) iodide, illustrated below:

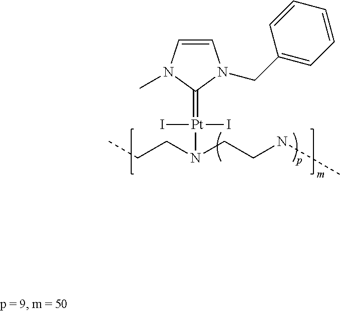

in the form of a white solid, which has the following characteristics:

¹H NMR spectrum (mixture 2: 1 CD₃CN and CD₃OD): δ 2.25-3.06 (m, 40H, 20 CH₂), 3.17-3.58 (m, NH₂ and NH masked by the signals of H₂O and CD₃OD), 4.05-4.45 (m, 3H, NCH₃), 5.85 (m, 2H, NCH₂), 7.10-7.95 (m, 7H, 5Ar—H and 2CH).

¹³C NMR spectrum (mixture 2: 1 CD₃CN and CD₃OD): δ 38.8; 46.2; 48.4-59.6; 122.2-125.0; 128.9-130.7; 136.4-138.9; 153.2-155.4

Elemental analysis: calculated (%) for C₁₅₅₀H₃₁₀₃I₁₀₀N₆₀₁Pt₅₀ C, 35.37, H, 5.95, N, 16.00. Pt, 18.55. found C, 32.24, H, 5.90, N, 14.48. Pt, 16.70 for [C_{31.21}H_{63.56}N_{12.02}Pt₁]₅₀.

Compound water-soluble at 6.7 g/L.

### EXAMPLE 35

### trans-diiodo(N-[16β-hydroxymethyl-16α-(aminoalkyl)-1,3,5(10)-estratriene-3,17-diol])[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol), and the estradiol derivative: (13S,16R,17R)-16-(7-aminoheptyl)-16-(hydroxymethyl)-13-methyl-7,8,9,11,12,13,14,15,16,17-decahydro-6H-cyclopenta[a]phenanthrene-3,17-diol (22 mg; 0.05 mmol) are suspended in methanol (1 mL). The reaction medium is held at 55° C. for 20 h. The solvent is evaporated off, the crude product is washed with pentane and purified by flash chromatography, eluting with a mixture of dichloromethane and cyclohexane and then with a mixture of dichloromethane and ethyl acetate. This gives the compound represented by the following chemical structure:

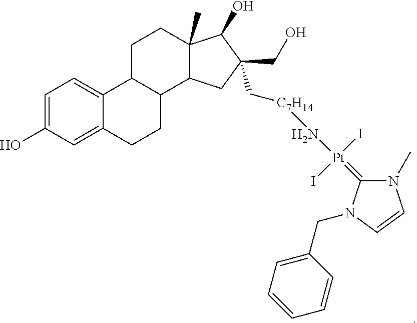

### EXAMPLE 36

### trans-diiodo(N-[16β-hydroxymethyl-16-(amino[polyethyleneglycol])-1,3,5(10)-estratriene-3,17-diol])[1-methyl-3-benzyl-imidazol-2-ylidene]platinum(II)

The compound trans-diiodo(N-pyridine)[1-methyl-3-benzyl-imidazol-2-ylidene]platinum(II) (20 mg; 0.029 mmol), and the estradiol derivative: 16β-hydroxymethyl-16-(amino[polyethyleneglycol])-1,3,5 (10)-estratriene-3,17-diol (26 mg; 0.05 mmol) are suspended in methanol (1 mL). The reaction medium is held at 55° C. for 20 h. The solvent is evaporated off, the crude product is washed with pentane and purified by flash chromatography, eluting with a mixture of dichloromethane and cyclohexane and then with a mixture of dichloromethane and ethyl acetate. This gives the compound represented by the following chemical structure:

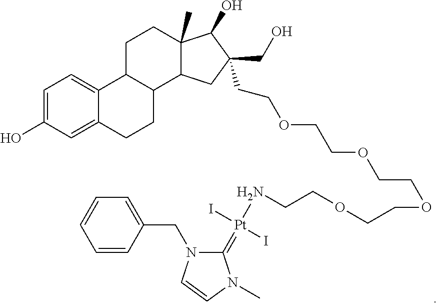

### EXAMPLE 37

### Platinum-Carbene/PMSA (Prostate Specific Membrane Antigen) Heterodimeric Inhibitor Conjugate

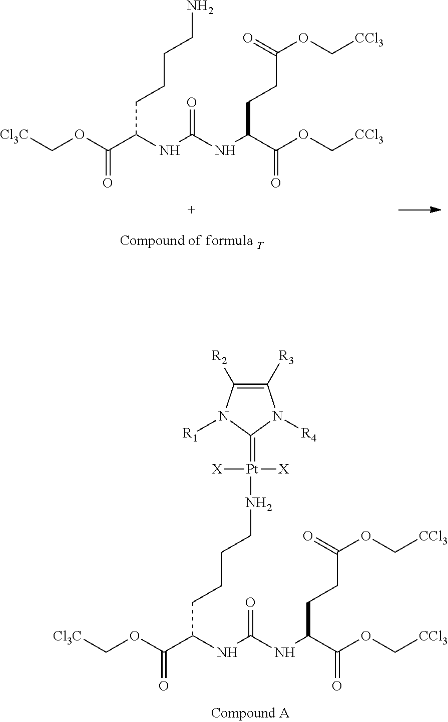

Compound I is synthesized in the classical conditions described in the literature (J. Med. Chem. 2009, 52, 347-357).

The lysine amine is then reacted with a platinum precursor complex NHC of formula I, to give compound A.

The ester group of 2,2,2-trichlorothyl can be deprotected by treatment with zinc to give compound B shown below.

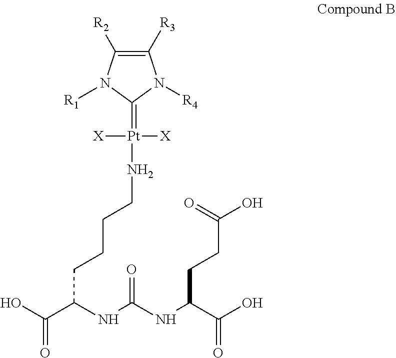

### EXAMPLE 38

### Platinum-Carbene/Cyclo(RGDfK) Cyclic Peptide Conjugate

The cyclo(RGDfK) peptide has a high affinity for integrin αvβ3, which plays an important role in angiogenesis and in metastasis of tumour cells.

The linear peptide, having the amino acid sequence H-Arg(HCl)-Gly-Asp(CH₂Cl₃)-D-Phe-Lys(N₃)—OH, is the precursor peptide of the cyclo(RGDfK) peptide.

The partially protected linear peptide is synthesized in the classical conditions of supported peptide synthesis starting from a polystyrene 2-chlorotrityl chloride resin, on which the amino acid Fmoc-Lys(N3)-OH is grafted. A succession of steps of deprotection (piperidine, DMF) and then coupling (BOP, DIEA, DMF) leads to the peptide resin having the sequence Boc Arg-H)ClGly-(AspO)CH₂Cl3D-(Phe-LysN3)(—. Treatment with trifluoroacetic acid leads to the linear peptide, precursor of the cyclo(RGDfK) peptide.

Cyclization of the cyclo(RGDfK) precursor peptide, carried out by treatment with BOP and DIEA in DMF according to the conditions described by Reid et al. (J. Org. Chem. 2003, 68, 4464-4471), gives the cyclo(RGDfK) peptide, illustrated by the following chemical structure:

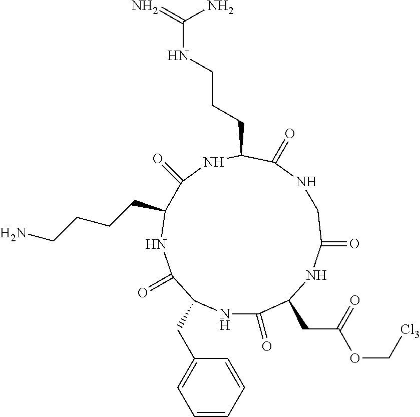

After reduction of the nitride function (H₂, Pd/C), the amide of the lysine of the cyclo(RGDfK) peptide is then reacted with a platinum precursor complex NHC of formula I to give compound C. This reaction is presented below:

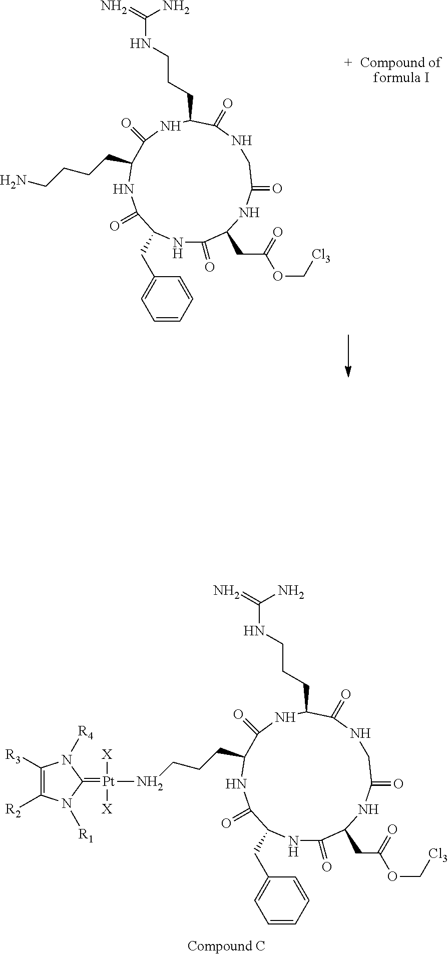

The ester group of 2,2,2-trichlorothyl can be deprotected by treatment with zinc to give compound D shown below.

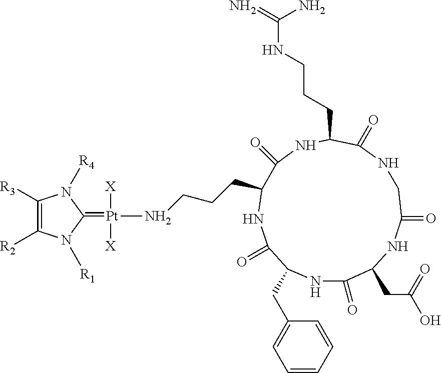

### Compound D

### EXAMPLE 39

### trans-diiodo(N-[1-((2R,7R,12R,17R)-17-amino-2,7,12-tribenzyl-4,9,14-trioxo-18-phenyl-3,5,8,10,13,15-hexaazaoctadecyl)-3-methylurea])[1-methyl-3-benzyl-imidazol-2-ylidene]platinum(II)

The compound trans-diiodo(N-pyridine)[1-methyl-3-benzyl-imidazol-2-ylidene]platinum(II) (mg, 0.059 mmol), (6R,11R,16R,21R)-6,11,16-tribenzyl-3,8,13,18-tetraoxo-22-phenyl-2,4,7,9,12,14,17,19-octaazadocosan-21-aminium trifluoroacetate (30 mg, 0.059 mmol) and triethylamine (0.5 mL) are suspended in methanol (2 mL). The reaction medium is held at 55° C. for 24 h. The solvent is evaporated off, the crude product is washed with pentane and purified by flash chromatography, eluting with dichloromethane and then with a mixture of dichloromethane and methanol (20/1 by volume). This gives 15 mg (31%) of trans-diiodo(N-[1-((2R,7R,12R,17R)-17-amino-2,7,12-tribenzyl-4,9,14-trioxo-18-phenyl-3,5,8,10,13,15-hexaazaoctadecyl)-3-methylurea])[1-methyl-3-benzyl-imidazol-2-ylidene]platinum(II), illustrated below:

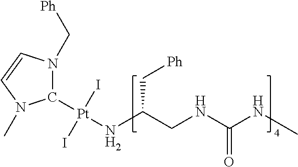

in the form of yellow oil, which has the following characteristics:

¹H NMR spectrum (CDCl₃): δ 2.41-2.85 (m, 8H, 8CH), 2.69 (d, J=4.8 Hz, 3H, CH₃), 3.05-3.67 (m, 10H, 8CH and NH₂), 3.84 (s, 3H, NCH₃), 3.90-4.08 (m, 4H, 4CH), 5.12 (d, J=10.5 Hz, 1H, NH), 5.41 (m, 2H, 2NH), 5.56-5.77 (m, 5H, 3NH and NCH₂), 5.93 (m, 1H, NH), 6.82 (d, J=2.1 Hz, 1H, CH), 7.03 (d, J=2.1 Hz, 1H, CH), 7.20-7.35 (m, 25H, 25Ar—H).

¹³C NMR spectrum (CDCl₃): δ 38.1 (NCH₃), 39.2 (Br), 40.4, 44.5-46.4 (Br), 50.9, 54.3 (NCH₂), 120.0 (CH), 122.4 (CH), 126.4 (Br, CH_{aromatic}), 128.3-129.2 (CH_{aromatic}), 135.2 (C_{aromatic}), 137.5 (C_{aromatic}), 138.3 (C_{aromatic}), 138.4 (C_{aromatic}), 139.4 (C—Pt), 159.3 (CO), 159.4 (CO), 159.6 (CO), 160.6 (CO).

Mass spectrum (positive ESI mode): 1356.67, 736.17, 619.08

### EXAMPLE 40

### trans-diiodo(N-[(6S,9S)-methyl 9-(4-aminobutyl)-6-((R)-sec-butyl)-2,2-dimethyl-4,7,10-trioxo-3-oxa-5,8,11-triazatridecan-13-oate])[1-methyl-3-benzyl-imidazol-2-ylidene]platinum(II)

The compound trans-diiodo(N-pyridine)[1-methyl-3-benzyl-imidazol-2-ylidene]platinum(II) (20 mg, 0.029 mmol) and (6S,9S)-methyl 9-(4-aminobutyl)-6-((R)-sec-butyl)-2,2-dimethyl-4,7,10-trioxo-3-oxa-5,8,11-triazatridecan-13-oate (14 mg, 0.034 mmol) are suspended in ethanol (1 mL). The reaction medium is held at 55° C. for 24 h. The solvent is evaporated off, the crude product is washed with pentane and purified by flash chromatography, eluting with dichloromethane and then with a mixture of dichloromethane and methanol (20/1 by volume). This gives 5 mg (17%) of trans-diiodo(N-[(6S,9S)-methyl 9-(4-aminobutyl)-6-((R)-sec-butyl)-2,2-dimethyl-4,7,10-trioxo-3-oxa-5,8,11-triazatridecan-13-oate])[1-methyl-3-benzyl-imidazol-2-ylidene]platinum(II), illustrated below:

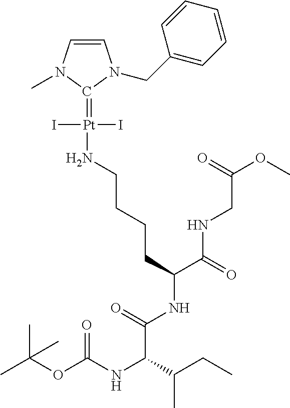

in the form of yellow oil, which has the following characteristics:

¹H NMR spectrum (CDCl₃): δ 0.96-1.00 (m, 6H, 2CH₃), 1.25-2.21 (m, 9H, 4CH₂ and CH), 1.45 (s, 9H, 3CH₃), 3.14-3.24 (m, 2H, NH₂), 3.74 (s, 3H, OCH₃), 3.89 (s, 3H, NCH₃), 4.11 (m, 2H, CH₂), 4.21 (m, 1H, CH), 4.55 (m, 1H, CH), 5.05 (m, 1H, NH), 5.59 (s, 2H, CH₂), 6.59 (m, 2H, CH and NH), 6.81 (m, 2H, CH and NH), 7.28-7.50 (m, 5H, 5Ar—H).

Mass spectrum (positive ESI mode): calculated for C₃₁H₅₀I₂N₆O₆PtNa 1074.142. found 1074.145.

### EXAMPLE 41

### trans-diiodo(N—[(S)-cyclohexyl 4-amino-5-(((9S,12S)-1-(2-chlorophenyl)-12-methyl-3,10,13-trioxo-15-phenyl-2,14-dioxa-4,11-diazapentadecan-9-yl)amino)-5-oxopentanoate])[1-methyl-3-benzyl-imidazol-2-ylidene]platinum(II)

The compound trans-diiodo(N-pyridine)[1-methyl-3-benzyl-imidazol-2-ylidene]platinum(II) (30 mg, 0.043 mmol), (S)-1-(((9S,12S)-1-(2-chlorophenyl)-12-methyl-3,10,13-trioxo-15-phenyl-2,14-dioxa-4,11-diazapentadecan-9-yl)amino)-5-(cyclohexyloxy)-1,5-dioxopentan-2-aminium hydrochloride (34 mg, 0.047 mmol) and triethylamine (0.05 mL) are suspended in ethanol (2 mL). The reaction medium is held at 55° C. for 24 h. The solvent is evaporated off, the crude product is washed with pentane and purified by flash chromatography, eluting with dichloromethane and then with a mixture of dichloromethane and methanol (20/1 by volume). This gives 30 mg (54%) of trans-diiodo(N—[(S)-cyclohexyl 4-amino-5-(((9S,12S)-1-(2-chlorophenyl)-12-methyl-3,10,13-trioxo-15-phenyl-2,14-dioxa-4,11-diazapentadecan-9-yl)amino)-5-oxopentanoate])[1-methyl-3-benzyl-imidazol-2-ylidene]platinum(II), illustrated below:

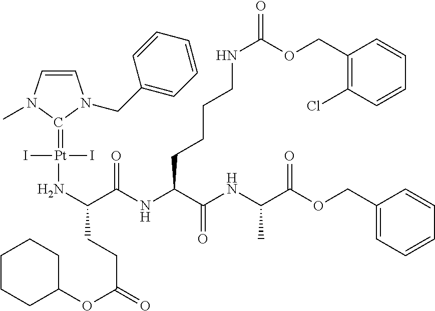

in the form of yellow oil, which has the following characteristics:

¹H NMR spectrum (CDCl₃): δ 1.24-2.00 (m, 21H, CH₃ and 9CH₂), 2.12 (m, 2H, CH₂), 2.62 (m, 1H, CH), 3.15 (m, 2H, CH₂), 3.56 (m, 2H, NH₂), 3.87 (s, 1H, OCH₃), 4.16 (m, 1H, CH), 4.45 (m, 1H, CH), 4.60 (m, 1H, CH), 4.79 (m, 1H, NH), 5.11-5.23 (m, 5H, 2CH₂ and NH), 5.55 and 5.57 (2s, 2×1H, CH₂), 6.54 (d, J=2.1 Hz, 1H, CH), 6.68 (d, J=7.5 Hz, 1H, NH), 6.77 (d, J=2.1 Hz, 1H, CH), 7.21-7.44 (m, 14H, 14Ar—H).

Mass spectrum (positive ESI mode): [M+Na]: calculated for C₄₆H₅₉ClI₂N₆O₈Pt.Na 1330.172. found 1330.178

### EXAMPLE 42

### trans-diiodo(N—[(S)-dimethyl 2-(3-((S)-6-(6-aminohexanamido)-1-methoxy-1-oxohexan-2-yl)ureido)pentanedioate])[1-methyl-3-benzyl-imidazol-2-ylidene]platinum(II)

The compound trans-diiodo(N-pyridine)[1-methyl-3-benzyl-imidazol-2-ylidene]platinum(II) (40 mg, 0.057 mmol), (6S,10S)-6,10-bis(methoxycarbonyl)-3,8,16-trioxo-2-oxa-7,9,15-triazaheneicosan-21-aminium trifluoroacetate (30 mg, 0.052 mmol) and triethylamine (0.03 mL) are suspended in tetrahydrofuran (2 mL). The reaction medium is held at 55° C. for 24 h. The solvent is evaporated off, the crude product is washed with pentane and purified by flash chromatography, eluting with dichloromethane and then with a mixture of dichloromethane and methanol (20/1 by volume). This gives 16 mg (28%) of trans-diiodo(N-[(S)-dimethyl 2-(3-((S)-6-(6-aminohexanamido)-1-methoxy-1-oxohexan-2-yl)ureido)pentanedioate])[1-methyl-3-benzyl-imidazol-2-ylidene]platinum(II), illustrated below:

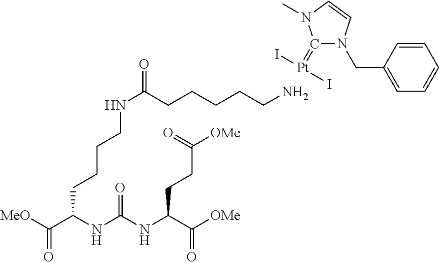

in the form of yellow oil, which has the following characteristics:

¹H NMR spectrum (CDCl₃): δ 1.29-1.85 (m, 12H, 6CH₂), 1.97-2.23 (m, 4H, 2CH₂), 2.44 (m, 2H, CH₂), 3.03 (m, 4H, CH₂ and NH₂), 3.22 (m, 2H, CH₂), 3.68 (s, 3H, OCH₃), 3.74 (s, 6H, 2OCH₃), 3.89 (s, 3H, NCH₃), 4.41 (m, 1H, CH), 4.47 (m, 1H, CH), 5.52 (d, J=8.1 Hz, 1H, NH), 5.59 (s, 2H, NCH₂), 5.62 (d, J=7.8 Hz, 1H, NH), 5.88 (t, J=5.7 Hz, 1H, NH), 6.57 (d, J=2.1 Hz, 1H, CH), 6.78 (d, J=2.1 Hz, 1H, CH), 7.34-7.46 (m, 5H, 5Ar—H)

¹³C NMR spectrum (CDCl₃): δ 22.2 (CH₂), 25.1 (CH₂), 25.9 (CH₂), 27.9 (CH₂), 28.8 (CH₂), 30.2 (CH₂), 31.4 (CH₂), 31.7 (CH₂), 36.3 (NCH₃), 38.2 (CH₂), 38.6 (CH₂), 45.2 (NHCH₂), 51.8, 52.3, 52.5, 52.8, 54.4 (NCH₂), 119.9 (CH), 122.3 (CH), 128.3 (CH_{aromatic}), 128.8 (CH_{aromatic}), 129.0 (CH_{aromatic}), 135.4 (C_{aromatic}), 139.5 (C—Pt), 157.1 (CO), 173.3 (CO), 173.4 (CO), 173.5 (CO), 173.7 (CO)

Mass spectrum (positive ESI mode): [M+H]: calculated for C₃₂H₅₀I₂N₆O₈Pt.H 1096.150. found 1096.154.

### EXAMPLE 43

### trans-diiodo(N—[(S)-dimethyl 2-(3-((S)-6-amino-1-methoxy-1-oxohexan-2-yl)ureido)pentanedioate])[1-methyl-3-benzyl-imidazol-2-ylidene]platinum(II)

The compound trans-diiodo(N-pyridine)[1-methyl-3-benzyl-imidazol-2-ylidene]platinum(II) (152 mg, 0.217 mmol), (S)-5-(3-((S)-1,5-dimethoxy-1,5-dioxopentan-2-yl)ureido)-6-methoxy-6-oxohexan-1-aminium trifluoroacetate (100 mg, 0.217 mmol) and triethylamine (0.14 mL) are suspended in tetrahydrofuran (2 mL). The reaction medium is held at 55° C. for 24 h. The solvent is evaporated off, the crude product is washed with pentane and purified by flash chromatography, eluting with dichloromethane and then with a mixture of dichloromethane and 1% of methanol. This gives 136 mg (64%) of trans-diiodo(N—[(S)-dimethyl 2-(3-((S)-6-amino-1-methoxy-1-oxohexan-2-yl)ureido)pentanedioate])[1-methyl-3-benzyl-imidazol-2-ylidene]platinum(II), illustrated below:

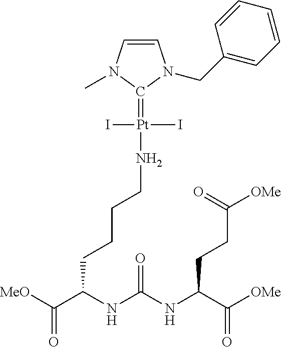

in the form of yellow oil, which has the following characteristics:

¹H NMR spectrum (CDCl₃): δ 1.37-1.82 (m, 6H, 3CH₂), 1.83-2.10 (m, 2H, CH₂), 3.00 (m, 2H, CH₂), 3.05 (m, 2H, NH₂), 3.66 (s, 3H, OCH₃), 3.76 (s, 6H, 2OCH₃), 3.87 (s, 3H, NCH₃), 4.48 (m, 2H, 2CH), 5.41 (d, J=8.4 Hz, 1H, NH), 5.49 (d, J=8.1 Hz, 1H, NH), 5.57 (s, 2H, NCH₂), 6.55 (s, 1H, CH), 6.77 (s, 1H, CH), 7.33-7.45 (m, 5H, 5Ar—H)

¹³C NMR spectrum (CDCl₃): δ 22.2 (CH₂), 27.8 (CH₂), 30.2 (CH₂), 31.1 (CH₂), 32.3 (CH₂), 38.2 (NCH₃), 45.0 (CH₂), 51.8, 52.4, 52.6, 52.8, 54.4 (NCH₂), 119.9 (CH), 122.3 (CH), 128.3 (CH_{aromatic}), 128.8 (CH_{aromatic}), 129.0 (CH_{aromatic}), 135.4 (C_{aromatic}), 139.7 (C—Pt), 156.9 (CO), 173.4 (2CO), 173.8 (CO)

Mass spectrum (positive ESI mode): 982.56, 619.05.

1. Compound of the following formula I: 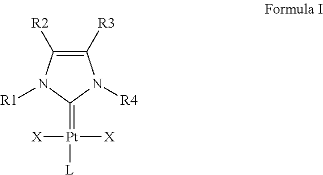
in which:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
L represents:
(i) an amine of formula 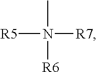
in which R5, R6 and R7 represent, independently of one another:
(a) a hydrogen,
(b) a linear or branched C1-C20 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular selected from alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 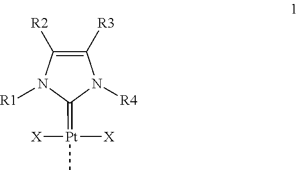
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine,
excluding the compounds of formula I, in which:
R1 and/or R4 represent, independently of one another, an aryl or aralkyl group, each optionally substituted, a linear or branched C1-C6 alkyl group, monocyclic C3-C7 cycloalkyl, linear or branched C2-C6 alkenyl,
R2 and/or R3 represent hydrogen, a phenyl group,
and X represents iodine, bromine or chlorine,
L represents:
an amine of formula 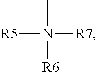
in which:
R5 and R6 represent a hydrogen and R7 represents a group selected from the cycloalkyl, mono- or bicyclic C3-C7 heterocycloalkyl or benzyl groups, optionally substituted,
R5, R6 or R7 represent simultaneously a hydrogen, or
R5 represents a hydrogen and R6 and R7 form, together with NH, a heterocycloalkyl, in particular a morpholine, or in which:
R1 and/or R4 represent, independently of one another, an unsubstituted linear or branched C1-C6 alkyl group,
R2 and/or R3 simultaneously represent hydrogen,
and X represents iodine, bromine or chlorine,
L represents a pyridine.

2. Compound according to claim 1 of the following formula I: 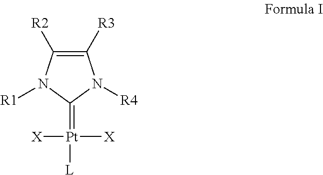
in which
(I) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
then L represents:
(i) an amine of formula 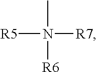
in which R5, R6 and R7 represent, independently of one another:
(a) a hydrogen,
(b) a non-cyclized linear or branched C1-C20 alkyl, optionally substituted with an estradiol,
(c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, in particular with a trimethylsilyl,
(d) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a hydrazine monosubstituted with an aryl having 1, 2 or 3 aromatic rings, in particular a phenyl, or a linear or branched alkyl with 1 to 12 carbon atoms,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xvi) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xvii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 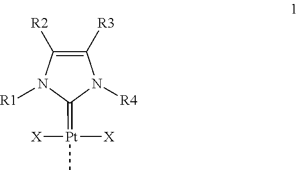
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine;
(IIa) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
a linear or branched C1-C6 alkyl group, substituted with a trimethylsilyl group, or a non-cyclized linear or branched C7-C12, in particular C7-C8, alkyl group, optionally substituted with an alkoxy group with 1 to 12 carbon atoms, in particular with 1 to 8 carbon atoms, with a CF₃ group or in particular with a trimethylsilyl group,
a linear or branched C2-C12, in particular C2-C8 alkenyl group, substituted with a trimethylsilyl group,
a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
II (b) or, if:
R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
with the condition that R2 or R3 represents:
an aralkyl group with a C1-C12, in particular C1-C8 carbon chain, the aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilylbenzyl group, or
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
then:
L represents:
(i) an amine of formula 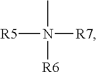
in which R5, R6 and R7 represent, independently of one another:
(a) a hydrogen,
(b) a non-cyclized linear or branched C1-C20 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, m=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)ₙ—NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 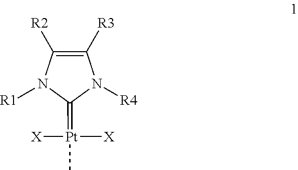
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

3. Compound of formula I according to claim 1: 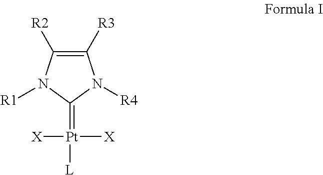
in which
(I) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
then L represents:
(i) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(ii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(iii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(iv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 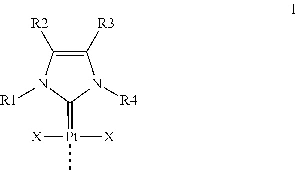
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine;
(IIa) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
a linear or branched C1-C6 alkyl group, substituted with a trimethylsilyl group,
an aryl group having 2 or 3 aromatic rings, in particular naphthalenyl or anthracenyl, the aryl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
II (b) or, if:
R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
then:
L represents:
(i) an amine of formula 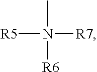
in which R5, R6 and R7 represent, independently of one another:
(a) a hydrogen,
(b) a non-cyclized linear or branched C1-C18 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 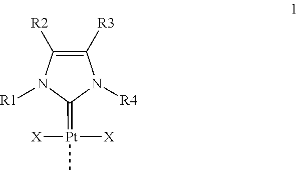
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

4. Compound of formula I according to claim 1: 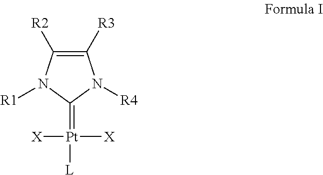
in which
(Ia) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
(Ib) or, if:
R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
then:
L represents:
(i) an amine of formula 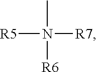
in which R5, R6 and R7 represent, independently of one another:
(a) a hydrogen,
(b) a non-cyclized linear or branched C1-C18 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 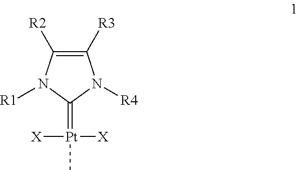
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

5. Compound of formula I according to claim 1: 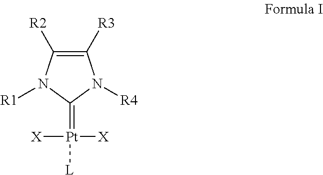
in which
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
L represents:
(i) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(ii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(iii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(iv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 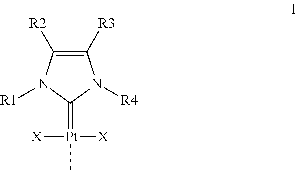
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

6. Compound of formula I according to claim 1: 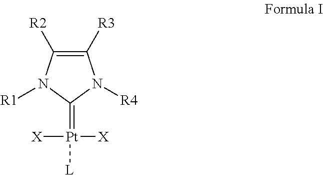
in which
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
a linear or branched C1-C6 alkyl group, substituted with a trimethylsilyl group,
an aryl group having 2 or 3 aromatic rings, in particular naphthalenyl or anthracenyl, the aryl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
L represents:
(i) an amine of formula 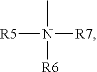
in which R5, R6 and R7 represent, independently of one another:
(a) a hydrogen,
(b) a non-cyclized linear or branched C1-C18 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 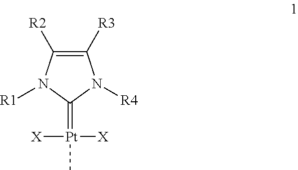
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

7. Compound of formula I according to claim 1:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and L represents:
an amine of formula 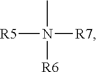
in which R5, R6 and R7 represent, independently of one another:
(a) a hydrogen, or
(b) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xi) a piperazine N-substituted with a dansyl or dabsyl group
(xii) a hydrazine monosubstituted with an aryl having 1, 2 or 3 aromatic rings, in particular a phenyl, or a linear or branched alkyl with 1 to 12 carbon atoms,
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 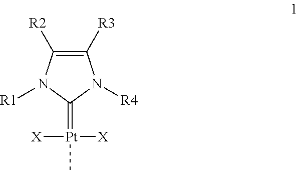
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

8. Compound of formula I according to claim 1:
R2 and R3 are hydrogens,
X represents iodine, bromine or chlorine, and
R1 is a methyl and R4 is a benzyl, or
R4 is a methyl and R1 is a benzyl, and
L represents:
(i) an amine of formula 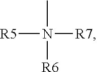
in which R5, R6 and R7 represent, independently of one another:
(a) a hydrogen,
(b) a non-cyclized linear or branched C1-C20 alkyl, optionally substituted with an estradiol,
(c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, or in particular with a trimethylsilyl,
(d) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a hydrazine monosubstituted with an aryl having 1, 2 or 3 aromatic rings, in particular a phenyl, or a linear or branched alkyl with 1 to 12 carbon atoms,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group,
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xvi) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group.
(xvii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 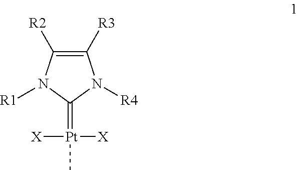
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2.

9. Compound of formula I according to claim 8, in which:
R2 and R3 are hydrogens,
X represents iodine, bromine or chlorine, and
R1 is a methyl and R4 is a benzyl, or
R4 is a methyl and R1 is a benzyl, and
L represents:
(i) an amine of formula 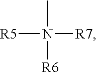
in which R5, R6 and R7 represent, independently of one another:
(a) a hydrogen,
(b) a linear or branched C1-C18 alkyl, substituted with an estradiol
(c) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol
provided that at least one of the R5, R6 and R7 radicals is different from hydrogen,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or amides,
(viii) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(ix) a hydrazine monosubstituted with an aryl having 1, 2 or 3 aromatic rings, in particular a phenyl, or a linear or branched alkyl with 1 to 12 carbon atoms,
(x) a piperazine N-substituted with a dansyl or dabsyl group,
(xi) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xiii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 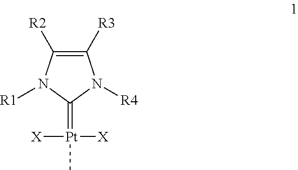
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2.

10. Compound of formula I according to claim 1: 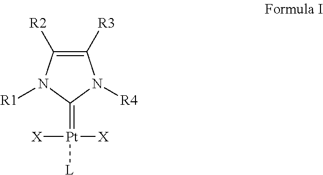
in which
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
L represents a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 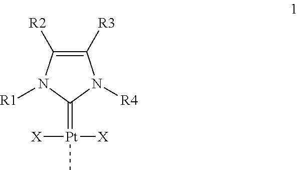
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2, or
and X represents iodine, bromine or chlorine.

11. Compound of formula I according to claim 9, of the following formula Ia: 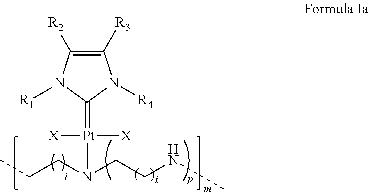
in which
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
X represents iodine, bromine or chlorine,
m=1 to 1000, in particular m=1 to 100, more particularly from 1 to 50,
p=0 to 50, in particular p=1 to 20, more particularly from 1 to 10, p representing the ratio of the number of platinum atoms to the number of amines of —NH— or —NH₂ type,
i=1, 2 or 3.

12. Compound of formula I according to claim 1, selected from:

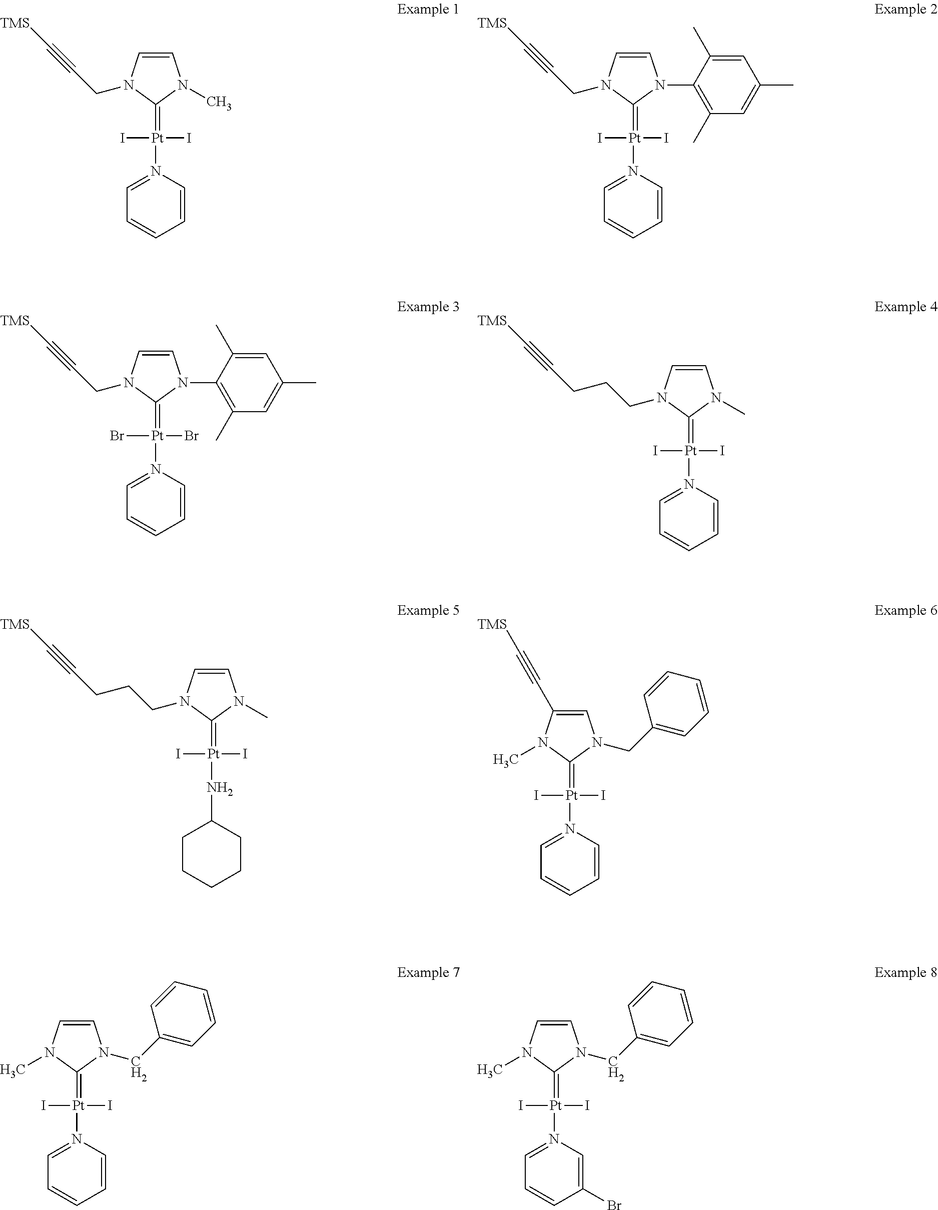

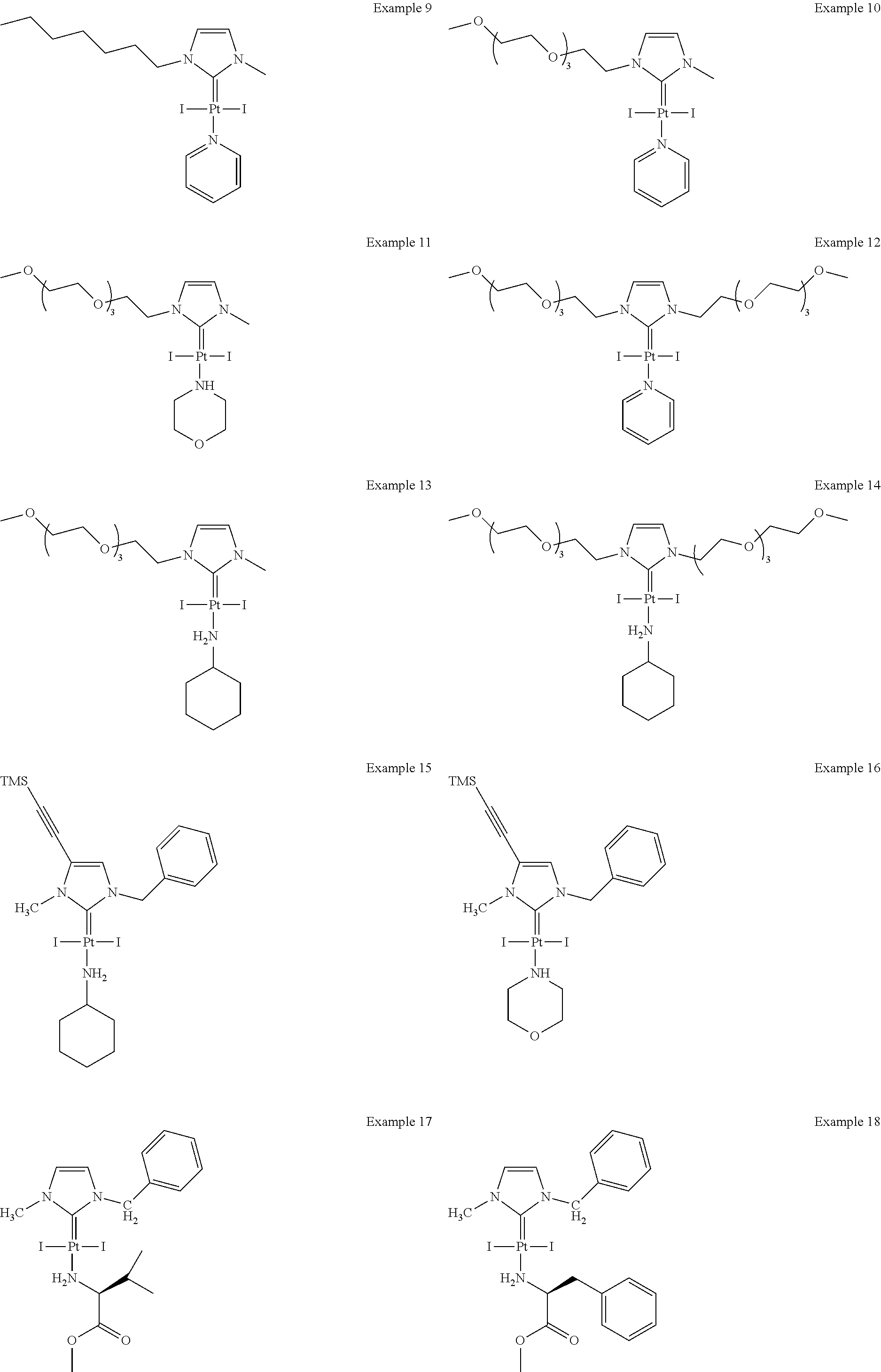

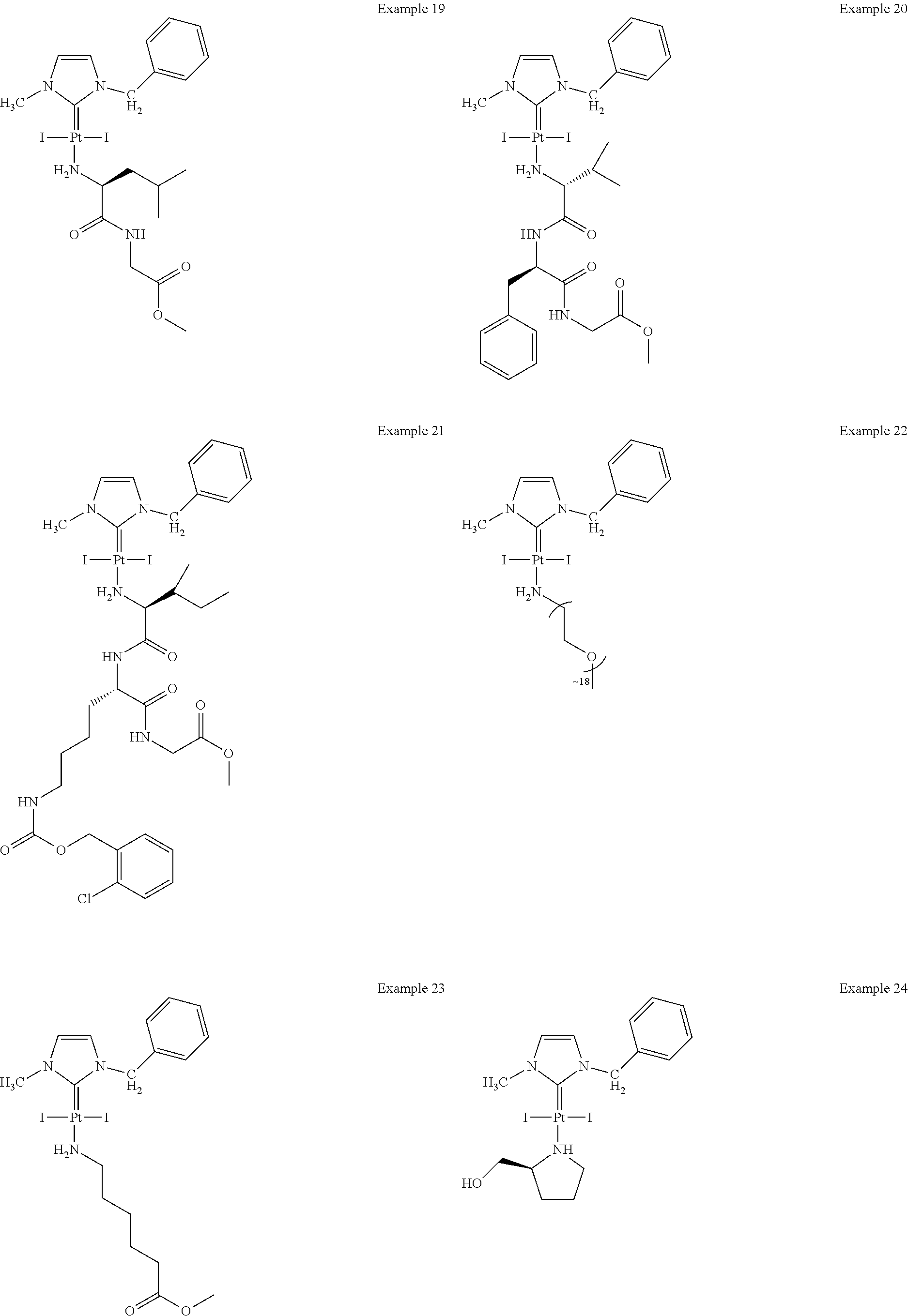

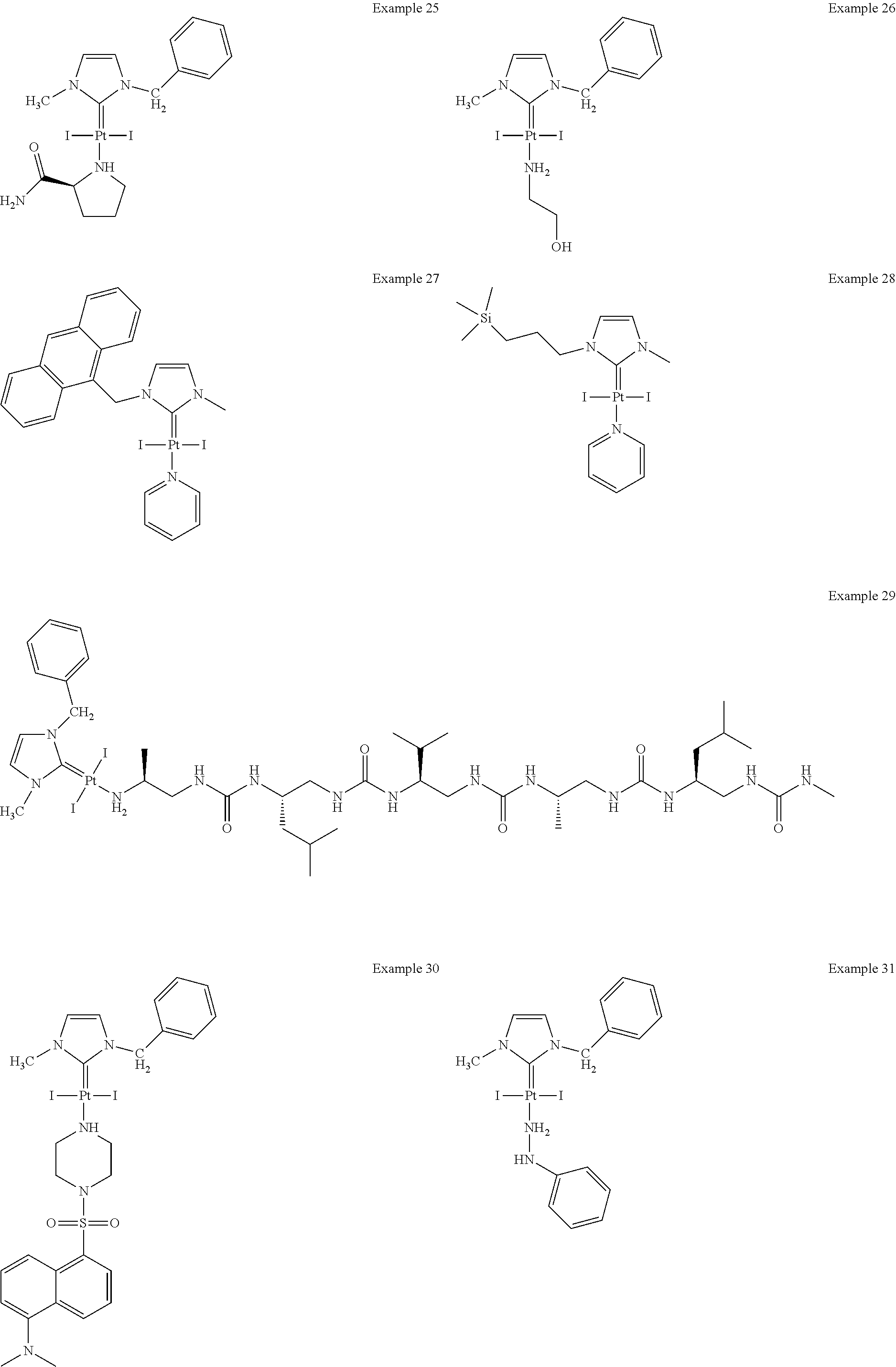

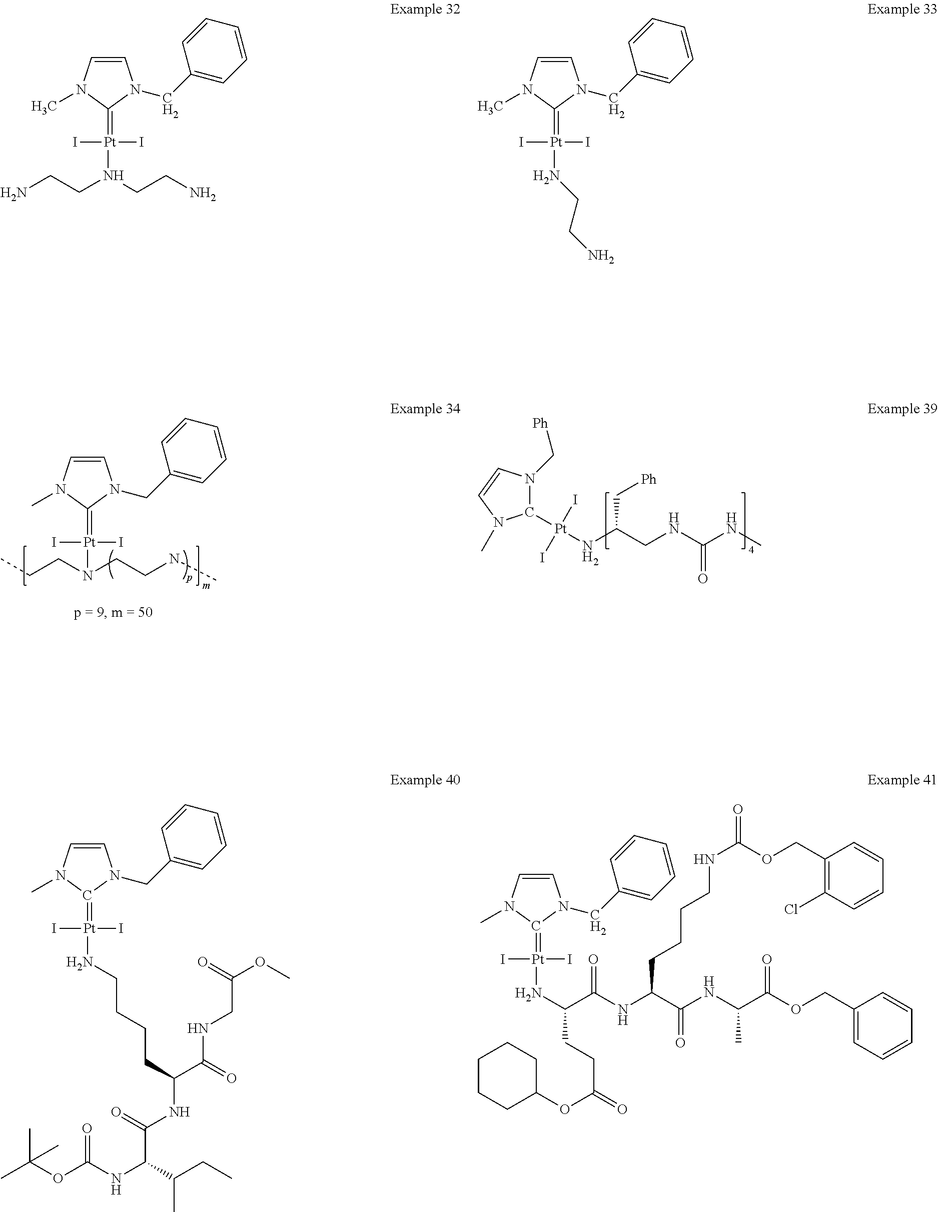

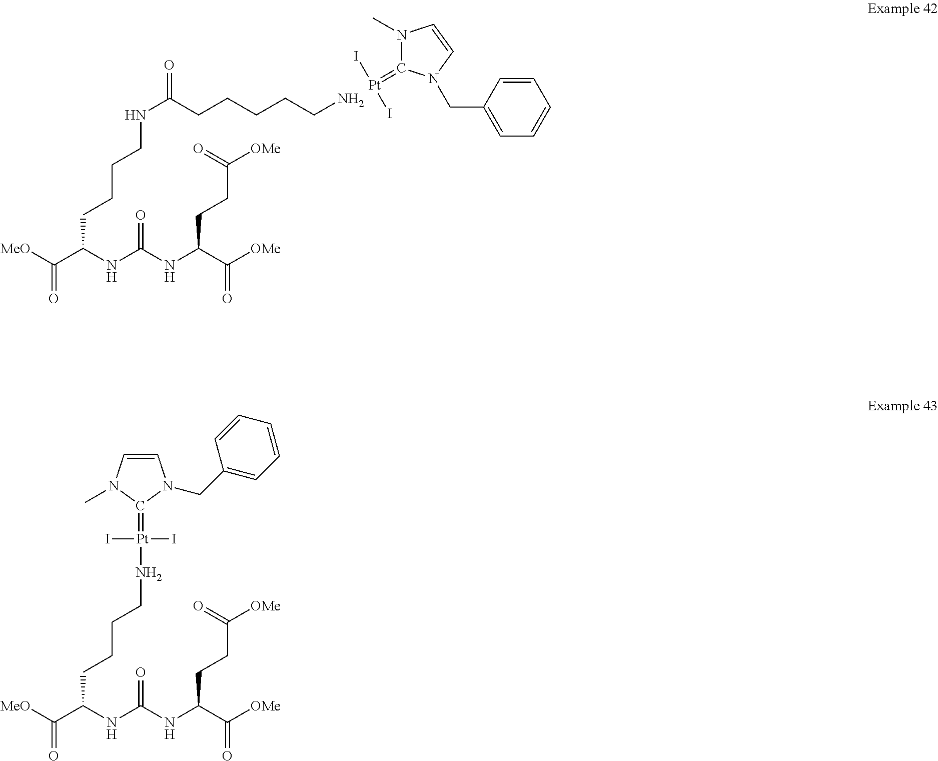

13. Compound of formula I according to claim 1, for use as a medicinal product.

14. Pharmaceutical composition comprising a compound of formula I according to claim 1 as active ingredient, and a pharmaceutically acceptable vehicle.

15. Pharmaceutical composition, comprising a compound of formula I according to claim 1 as active ingredient, and a pharmaceutically acceptable vehicle, used in the treatment of cancers, in particular in the treatment of a cancer selected from cervical cancer, glioma, colon cancer, breast cancer, pancreatic cancer, prostate cancer, liver cancer, lung cancer, stomach cancer, intestinal cancer, cancer, melanoma, multiple myeloma.

16. Compound of formula I according to claim 2: 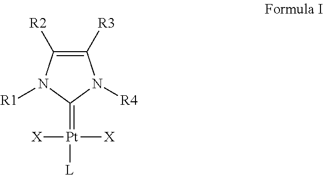
in which
(I) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
then L represents:
(i) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(ii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(iii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(iv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 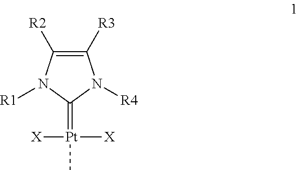
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine;
(IIa) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
a linear or branched C1-C6 alkyl group, substituted with a trimethylsilyl group,
an aryl group having 2 or 3 aromatic rings, in particular naphthalenyl or anthracenyl, the aryl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
II (b) or, if:
R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
then:
L represents:
(i) an amine of formula 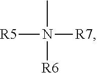
in which R5, R6 and R7 represent, independently of one another:
(a) a hydrogen,
(b) a non-cyclized linear or branched C1-C18 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 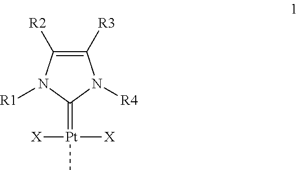
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

17. Compound of formula I according to claim 2: 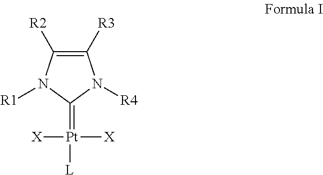
in which
(Ia) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
(Ib) or, if:
R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
then:
L represents:
(i) an amine of formula 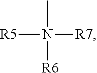
in which R5, R6 and R7 represent, independently of one another:
(a) a hydrogen,
(b) a non-cyclized linear or branched C1-C18 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 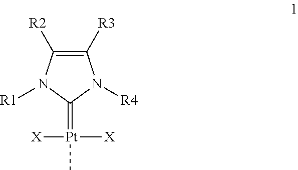
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

18. Compound of formula I according to claim 3: 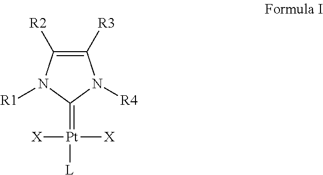
in which
(Ia) if:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, or in particular C1-C8, alkyl group,
with the condition that R1 or R4 represents:
a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
(Ib) or, if:
R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
with the condition that R2 or R3 represents:
a linear or branched C2-C12, in particular C2-C8, alkynyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
then:
L represents:
(i) an amine of formula 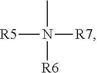
in which R5, R6 and R7 represent, independently of one another:
(a) a hydrogen,
(b) a non-cyclized linear or branched C1-C18 alkyl, optionally substituted with an estradiol,
(c) an aryl group having 1, 2 or 3 aromatic rings, in particular phenyl, or aralkyl with a C1-C12, in particular C1-C8 carbon chain, the aryl, aralkyl group being optionally substituted with a C1-C12, in particular C1-C8 alkoxy group, such as a methoxy, or an alkyl group with 1 to 12 carbon atoms, in particular with 1 to 8 carbon atoms, with a CF₃ group or with a trimethylsilyl group,
(d) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(e) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
(ii) a diamine of general formula NH₂—(CH₂)ₙ—NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a morpholine,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group
(xiii) a hydrazine monosubstituted with an aryl having 1, 2 or 3 aromatic rings, in particular a phenyl, or a linear or branched alkyl with 1 to 12 carbon atoms,
(xiv) a glucamine optionally N-substituted with an alkyl group with 1 to 20 carbon atoms, in particular N-methylglucamine, N-ethylglucamine or N-dodecylglucamine,
(xv) a glucosamine optionally N-substituted with an alkyl group with 1 to 20 carbon atoms
(xvi) a pyridine or a pyridine substituted with iodine, bromine or chlorine, in particular 3-bromopyridine, or 3-chloropyridine, or disubstituted with iodine, bromine or chlorine, in particular 3,5-dibromopyridine
(xvii) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xviii) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group,
(xix) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 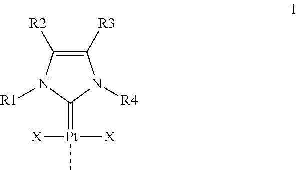
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

19. Compound of formula I according to claim 2, in which:
R1 and R4 represent, independently of one another:
(i) a linear or branched C1-C12, in particular C1-C8 alkyl group, optionally substituted with an alkoxy group with 1 to 12 carbon atoms, in particular with 1 to 8 carbon atoms, with a CF₃ group or in particular with a trimethylsilyl group,
(ii) a linear or branched C2-C12, in particular C2-C8 alkenyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iii) a linear or branched C2-C12, in particular C2-C8 alkynyl group, optionally substituted with an alkyl group with 1 to 12 carbon atoms, with an alkoxy group with 1 to 12 carbon atoms, in particular with 1 to 8 carbon atoms, with a CF₃ group, or in particular with a trimethylsilyl group,
(iv) an aryl group having 1, 2 or 3 aromatic rings, in particular phenyl, or aralkyl with a C1-C12, in particular C1-C8 carbon chain, the aryl or aralkyl group being optionally substituted with a C1-C12, in particular C1-C8 alkyl group, or with a C1-C12, in particular C1-C8 alkoxy group, such as a methoxy, with a CF₃ group, or in particular with a trimethylsilyl group,
(v) a C3-C7 cycloalkyl, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, in particular with a trimethylsilyl group, or
(vi) a polyethylene glycol represented by the formula —(CH₂CH₂O)ₙ—R′ or a polypropylene glycol represented by the formula —(CH₂CH₂CH₂O)ₙ—R′, in which n=1 to 40, in particular n=1 to 20, and R′ is a C1-C12, in particular C1-C8 alkyl group,
and R2 and R3 represent, independently of one another:
a hydrogen,
an aryl or aralkyl group, in particular phenyl, benzyl, or
a C2-C12, in particular C2-C8 alkynyl group, linear or branched, optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl group,
and L represents:
an amine of formula 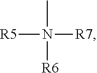
in which R5, R6 and R7 represent, independently of one another:
(a) a hydrogen, or
(b) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in
particular with 1 to 8 carbon atoms,
(x) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xi) a piperazine N-substituted with a dansyl or dabsyl group
(xii) a hydrazine monosubstituted with an aryl having 1, 2 or 3 aromatic rings, in particular a phenyl, or a linear or branched alkyl with 1 to 12 carbon atoms,
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 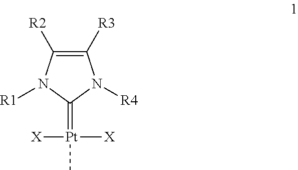
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2,
and X represents iodine, bromine or chlorine.

20. Compound of formula I according to claim 2, in which:
R2 and R3 are hydrogens,
X represents iodine, bromine or chlorine, and
R1 is a methyl and R4 is a benzyl, or
R4 is a methyl and R1 is a benzyl, and
L represents:
(i) an amine of formula 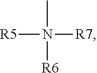
in which R5, R6 and R7 represent, independently of one another:
(a) a hydrogen,
(b) a non-cyclized linear or branched C1-C20 alkyl, optionally substituted with an estradiol,
(c) an aryl having 1 or 2 or 3 aromatic rings, in particular phenyl, optionally substituted with a C1-C12, in particular C1-C8 alkoxy group, such as a methoxy, or an alkyl group with 1 to 12 carbon atoms, in particular with 1 to 8 carbon atoms, with a CF₃ group, or in particular with a trimethylsilyl,
(d) a polymer represented by the formula —(CH₂CH₂O)ₙ—R′ or the formula —(CH₂CH₂CH₂O)ₙ—R′, in which n=1 to 40, in particular n=1 to 20, and R′ is a C1-C12, in particular C1-C8 alkyl group, optionally substituted with an estradiol,
provided that at least one of the R5, R6 and R7 radicals is different from hydrogen,
(ii) a diamine of general formula NH₂—(CH₂)n-NH₂, n=1 to 12 carbon atoms,
(iii) a triamine of general formula NH₂—(CH₂)ₙ—NH—(CH₂)_{n′}—NH₂, n=1 to 12 carbon atoms, n′=1 to 12 carbon atoms,
(iv) a linear or branched amino alcohol with 2 to 20 carbon atoms, in particular prolinol,
(v) a linear or branched amino ester with 2 to 20 carbon atoms, in particular with 2 to 10 carbon atoms,
(vi) a linear or branched amino amide with 2 to 20 carbon atoms, in particular prolinamide,
(vii) an amino acid in particular selected from the 20 proteinogenic α-amino acids or their esters or amides, and in particular alanine or its esters or amides, arginine or its esters or amides, asparagine or its esters or amides, aspartate or its esters or amides, cysteine or its esters or amides, glutamate or its esters or amides, glutamine or its esters or amides, glycine or its esters or amides, isoleucine or its esters or amides, leucine or its esters or amides, lysine or its esters or amides, methionine or its esters or amides, serine or its esters or amides, threonine or its esters or amides, or valine or its esters or amides,
(viii) a beta or gamma amino acid or its esters or amides,
(ix) a peptide, optionally cyclic, comprising 2 to 30, in particular 2 to 10 and in particular 2 to 3 amino acids, where the C-terminal acid and the N-terminal amine of said peptide and the side chains of said amino acids can be substituted with one or more substituent(s) selected independently from:
a linear or branched C1-C6 alkyl,
an aryl group having 1, 2 or 3 aromatic rings, in particular phenyl, or aralkyl with a C1-C12, in particular C1-C8 carbon chain,
a C3-C7 cycloalkyl, optionally substituted with an alkyl group with 1 to 12 carbon atoms, in particular with 1 to 8 carbon atoms,
(x) a hydrazine monosubstituted with an aryl having 1, 2 or 3 aromatic rings, in particular a phenyl, or a linear or branched alkyl with 1 to 12 carbon atoms,
(xi) a piperazine optionally substituted with an alkyl group with 1 to 12 carbon atoms, in particular with 1 to 8 carbon atoms, with an alkoxy group with 1 to 12 carbon atoms, in particular with 1 to 8 carbon atoms, with a CF₃ group, or in particular with a trimethylsilyl,
(xii) a piperazine N-substituted with a dansyl or dabsyl group,
(xiii) a glucamine optionally N-substituted with an alkyl group with 1 to 20 carbon atoms, in particular N-methylglucamine, N-ethylglucamine or N-dodecylglucamine,
(xiv) a glucosamine optionally N-substituted with an alkyl group with 1 to 20 carbon atoms,
(xv) a pseudopeptide of general formula H—(NH—CH(R)—CH₂—Y—CO)n-NHR″, with R being a side chain of one of the 20 proteinogenic amino acids; Y being independently, throughout the sequence, CH₂, O or NH; n=1-15; R″=H, or short alkyl, or aralkyl chain,
(xvi) a pseudopeptide of general formula Rₐ—CO—CH(R_{b})—NH—CO—NH—CH(R_{c})—CO—R_{d} in which Rₐ and R_{d} represent, independently of one another, H, a linear or branched C1-C6 alkyl group, a monocyclic C3-C7 cycloalkyl group, or a carboxylic acid protective group; R_{b} represents the side chain of lysine, the amine of said side chain being optionally substituted with a —CO—(CH₂)₅—NH₂ group; R_{c} represents a side chain of one of the 20 proteinogenic amino acids, optionally protected by an ad hoc protective group.
(xvii) a polymer represented by the general formula NH₂—(CH₂(CH₂)ᵢNH)₍ₙ₋₁₎—H, in which i=1, 2 or 3, n=1 to 1000, in particular n=1 to 500, more particularly from 1 to 100, said polymer moreover forming m−1 coordination bonds with m−1 groups of formula 1: 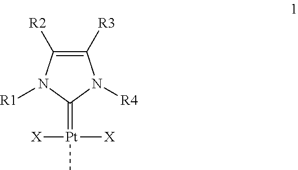
where R₁, R₂, R₃, R₄ and X are as defined above,
the number m being comprised between 1 and n, the ratio m/n representing the number of platinum atoms to the number of amines of —NH— or —NH₂ type, in particular being comprised between 1/50 and 1/2, more particularly between 1/20 and 1/2.
